(19) United States
(12) Patent Application Publication
(10) Pub. No.: US 2020/0073612 A1
(43) Pub. Date: Mar. 5, 2020

(54) ELECTRONIC APPARATUS

(71) Applicant: KYOCERA CORPORATION, Kyoto (JP)

(72) Inventors: Shigeki TANABE, Yokohama-shi (JP); Yasuhiro UENO, Yokohama-shi (JP); Hideki MORITA, Yokohama-shi (JP); Isao MASUIKE, Tokyo (JP); Koutaro YAMAUCHI, Yokohama-shi (JP); Manabu SAKUMA, Yokohama-shi (JP); Kenji SHIMADA, Yokohama-shi (JP)

(21) Appl. No.: 16/552,826

(22) Filed: Aug. 27, 2019

(30) Foreign Application Priority Data
Aug. 28, 2018 (JP) 2018-159353

(51) Int. Cl. G06F 3/14

(52) U.S. Cl. CPC G06F 3/14

(57) ABSTRACT

An electronic apparatus, a computer-readable non-transitory recording medium, and a display control method are disclosed. An electronic apparatus comprises an information display area, and at least one processor. The information display area is located on a surface of the electronic apparatus. The at least one processor is configured to change display of the information display area, according to first rotation of the electronic apparatus about a first axis. The first axis is in parallel with a first display area comprised in the information display area.

### CROSS-REFERENCE TO RELATED APPLICATION

The present application claims priority under 35 U.S.C. § 119 to Japanese Patent Application No. 2018-159353, filed on Aug. 28, 2018, entitled “ELECTRONIC APPARATUS, CONTROL PROGRAM, AND DISPLAY CONTROL METHOD”. The content of which is incorporated by reference herein in its entirety.

### FIELD

The present disclosure relates generally to an electronic apparatus.

### BACKGROUND

Various technologies related to an electronic apparatus have been proposed.

### SUMMARY

An electronic apparatus, a computer-readable non-transitory recording medium, and a display control method are disclosed. In one embodiment, an electronic apparatus comprises an information display area, and at least one processor. The information display area is located on a surface of the electronic apparatus. The at least one processor is configured to change display of the information display area, according to first rotation of the electronic apparatus about a first axis. The first axis is in parallel with a first display area comprised in the information display area.

An electronic apparatus comprises an information display area, and at least one processor. The information display area is located on a surface of the electronic apparatus. The information display area comprises a cylindrical curved surface. The at least one processor is configured to change display of the information display area, according to circumferential rotation of the cylindrical curved surface of the electronic apparatus. The circumferential rotation is rotation in a circumferential direction of the cylindrical curved surface.

A computer-readable non-transitory recording medium is a computer-readable non-transitory recording medium that stores a control program. The control program is configured to control an electronic apparatus. The electronic apparatus comprises an information display area on a surface of the electronic apparatus. The control program is configured to cause the electronic apparatus to change display of the information display area, according to rotation of the electronic apparatus about an axis. The axis is in parallel with a certain display area comprised in the information display area.

A computer-readable non-transitory recording medium is a computer-readable non-transitory recording medium that stores a control program. The control program is configured to control an electronic apparatus. The electronic apparatus comprises an information display area on a surface of the electronic apparatus. The information display area comprises a cylindrical curved surface. The control program is configured to cause the electronic apparatus to change display of the information display area, according to circumferential rotation of the cylindrical curved surface of the electronic apparatus. The circumferential rotation is rotation in a circumferential direction of the cylindrical curved surface.

A display control method is a display control method of an electronic apparatus. The electronic apparatus comprises an information display area on a surface of the electronic apparatus. The display control method comprises changing display of the information display area, according to rotation of the electronic apparatus about an axis. The axis is in parallel with a certain display area comprised in the information display area.

A display control method is a display control method of an electronic apparatus. The electronic apparatus comprises an information display area on a surface of the electronic apparatus. The information display area comprises a cylindrical curved surface. The display control method comprising changing display of the information display area, according to circumferential rotation of the cylindrical curved surface of the electronic apparatus. The circumferential rotation is rotation in a circumferential direction of the cylindrical curved surface.

### BRIEF DESCRIPTION OF THE DRAWINGS

FIG. 1 illustrates a perspective view showing one example of an external appearance of an electronic apparatus.

FIG. 2 illustrates a perspective view showing one example of an external appearance of the electronic apparatus.

FIG. 3 illustrates a perspective view showing one example of an external appearance of the electronic apparatus.

FIG. 4 illustrates a plan view showing one example of an external appearance of the electronic apparatus.

FIG. 5 illustrates a perspective view showing one example of an external appearance of the electronic apparatus.

FIG. 6 illustrates a block diagram showing one example of a configuration of the electronic apparatus.

FIG. 7 illustrates a flowchart showing one example of operation of the electronic apparatus.

FIG. 8 illustrates a diagram showing one example of a state in which the electronic apparatus is held by a hand of a user.

FIG. 9 illustrates a plan view showing one example of an external appearance of the electronic apparatus.

FIG. 10 illustrates a perspective view showing one example of an external appearance of an electronic apparatus.

FIG. 11 illustrates a perspective view showing one example of an external appearance of the electronic apparatus.

FIG. 12 illustrates a diagram showing one example of a state in which the electronic apparatus is carried by a user.

FIG. 13 illustrates a plan view showing one example of an external appearance of an electronic apparatus.

FIG. 14 illustrates a plan view showing one example of an external appearance of an electronic apparatus.

FIG. 15 illustrates a diagram showing one example of a state in which the electronic apparatus is worn by a user.

FIG. 16 illustrates a diagram showing one example of a state in which the electronic apparatus is worn by a user.

FIG. 17 illustrates a diagram showing one example of a rotation axis when the electronic apparatus is rotated.

FIG. 18 illustrates a diagram showing one example of a rotation axis when the electronic apparatus is rotated.

FIG. 19 illustrates a diagram showing one example of rotations of the electronic apparatus.

FIG. 20 illustrates a diagram showing one example of rotations of the electronic apparatus.

FIG. 21 illustrates a diagram showing one example of pages displayed by the electronic apparatus.

FIG. 22 illustrates a diagram showing one display example of the electronic apparatus.

FIG. 23 illustrates a diagram showing one display example of the electronic apparatus.

FIG. 24 illustrates a diagram showing one display example of the electronic apparatus.

FIG. 25 illustrates a diagram showing one display example of the electronic apparatus.

FIG. 26 illustrates a diagram showing one display example of the electronic apparatus.

FIG. 27 illustrates a diagram showing one display example of the electronic apparatus.

FIG. 28 illustrates a diagram showing one example of screens displayed by the electronic apparatus.

FIG. 29 illustrates a diagram showing one display example of the electronic apparatus.

FIG. 30 illustrates a diagram showing one display example of the electronic apparatus.

FIG. 31 illustrates a diagram showing one display example of the electronic apparatus.

FIG. 32 illustrates a diagram showing one display example of the electronic apparatus.

FIG. 33 illustrates a diagram showing one display example of the electronic apparatus.

FIG. 34 illustrates a diagram showing one display example of the electronic apparatus.

FIG. 35 illustrates a diagram for explaining one example of operation of the electronic apparatus.

FIG. 36 illustrates a diagram for explaining one example of operation of the electronic apparatus.

FIG. 37 illustrates a diagram for explaining one example of operation of the electronic apparatus.

FIG. 38 illustrates a diagram for explaining one example of operation of the electronic apparatus.

FIG. 39 illustrates a diagram showing one display example of the electronic apparatus.

FIG. 40 illustrates a diagram showing one display example of the electronic apparatus.

FIG. 41 illustrates a diagram showing one display example of the electronic apparatus.

FIG. 42 illustrates a diagram showing one display example of the electronic apparatus.

FIG. 43 illustrates a diagram showing one display example of the electronic apparatus.

FIG. 44 illustrates a perspective view showing one example of an external appearance of an electronic apparatus.

FIG. 45 illustrates a perspective view showing one example of an external appearance of the electronic apparatus.

FIG. 46 illustrates a block diagram showing one example of a configuration of the electronic apparatus.

FIG. 47 illustrates a diagram showing one display example of the electronic apparatus.

FIG. 48 illustrates a diagram showing one display example of the electronic apparatus.

FIG. 49 illustrates a diagram for explaining one example of operation of the electronic apparatus.

FIG. 50 illustrates a perspective view showing one example of an external appearance of the electronic apparatus.

FIG. 51 illustrates a diagram showing one example of an information display area.

FIG. 52 illustrates a flowchart showing one example of operation of the electronic apparatus.

FIG. 53 illustrates a diagram showing one example of a state in which the electronic apparatus is held by a hand of a user.

FIG. 54 illustrates a diagram showing one example of a state in which the electronic apparatus is placed on a table.

FIG. 55 illustrates a diagram showing circumferential rotations of the electronic apparatus.

FIG. 56 illustrates a diagram showing one display example of the electronic apparatus.

FIG. 57 illustrates a diagram showing one display example of the electronic apparatus.

FIG. 58 illustrates a diagram showing one display example of the electronic apparatus.

FIG. 59 illustrates a diagram showing one display example of the electronic apparatus.

FIG. 60 illustrates a diagram showing one display example of the electronic apparatus.

FIG. 61 illustrates a diagram showing one display example of the electronic apparatus.

FIG. 62 illustrates a diagram showing one display example of the electronic apparatus.

FIG. 63 illustrates a diagram for explaining one example of operation of the electronic apparatus.

### DETAILED DESCRIPTION

<One Example of External Appearance of Electronic Apparatus>

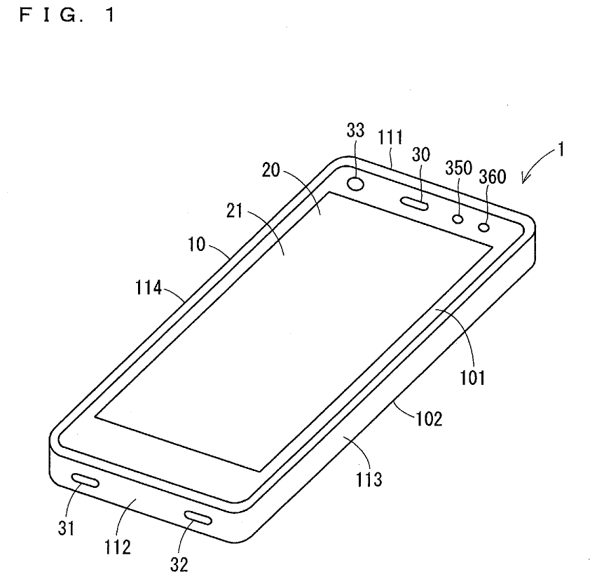

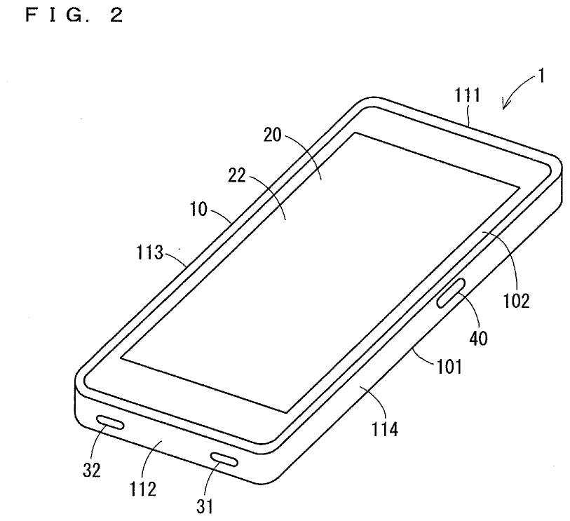

FIG. 1 and FIG. 2 each illustrate a perspective view showing one example of an external appearance of an electronic apparatus 1. For example, the electronic apparatus 1 is a mobile phone, such as a smartphone. FIG. 1 illustrates the electronic apparatus 1 as seen from a first main surface 101 side of a case 10 of the electronic apparatus 1. FIG. 2 illustrates the electronic apparatus 1 as seen from a second main surface 102 side of the case 10.

As illustrated in FIGS. 1 and 2, the electronic apparatus 1 comprises a case 10 having a substantially rectangular plate-like shape in plan view. The case 10 forms an outer case of the electronic apparatus 1. Surfaces of the case 10 comprise a pair of main surfaces consisting of a first main surface 101 and a second main surface 102 facing each other, a pair of side surfaces consisting of a first side surface 111 and a second side surface 112 facing each other, and a pair of side surfaces consisting of a third side surface 113 and a fourth side surface 114 facing each other. The first main surface 101, the second main surface 102, the first side surface 111, the second side surface 112, the third side surface 113, and the fourth side surface 114 of the case 10 may be hereinafter referred to as a first main surface 101, a second main surface 102, a first side surface 111, a second side surface 112, a third side surface 113, and a fourth side surface 114 of the electronic apparatus 1, respectively.

An information display area 20 is located on a surface of the case 10. In the information display area 20, various pieces of information, such as a letter, a symbol, and a graphic symbol are displayed. The information display area 20 comprises display surfaces 21 and 22. It can be said that each of the display surfaces 21 and 22 is a display area. The display surface 21 is located on the first main surface 101. The display surface 22 is located on the second main surface 102. For example, an outer shape of each of the display surfaces 21 and 22 is a rectangular shape. Each of the display surfaces 21 and 22 may be hereinafter referred to as a display surface or a display area, unless the display surfaces 21 and 22 need to be particularly distinguished from each other.

A receiver hole 30, a proximity sensor 350, and an illuminance sensor 360 are located at an end portion of the first main surface 101 on the first side surface 111 side. A lens 33 of a camera 280 (described later) is visibly recognizable from the end portion of the first main surface 101 on the first side surface 111 side. A speaker hole 31 and a microphone hole 32 are located on the second side surface 112 of the electronic apparatus 1.

As illustrated in FIG. 2, a power button 40 is located on the fourth side surface 114 of the case 10. For example, the power button 40 is a hardware button. The electronic apparatus 1 may comprise another hardware button exposed from the case 10, other than the power button 40.

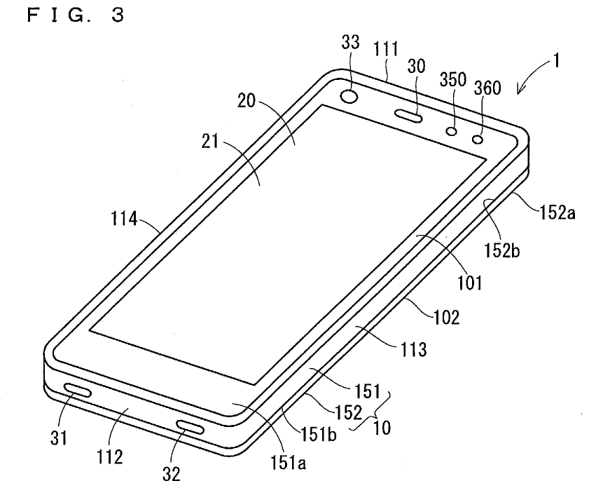

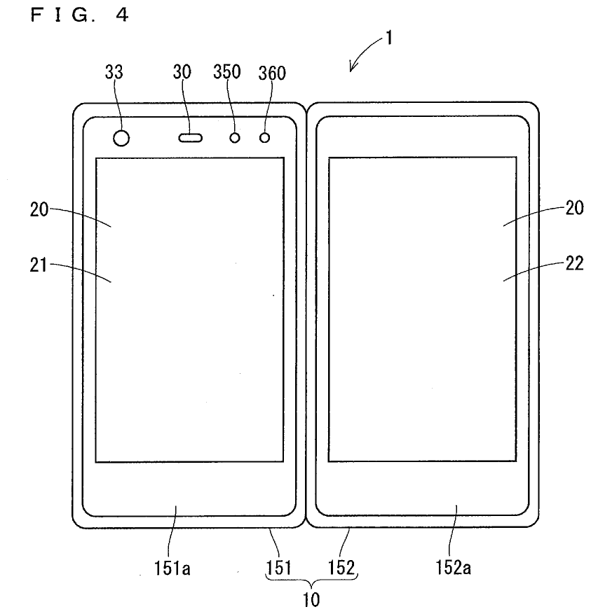

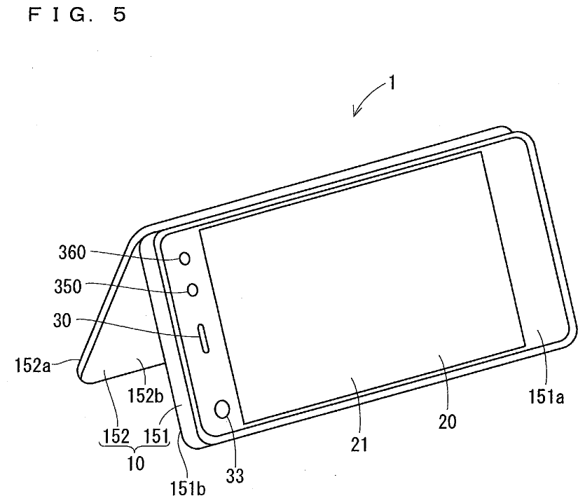

Note that the electronic apparatus 1 may be openable and closable. FIGS. 3 to 5 each illustrate a diagram showing an external appearance of one example of an openable and closable electronic apparatus 1. The external appearance of the electronic apparatus 1 according to one example can have three types of states, namely, a closed state in which the electronic apparatus 1 is closed, an open state in which the electronic apparatus 1 is open, and a partly open state in which the electronic apparatus 1 is partly open. FIG. 3 illustrates a perspective view of the electronic apparatus 1 in a closed state. FIG. 4 illustrates a plan view of the electronic apparatus 1 in an open state. FIG. 5 illustrates a perspective view of the electronic apparatus 1 in a partly open state. The electronic apparatus 1 in a closed state illustrated in FIG. 3 have an external appearance the same as the external appearance of the electronic apparatus 1 illustrated in FIGS. 1 and 2.

The case 10 of the electronic apparatus 1 illustrated in FIGS. 3 to 5 comprises a first case 151 and a second case 152. For example, each of the first case 151 and the second case 152 has a substantially rectangular plate-like shape in plan view. The first case 151 and the second case 152 are connected together with a hinge on the third side surface 113 (see FIG. 3) of the electronic apparatus 1 in a closed state. For example, the thickness of the first case 151 is larger than the thickness of the second case 152.

Surfaces of the first case 151 comprise a pair of main surfaces consisting of a first main surface 151a and a second main surface 151b facing each other. Surfaces of the second case 152 comprise a pair of main surfaces consisting of a first main surface 152a and a second main surface 152b facing each other. The display surface 21 is located on the first main surface 151a of the first case 151. The display surface 22 is located on the first main surface 152a of the second case 152.

As illustrated in FIG. 3, regarding the electronic apparatus 1 in a closed state, the first case 151 and the second case 152 overlap each other such that the second main surface 151b of the first case 151 and the second main surface 152b of the second case 152 come into contact with each other. Regarding the electronic apparatus 1 in a closed state, the first main surface 151a of the first case 151 serves as the first main surface 101 of the electronic apparatus 1 illustrated in FIGS. 1 and 2. Regarding the electronic apparatus 1 in a closed state, the first main surface 152a of the second case 152 serves as the second main surface 102 of the electronic apparatus 1 illustrated in FIGS. 1 and 2.

As illustrated in FIG. 4, regarding the electronic apparatus 1 in an open state, the first case 151 and the second case 152 are arranged side by side such that the first main surface 151a of the first case 151 and the first main surface 152a of the second case 152 are located on substantially the same plane. With this configuration, the display surfaces 21 and 22 are located on substantially the same plane.

As illustrated in FIG. 5, regarding the electronic apparatus 1 in a partly open state, the electronic apparatus 1 is partly open such that the first main surface 151a of the first case 151 and the first main surface 152a of the second case 152 form a predetermined angle. The electronic apparatus 1 in a partly open state can be placed on a table or the like such that the first case 151 and the second case 152 stand with an open portion facing down. From opposite directions, two users can see respective display surfaces 21 and 22 of the electronic apparatus 1 in a partly open state placed on a table or the like.

Note that an electronic apparatus 1 as a mobile phone is herein mainly described. However, the electronic apparatus 1 may be another type of electronic apparatus different from a mobile phone. For example, the electronic apparatus 1 may be a tablet terminal, a personal computer, or a wearable apparatus. Examples of types of the wearable apparatus adopted as the electronic apparatus 1 include an arm-worn type, such as a wristband type or a wristwatch type, a head-worn type, such as a headband type or an eyeglass type, and a body-worn type, such as a garment type.

<One Example of Electrical Configuration of Electronic Apparatus>

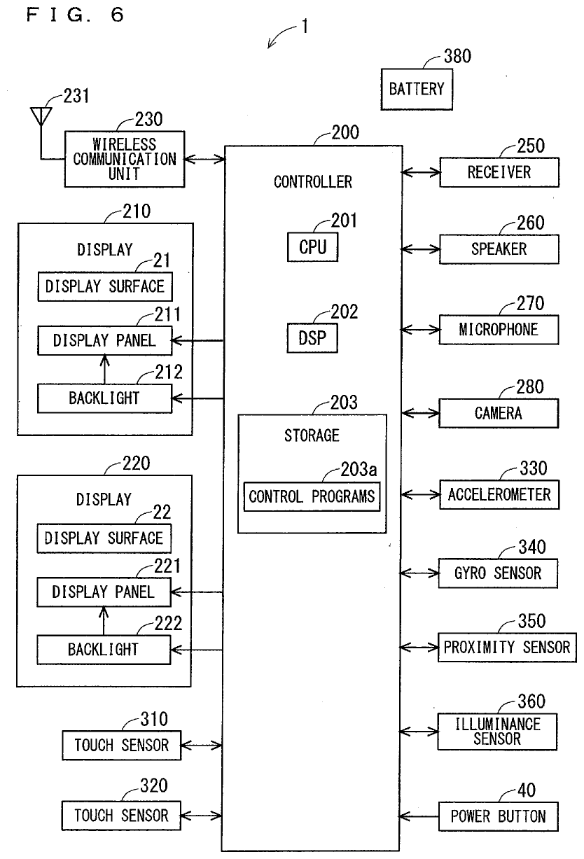

FIG. 6 illustrates a block diagram mainly showing one example of an electrical configuration of the electronic apparatus 1. As illustrated in FIG. 6, the electronic apparatus 1 comprises a controller 200, a display 210, a display 220, a wireless communication unit 230, a receiver 250, a speaker 260, a microphone 270, and a camera 280. The electronic apparatus 1 further comprises a touch sensor 310, a touch sensor 320, an accelerometer 330, a gyro sensor 340, a proximity sensor 350, an illuminance sensor 360, a power button 40, and a battery 380. These components of the electronic apparatus 1 are accommodated inside the case 10.

The controller 200 can integrally manage operation of the electronic apparatus 1 by controlling another component of the electronic apparatus 1. It can also be said that the controller 200 is a control device or a control circuit. The controller 200 comprises at least one processor for providing control and processing capability to perform various functions as described in further detail below.

In accordance with various embodiments, the at least one processor may be implemented as a single integrated circuit (IC) or as multiple communicatively coupled IC's and/or discrete circuits. It is appreciated that the at least one processor can be implemented in accordance with various known technologies.

In one embodiment, the processor comprises one or more circuits or units configurable to perform one or more data computing procedures or processes by executing instructions stored in an associated memory, for example. In other embodiments, the processor may be implemented as firmware (e.g. discrete logic components) configured to perform one or more data computing procedures or processes.

In accordance with various embodiments, the processor may comprise one or more processors, controllers, microprocessors, microcontrollers, application specific integrated circuits (ASICs), digital signal processors, programmable logic devices, field programmable gate arrays, or any combination of these devices or structures, or other known devices and structures, to perform the functions described herein.

In one example, the controller 200 comprises a central processing unit (CPU) 201, a digital signal processor (DSP) 202, and a storage 203. The storage 203 comprises a non-transitory recording medium readable by the CPU 201 and the DSP 202, such as read only memory (ROM) and random access memory (RAM). For example, the ROM of the storage 203 is flash ROM (flash memory) that is non-volatile memory. The storage 203 stores a plurality of control programs 203a etc. for controlling the electronic apparatus 1. Various functions of the controller 200 are implemented by the CPU 201 and the DSP 202 executing the various control programs 203a in the storage 203.

Note that a configuration of the controller 200 is not limited to one example described above. For example, the controller 200 may comprise a plurality of CPUs 201. The controller 200 need not comprise the DSP 202, or may comprise a plurality of DSPs 202. All of functions of the controller 200 or a part of functions of the controller 200 may be implemented by a hardware circuit that does not require software to implement its function. The storage 203 may comprise a computer-readable non-transitory recording medium, other than ROM and RAM. For example, the storage 203 may comprise a small-sized hard disk drive, a solid state drive (SSD), or the like.

The plurality of control programs 203a in the storage 203 comprise various applications (i.e., application programs). For example, the storage 203 stores a phone application for making a voice call and a video call, a browser for displaying a website, a map application for displaying a map, and an email application for creating, viewing, sending, and receiving an electronic mail. The storage 203 further stores a camera application for capturing an object by using the camera 280, a recorded-image display application for displaying a still image and a video stored in the storage 203, a music play control application for performing control of playing music data stored in the storage 203, etc. At least one application in the storage 203 may be stored in the storage 203 in advance. At least one application in the storage 203 may be downloaded by the electronic apparatus 1 from another device, and is stored in the storage 203.

The wireless communication unit 230 comprises an antenna 231. For example, the wireless communication unit 230 can perform wireless communication with a plurality of types of communication methods by using the antenna 231. Wireless communication of the wireless communication unit 230 is controlled by the controller 200.

The wireless communication unit 230 can perform wireless communication with a base station of a mobile phone system. The wireless communication unit 230 can communicate with a mobile phone different from the electronic apparatus 1, a web server, or the like, via the base station and a network such as the Internet. For example, the electronic apparatus 1 can perform data communication and make a voice call and a video call with another mobile phone or the like.

The wireless communication unit 230 can perform wireless communication by using a wireless local area network (LAN), such as WiFi. The wireless communication unit 230 can perform short-range wireless communication. For example, the wireless communication unit 230 can perform wireless communication in accordance with Bluetooth (trademark). The wireless communication unit 230 may be capable of performing wireless communication in accordance with at least one of ZigBee (trademark) and near field communication (NFC).

The wireless communication unit 230 performs various types of processing, such as amplification processing, on a signal received by the antenna 231. Then, the wireless communication unit 230 outputs the processed signal to the controller 200. The controller 200 receives the signal, and performs various types of processing on the received signal to acquire information included in the received signal. Apart from this, the controller 200 includes information in a signal, and outputs the signal including information to the wireless communication unit 230. The wireless communication unit 230 receives the signal, and performs various types of processing, such as amplification processing, on the received signal. Then, the wireless communication unit 230 wirelessly transmits the processed signal from the antenna 231.

The display 210 comprises the display surface 21 located on the first main surface 101 of the electronic apparatus 1, a display panel 211, and a backlight 212. The display 210 can display various pieces of information on the display surface 21. For example, the display panel 211 is a liquid crystal display panel, and comprises a plurality of pixels (also referred to as a “pixel unit” or a “pixel circuit”). For example, the display panel 211 comprises liquid crystals, a glass substrate, and a polarizing plate. Inside the case 10, the display panel 211 faces the display surface 21. Information displayed on the display panel 211 is displayed on the display surface 21 that is a surface of the electronic apparatus 1. The backlight 212 emits light toward the display panel 211, from the back of the display panel 211. For example, the backlight 212 comprises at least one light emitting diode (LED). When the controller 200 controls the display panel 211, the display panel 211 can control a transmission amount of light from the backlight 212 per pixel. In this manner, the display panel 211 can display various pieces of information. When the controller 200 controls each pixel of the display panel 211 while the backlight 212 is turned on, the display 210 can display various pieces of information, such as a letter, a symbol, and a graphic symbol. The controller 200 can control the backlight 212. For example, the controller 200 can turn on and off the backlight 212.

The display 220 comprises the display surface 22 located on the second main surface 102 of the electronic apparatus 1, a display panel 221, and a backlight 222. The display 220 can display various pieces of information on the display surface 22. A configuration and operation of the display panel 221 are the same as the configuration and operation of the display panel 211 described above. A configuration and operation of the backlight 222 are the same as the configuration and operation of the backlight 212 described above. When the controller 200 controls each pixel of the display panel 221 while the backlight 222 is turned on, the display 220 can display various pieces of information, such as a letter, a symbol, and a graphic symbol. The controller 200 can independently control display of each of the display surfaces 21 and 22. The controller 200 can control the backlight 222. For example, the controller 200 can turn on and off the backlight 222.

Note that at least one of the display panels 211 and 221 may be a display panel other than a liquid crystal display panel. For example, the display panel 211 may be a light-emitting display panel, such as an organic electroluminescent (EL) panel. In this case, the backlight 212 is unnecessary. Similarly, the display panel 221 may be a light-emitting display panel, such as an organic EL panel. In this case, the backlight 222 is unnecessary.

The controller 200 can set the display surface 21 to a display state or a non-display state. Similarly, the controller 200 can set the display surface 22 to a display state or a non-display state. Here, the display state refers to a state in which the electronic apparatus 1 intentionally performs display on the display surface (i.e., display area). The non-display state refers to a state in which the electronic apparatus 1 intentionally does not perform display on the display surface. In one example, when the backlight 212 is turned off, the electronic apparatus 1 cannot intentionally perform display on the display surface 21. Therefore, when the backlight 212 is turned off, the display surface 21 is in a non-display state. In other words, when the backlight 212 is not driven, the display surface 21 is in a non-display state. When the display panel 211 is a light-emitting display panel such as an organic EL panel, the display surface 21 is in a non-display state unless all the pixels emit light. Specifically, when light is turned off in the entire display area of the display panel 211, the display surface 21 is in a non-display state. The same holds true for the display surface 22.

The touch sensor 310 can detect touch operation performed on the display surface 21 by a pointer, such as a finger. It can also be said that the touch sensor 310 can detect operation input on the display surface 21. The touch sensor 310 is also referred to as a touch panel. For example, the touch sensor 310 is a projected capacitive touch sensor. For example, the touch sensor 310 is located on the back of the display surface 21. When a user performs operation on the display surface 21 with a pointer such as a finger, the touch sensor 310 can input an electrical signal according to the operation to the controller 200. The controller 200 can identify details of operation performed on the display surface 21, based on the electrical signal (output signal) from the touch sensor 310. Then, the controller 200 can perform processing according to the identified details of operation. In this manner, the controller 200 can perform processing according to operation detected by the touch sensor 310. A user can input various pieces of information to the electronic apparatus 1 by performing operation on the display surface 21 with a finger or the like.

The touch sensor 320 can detect touch operation performed on the display surface 22 by a pointer, such as a finger. It can also be said that the touch sensor 320 can detect operation input on the display surface 22. A configuration and operation of the touch sensor 320 are the same as the configuration and operation of the touch sensor 310. The controller 200 can identify details of operation performed on the display surface 22, based on an electrical signal (output signal) from the touch sensor 320. Then, the controller 200 can perform processing according to the identified details of operation. In this manner, the controller 200 can perform processing according to operation detected by the touch sensor 320. A user can input various pieces of information to the electronic apparatus 1 by performing operation on the display surface 22 with a finger or the like.

Note that a user can input various pieces of information to the electronic apparatus 1 also by performing operation on the display surface with a pointer other than a finger. One example of the pointer other than a finger is a pen for a touch sensor, such as a stylus pen. Each of the touch sensors 310 and 320 may be hereinafter referred to as a touch sensor, unless the touch sensors 310 and 320 need to be particularly distinguished from each other.

In the electronic apparatus 1, an in-cell display panel incorporating a touch sensor may be adopted instead of the display panel 211 and the touch sensor 310. In this case, the display panel also serves as a sensor that detects operation input on the display surface 21. Similarly, an in-cell display panel incorporating a touch sensor may be adopted instead of the display panel 221 and the touch sensor 320.

When the power button 40 is operated, i.e., pressed, by a user, the power button 40 can output an operation signal to the controller 200. The operation signal indicates that the power button 40 has been operated. In this manner, the controller 200 can determine whether or not the power button 40 has been operated. The controller 200, which has received the operation signal, controls another component. In this manner, in the electronic apparatus 1, a function according to the operation performed on the power button 40 is executed.

The microphone 270 can convert incoming sound from the outside of the electronic apparatus 1 into an electrical sound signal, and output the converted signal to the controller 200. Sound from the outside of the electronic apparatus 1 is taken into the electronic apparatus 1 through the microphone hole 32, and is input to the microphone 270.

For example, the speaker 260 is a dynamic speaker. The speaker 260 can convert an electrical sound signal from the controller 200 into sound, and output the converted sound. The sound output from the speaker 260 is output to the outside through the speaker hole 31. A user can hear the sound output through the speaker hole 31 even at a place far from the electronic apparatus 1.

The receiver 250 can output received voice sound. For example, the receiver 250 is a dynamic speaker. The receiver 250 can convert an electrical sound signal from the controller 200 into sound, and output the converted sound. The sound output from the receiver 250 is output to the outside through the receiver hole 30. The volume of the sound output through the receiver hole 30 is smaller than the volume of the sound output through the speaker hole 31. A user can hear the sound output through the receiver hole 30 by bringing his/her ear close to the receiver hole 30. Note that, instead of the receiver 250, the electronic apparatus 1 may comprise a vibration element, such as a piezoelectric vibration element, that vibrates the first main surface 101 of the case 10. In this case, sound is conveyed to a user through vibration of the first main surface 101.

For example, the camera 280 comprises a lens 33 and an image sensor. The camera 280 can capture an object, based on control performed by the controller 200. The camera 280 can generate a still image or a video showing the captured object, and output the generated still image or video to the controller 200. Note that the electronic apparatus 1 may comprise a plurality of cameras 280.

The accelerometer 330 can detect acceleration of the electronic apparatus 1. For example, the accelerometer 330 is a three-axis accelerometer. The accelerometer 330 can detect acceleration of the electronic apparatus 1 in an x-axis direction, a y-axis direction, and a z-axis direction. For example, the x-axis direction, the y-axis direction, and the z-axis direction are set to a long-side direction, a short-side direction, and a thickness direction of the electronic apparatus 1, respectively. A detection result obtained by the accelerometer 330 is input to the controller 200.

For example, the gyro sensor 340 is a three-axis gyro sensor. The gyro sensor 340 can detect angular velocity about each axis of the x-axis, the y-axis, and the z-axis. A detection result obtained by the gyro sensor 340 is input to the controller 200.

For example, the proximity sensor 350 is an infrared proximity sensor. When an object approaches the proximity sensor 350 and enters a predetermined range from the proximity sensor 350, the proximity sensor 350 outputs a detection signal. The detection signal is input to the controller 200. The proximity sensor 350 can detect an object approaching or coming into contact with the first main surface 101 of the electronic apparatus 1. In other words, the proximity sensor 350 can detect an object approaching or coming into contact with the display surface 21. A detection result obtained by the proximity sensor 350 is input to the controller 200.

The illuminance sensor 360 can detect brightness around the electronic apparatus 1. Specifically, the illuminance sensor 360 can detect brightness around the first main surface 101. In other words, the illuminance sensor 360 can detect brightness around the display surface 21. A detection result obtained by the illuminance sensor 360 is input to the controller 200. Note that the illuminance sensor 360 and the proximity sensor 350 may be integrated together.

The battery 380 can output power of the electronic apparatus 1. For example, the battery 380 is a rechargeable battery. Power output from the battery 380 is supplied to various configurations of the electronic apparatus 1, such as the controller 200 and the wireless communication unit 230.

Note that the electronic apparatus 1 may comprise a sensor other than the touch sensors 310 and 320, the accelerometer 330, the gyro sensor 340, the proximity sensor 350, and the illuminance sensor 360. For example, the electronic apparatus 1 may comprise at least one of an air-pressure sensor, a geomagnetic sensor, a temperature sensor, and a position detection sensor.

<Operation Modes of Electronic Apparatus>

The electronic apparatus 1 includes a number of operation modes. Examples of the operation modes of the electronic apparatus 1 include a normal mode, a sleep mode, and a shutdown mode. In the shutdown mode, the electronic apparatus 1 is shut down, and most functions of the electronic apparatus 1 are stopped. In the sleep mode, some functions of the electronic apparatus 1, including a display function, are stopped. The normal mode refers to a mode in which the electronic apparatus 1 operates in a mode other than the sleep mode and the shutdown mode. The controller 200 controls a predetermined component of the electronic apparatus 1, according to an operation mode to be set. In this manner, an operation mode of the electronic apparatus 1 is set. The term “operation mode” by itself hereinafter refers to an operation mode of the electronic apparatus 1.

In the sleep mode, for example, some components of the electronic apparatus 1, including the display panels 211 and 221, the touch sensors 310 and 320, and the camera 280, do not operate. In the shutdown mode, for example, most components of the electronic apparatus 1, including the display panels 211 and 221, the touch sensors 310 and 320, and the camera 280, do not operate. Power of the electronic apparatus 1 is less consumed in the sleep mode than in the normal mode. Power of the electronic apparatus 1 is less consumed in the shutdown mode than in the sleep mode. In the sleep mode and the shutdown mode, the display surfaces 21 and 22 are set to a non-display state.

In one example, when the power button 40 is pressed for a long period of time in the normal mode, a confirmation screen is displayed on the display surface 21, for example. The confirmation screen is a screen for confirming with a user as to whether or not a mode is to be transitioned from the normal mode to the shutdown mode. When a user performs predetermined operation on the display surface 21 while the confirmation screen is displayed on the display surface 21, the mode transitions from the normal mode to the shutdown mode.

When operation is not performed on the electronic apparatus 1 for a certain period of time or longer in the normal mode, the mode transitions from the normal mode to the sleep mode. When the power button 40 is pressed for a short period of time in the normal mode, the mode transitions from the normal mode to the sleep mode. In contrast, when the power button 40 is pressed for a short period of time in the sleep mode, the mode transitions from the sleep mode to the normal mode.

For example, the normal mode of the electronic apparatus 1 includes a single display mode and a multi-display mode. In the single display mode, display is performed only on the display surface 21 out of the display surfaces 21 and 22. The display surface 22 is in a non-display state throughout the single display mode. In the multi-display mode, display is performed on both of the display surfaces 21 and 22. The single display mode may be hereinafter referred to as an SD mode, and the multi-display mode may be hereinafter referred to as an MD mode.

The MD mode includes a first MD mode and a second MD mode. In the first MD mode, the same screen is displayed on each of the display surfaces 21 and 22. In the second MD mode, different screens are displayed on the display surfaces 21 and 22.

As one example, the controller 200 executes a browser while the operation mode is the first MD mode. In this case, the controller 200 can display the same webpage on each of the display surfaces 21 and 22.

As another example, the controller 200 executes a browser and a map application while the operation mode is the second MD mode. In this case, the controller 200 can display one of the web page and the map on the display surface 21, and can display the other of the web page and the map on the display surface 22.

When the electronic apparatus 1 operates in the normal mode, for example, a user performs predetermined operation on the display surface 21. In this manner, with regard to the electronic apparatus 1, the user can specify an operation mode in which the electronic apparatus 1 is to operate. The electronic apparatus 1 operates in the operation mode specified by the user.

Note that, when the electronic apparatus 1 is openable and closable as illustrated in FIGS. 3 to 5 described above, the electronic apparatus 1 in an open state (see FIG. 4) may include a third MD mode as an operation mode. In the third MD mode, the display surfaces 21 and 22 are regarded as one large display surface, and one screen is displayed on the display surfaces 21 and 22. As one example, the controller. 200 plays a video in the storage 203 while the operation mode is the third MD mode. In this case, the controller 200 can display a frame image on the large screen made up of the display surfaces 21 and 22.

<Examples of Display Control in MD Mode>

Some examples of display control performed in the electronic apparatus 1 operating in the MD mode are described below. The following description is based on the premise that the electronic apparatus 1 operates in the MD mode, unless otherwise specifically noted. The following description is also based on the premise that the electronic apparatus 1 operates in a closed state, when the electronic apparatus 1 is openable and closable as illustrated in FIGS. 3 to 5 described above.

<Method of Determining Non-Display State>

In one example, the controller 200 determines whether or not each of the display surfaces 21 and 22 is to be set to a non-display state, based on a condition of an object in terms of contact or proximity with respect to the information display area 20 located on a surface of the electronic apparatus 1. Specifically, the controller 200 determines whether or not the display surface 21 is to be set to a non-display state, based on a condition of an object in terms of contact or proximity with respect to the display surface 21. The controller 200 determines whether or not the display surface 22 is to be set to a non-display state, based on a condition of an object in terms of contact or proximity with respect to the display surface 22. In one example, when the electronic apparatus 1 operates in the MD mode, the display surface is in a display state unless it is determined that the display surface is to be set to a non-display state. A display surface to be described may be hereinafter referred to as a target display surface. A touch sensor that detects operation performed on a target display surface may be referred to as a target touch sensor. For example, when the display surface 21 is a target display surface, a target touch sensor is the touch sensor 310. It can also be said that the target display surface is a target display area.

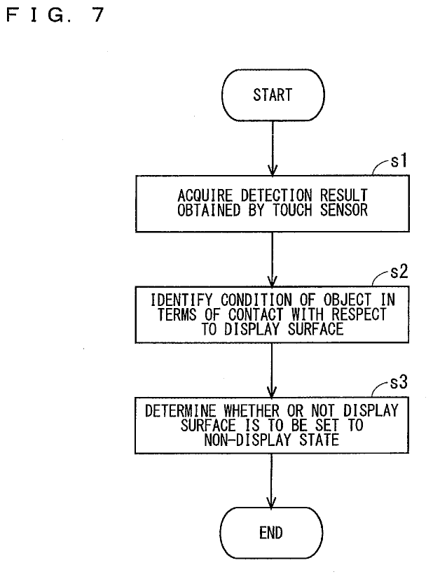

FIG. 7 illustrates a flowchart showing one example of non-display determination processing in which the controller 200 determines whether or not a target display surface is to be set to a non-display state, based on a condition of an object in terms of contact or proximity with respect to the target display surface. It can also be said that, in the non-display determination processing, whether or not to set a target display area to a non-display state is determined based on a condition of an object in terms of contact or proximity with respect to the target display area. When the electronic apparatus 1 operates in the MD mode, the controller 200 repeatedly executes the non-display determination processing illustrated in FIG. 7 for each of the display surfaces 21 and 22.

As illustrated in FIG. 7, in Step s1, the controller 200 acquires a detection result obtained by a target touch sensor. Next, in Step s2, the controller 200 identifies a condition of an object in terms of contact with respect to a target display surface, based on the acquired detection result. For example, the controller 200 calculates the area of a region with which the object is in contact in the target display surface, based on the acquired detection result. The area may be hereinafter referred to as an object contact area.

Next, in Step s3, the controller 200 determines whether or not the target display surface is to be set to a non-display state, based on the object contact area acquired in Step s2. In Step s3, if the object contact area is equal to or greater than a threshold value, the controller 200 determines that the target display surface is to be set to a non-display state. In this manner, the target display surface is set to a non-display state. On the other hand, if the object contact area is less than the threshold value, the controller 200 determines that the target display surface is not to be set to a non-display state. In this manner, the target display surface remains in a display state.

Through execution of the non-display determination processing as described above for each of the display surfaces 21 and 22, the electronic apparatus 1 can set a display surface likely to be seen by a person to a display state, and set a display surface less likely to be seen by a person to a non-display state, out of the display surfaces 21 and 22. As a result, power consumption of the electronic apparatus 1 can be reduced, and at the same time, convenience of the electronic apparatus 1 can be maintained.

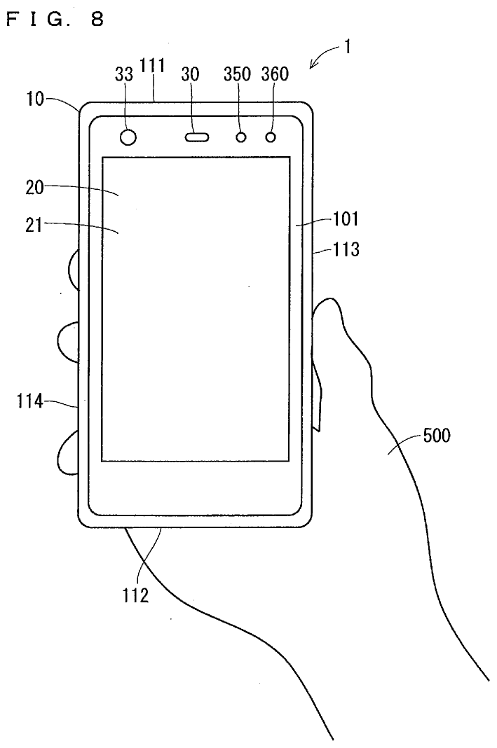

As one example, as illustrated in FIG. 8, a user holds the electronic apparatus 1 with one hand 500. In this case, it is likely that the hand 500 comes into contact with a wide range of a display surface that is difficult to be seen by a user and less likely to be seen by a person. In contrast, it is likely that the hand 500 comes into contact with a smaller range of a display surface that is easily seen by a user and likely to be seen by a person. In one example of FIG. 8, the hand 500 is in contact with a wide range of the display surface 22 difficult to be seen by a user, whereas the hand 500 is not in contact with the display surface easily seen by a user. Therefore, in one example of FIG. 8, the display surface 22 difficult to be seen by a user is set to a non-display state, whereas the display surface 21 easily seen by a user is set to a display state. In other words, the display surface 22 less likely to be seen by a person is set to a non-display state, whereas the display surface 21 likely to be seen by a person is set to a display state.

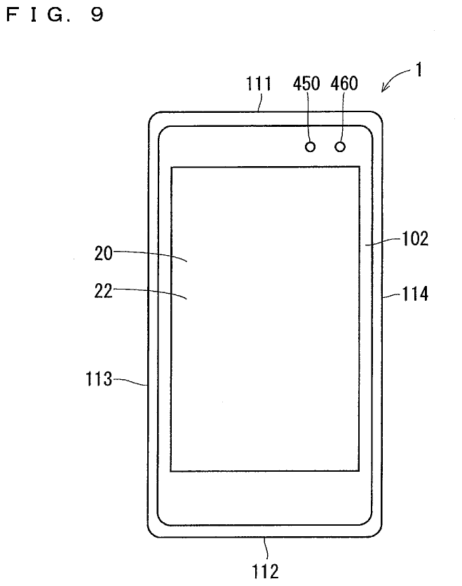

Note that, as illustrated in FIG. 9, when the electronic apparatus 1 comprises a proximity sensor 450 located on the second main surface 102, the controller 200 may use a detection result obtained by the proximity sensor 350 in the non-display determination processing for the display surface 21, and use a detection result obtained by the proximity sensor 450 in the non-display determination processing for the display surface 22. Each of the proximity sensors 350 and 450 may be hereinafter referred to as a proximity sensor, unless the proximity sensors 350 and 450 need to be particularly distinguished from each other. A proximity sensor that can detect proximity or contact of an object with respect to a target display surface may be referred to as a target proximity sensor. When the display surface 22 is a target display surface, a target proximity sensor is the proximity sensor 450.

When a detection result obtained by a target proximity sensor is used in the non-display determination processing for a target display surface, in Step s1, the controller 200 acquires a detection result obtained by the target proximity sensor. Next, in Step s2, the controller 200 identifies a condition of an object in terms of proximity or contact with respect to the target display surface, based on the acquired detection result. For example, if the target proximity sensor detects an object, the controller 200 determines that the object is approaching or in contact with the target display surface. Then, in Step s3, the controller 200 determines that the target display surface is to be set to a non-display state. On the other hand, if the target proximity sensor does not detect an object, the controller 200 determines that no object is approaching or in contact with the target display surface. Then, in Step s3, the controller 200 determines that the target display surface is not to be set to a non-display state. The non-display determination processing using a detection result obtained by a proximity sensor may be hereinafter referred to as non-display determination processing using a proximity sensor. The non-display determination processing using a detection result obtained by a touch sensor illustrated in FIG. 7 may be referred to as non-display determination processing using a touch sensor.

As illustrated in FIG. 9, when the electronic apparatus 1 comprises an illuminance sensor 460 located on the second main surface 102, the controller 200 may use a detection result obtained by the illuminance sensor 360 in the non-display determination processing for the display surface 21, and use a detection result obtained by the illuminance sensor 460 in the non-display determination processing for the display surface 22. Each of the illuminance sensors 360 and 460 may be hereinafter referred to as an illuminance sensor, unless the illuminance sensors 360 and 460 need to be particularly distinguished from each other. An illuminance sensor that detects brightness around a target display surface may be referred to as a target illuminance sensor. When the display surface 21 is a target display surface, a target illuminance sensor is the illuminance sensor 360.

When a detection result obtained by a target illuminance sensor is used in the non-display determination processing for a target display surface, in Step s1, the controller 200 acquires a detection result obtained by the target illuminance sensor. Next, in Step s2, the controller 200 identifies a condition of an object in terms of proximity or contact with respect to the target display surface, based on the acquired detection result. For example, in Step s2, if the controller 200 determines that an object is approaching or in contact with the target display surface based on the detection result obtained by the target illuminance sensor, in Step s3, the controller 200 determines that the target display surface is to be set to a non-display state. On the other hand, if the controller 200 determines that no object is approaching or in contact with the target display surface based on the detection result obtained by the target illuminance sensor, in Step s3, the controller 200 determines that the target display surface 21 is not to be set to a non-display state. If brightness around the target display surface detected by the target illuminance sensor is equal to or less than a threshold value (i.e., if it is dark), the controller 200 determines that an object is approaching or in contact with the target display surface. On the other hand, if brightness around the target display surface detected by the target illuminance sensor is greater than the threshold value (i.e., if it is bright), the controller 200 determines that no object is approaching or in contact with the target display surface. The non-display determination processing using a detection result obtained by an illuminance sensor may be hereinafter referred to as non-display determination processing using an illuminance sensor.

In this manner, a detection result obtained by the proximity sensor or the illuminance sensor is used in the non-display determination processing. Consequently, even when an object difficult to be detected by a touch sensor approaches or comes into contact with a display surface, the electronic apparatus 1 can set the display surface to a non-display state. For example, when the electronic apparatus 1 is placed on a table with the display surface 21 facing down and being brought into contact with the table, the electronic apparatus 1 can set the display surface 21 less likely to be seen by a person to a non-display state.

The controller 200 may execute at least two types of non-display determination processing out of the non-display determination processing using a touch sensor, the non-display determination processing using a proximity sensor, and the non-display determination processing using an illuminance sensor. For example, the controller 200 may execute at least two types of non-display determination processing as provisional determination processing of determining whether or not the target display surface is to be set to a non-display state. Then, based on a result of the provisional determination processing, the controller 200 may ultimately determine whether or not the target display surface is to be set to a non-display state. In this case, if the controller 200 determines that the target display surface is to be set to a non-display state in at least one type of non-display determination processing out of a plurality of types of non-display determination processing executed as the provisional determination processing, the controller 200 ultimately determines that the target display surface is to be set to a non-display state. In contrast, if the controller 200 determines that the target display surface is not to be set to a non-display state in all of a plurality of types of non-display determination processing executed as the provisional determination processing, the controller 200 ultimately determines that the target display surface is not to be set to a non-display state.

Note that, even when the electronic apparatus 1 is an apparatus other than a mobile phone, the electronic apparatus 1 can execute the non-display determination processing in a similar manner. For example, when the electronic apparatus 1 is a wearable apparatus as illustrated in FIGS. 10 to 16, the electronic apparatus 1 can execute the non-display determination processing in a similar manner.

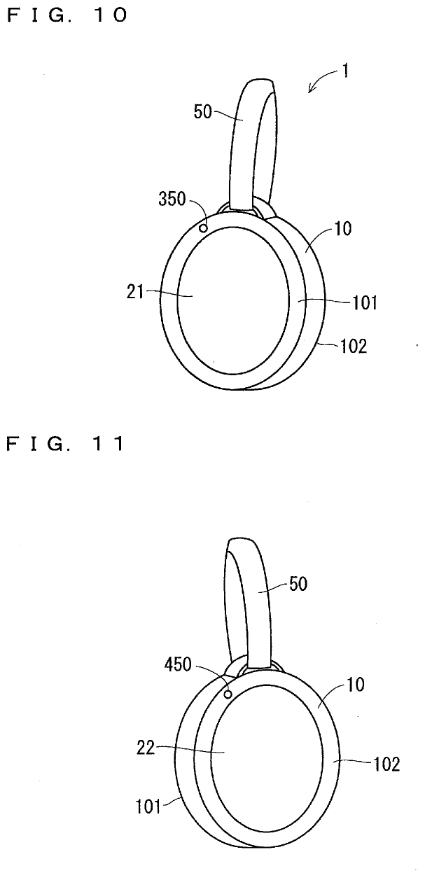

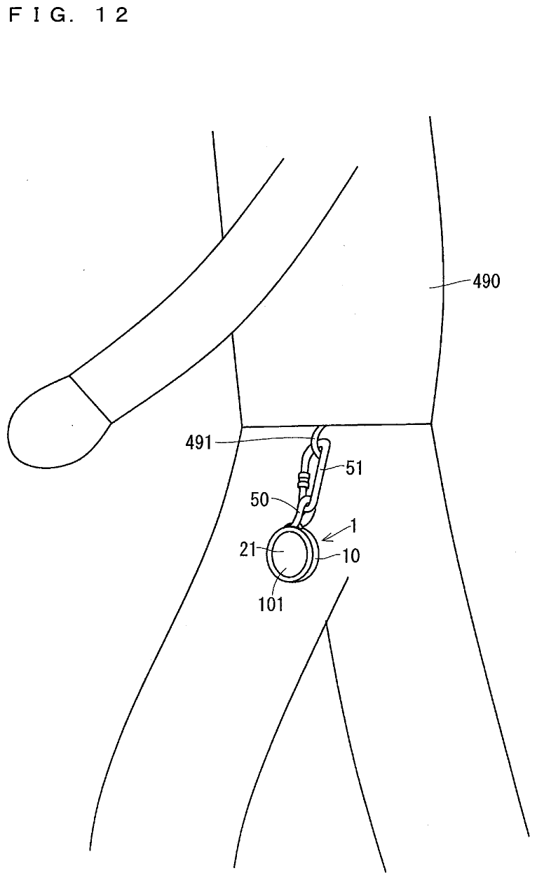

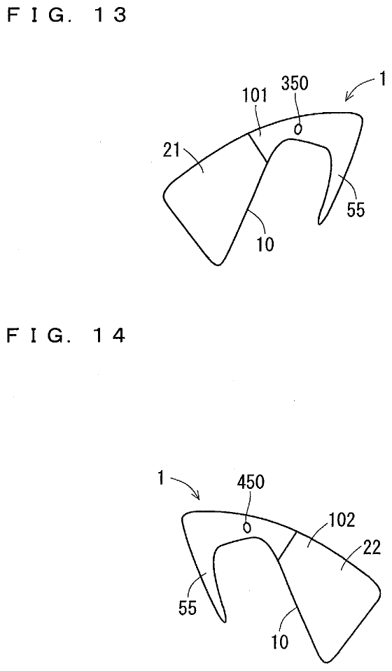

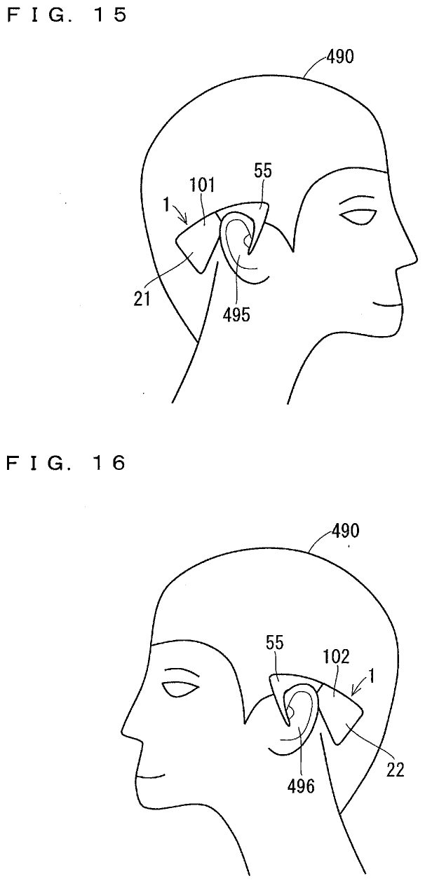

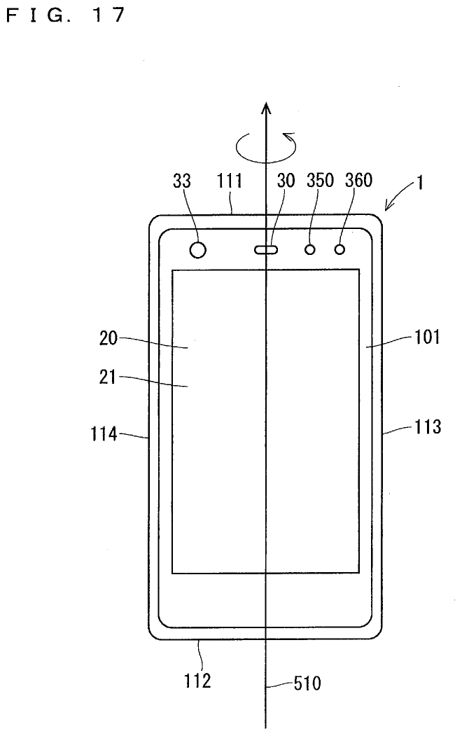

FIGS. 10 and 11 each illustrate a perspective view showing one example of an external appearance of an electronic apparatus 1 that can be suspended from a part of the body of a user. FIG. 12 illustrates a diagram showing one example of a state in which the electronic apparatus 1 illustrated in FIGS. 10 and 11 is suspended from the waist of a user. FIGS. 13 and 14 each illustrate a perspective view showing one example of an external appearance of an electronic apparatus 1 that can be worn on the ear of a user. FIGS. 15 and 16 each illustrate a diagram showing one example of a state in which the electronic apparatus 1 illustrated in FIGS. 13 and 14 is worn on the ear of a user. The electronic apparatus 1 illustrated in FIGS. 10 to 12 may be hereinafter referred to as a suspendable electronic apparatus 1. The electronic apparatus 1 illustrated in FIGS. 13 to 16 may be referred to as an ear-worn electronic apparatus 1.

<Suspendable Electronic Apparatus>

As illustrated in FIGS. 10 to 12, for example, the case 10 of the suspendable electronic apparatus 1 has a circular shape in plan view. As illustrated in FIG. 10, the display surface 21 and the proximity sensor 350 are located on the first main surface 101 of the case 10. As illustrated in FIG. 11, the display surface 22 and the proximity sensor 450 are located on the second main surface 102 of the case 10. For example, a belt 50 for suspending the suspendable electronic apparatus 1 is attached to the case 10. As illustrated in FIG. 12, for example, a hook 51 attached to the belt 50 is caught on a belt loop 491. This allows the suspendable electronic apparatus 1 to be suspended from the waist of a user 490.

When the suspendable electronic apparatus 1 is suspended from a part of the body of a user, one of the display surfaces 21 and 22 may be covered by the body of the user. In one example of FIG. 12, the display surface 22 of the suspendable electronic apparatus 1 suspended from the waist of a user 490 is covered by the body of the user 490. When the suspendable electronic apparatus 1 executes the non-display determination processing using a proximity sensor described above for each of the display surfaces 21 and 22, a display surface that is covered by the body of a user 490 and less likely to be seen by a person can be set to a non-display state.

Note that, when the illuminance sensors 360 and 460 are located on the first main surface 101 and the second main surface 102, respectively, the suspendable electronic apparatus 1 may execute the non-display determination processing using an illuminance sensor described above.

When the suspendable electronic apparatus 1 comprises a first airflow sensor that detects airflow of air impinging on the first main surface 101 and a second airflow sensor that detects airflow of air impinging on the second main surface 102, detection results obtained by the first and second airflow sensors may be used in the non-display determination processing. Each of the first and second airflow sensors may be hereinafter referred to as an airflow sensor, unless the first and second airflow sensors need to be particularly distinguished from each other. An airflow sensor that detects airflow of air impinging on a display surface to be described (i.e., a target display surface) may be referred to as a target airflow sensor.

When a detection result obtained by a target airflow sensor is used in the non-display determination processing for a target display surface, in Step s1, the controller 200 acquires a detection result obtained by the target airflow sensor. Next, in Step s2, the controller 200 identifies a condition of an object in terms of proximity or contact with respect to the target display surface, based on the acquired detection result. For example, if airflow detected by the target airflow sensor is equal to or less than a threshold value, the controller 200 determines that an object is approaching or in contact with the target display surface. On the other hand, if airflow detected by the target airflow sensor is greater than the threshold value, the controller 200 determines that no object is approaching or in contact with the target display surface. If the controller 200 determines that an object is approaching or in contact with the target display surface, in Step s3, the controller 200 determines that the target display surface is to be set to a non-display state. On the other hand, if the controller 200 determines that no object is approaching or in contact with the target display surface, in Step s3, the controller 200 determines that the target display surface is not to be set to a non-display state. The non-display determination processing using a detection result obtained by an airflow sensor as described above may be hereinafter referred to as non-display determination processing using an airflow sensor.

Here, when the suspendable electronic apparatus 1 is suspended from a part of the body of a user, it is likely that more air impinges on one display surface that is not covered by the body of the user, and less air impinges on the other display surface that is covered by the body of the user, out of the display surfaces 21 and 22. Therefore, when the suspendable electronic apparatus 1 executes the non-display determination processing using an airflow sensor described above for each of the display surfaces 21 and 22, a display surface that is covered by the body of a user 490 and less likely to be seen by a person can be set to a non-display state.

Note that the controller 200 of the suspendable electronic apparatus 1 may execute at least two types of non-display determination processing out of the non-display determination processing using a proximity sensor, the non-display determination processing using an illuminance sensor, and the non-display determination processing using an airflow sensor, as provisional determination processing of determining whether or not the target display surface is to be set to a non-display state. Then, based on a result of the provisional determination processing, the controller 200 may ultimately determine whether or not the target display surface is to be set to a non-display state.

When a user moves with the suspendable electronic apparatus 1 suspended from a part of the body of the user, there is great difference between airflow of air impinging on one display surface covered by the body of the user and airflow of air impinging on the other display surface not covered by the body of the user. Therefore, when the non-display determination processing using an airflow sensor is executed while a user is moving, i.e., while the suspendable electronic apparatus 1 is moving, a display surface covered by the body of a user 490 and less likely to be seen by a person can be more securely set to a non-display state. In this case, if the controller 200 of the suspendable electronic apparatus 1 determines that the suspendable electronic apparatus 1 is moving, the controller 200 may execute the non-display determination processing using an airflow sensor. If the controller 200 of the suspendable electronic apparatus 1 determines that the suspendable electronic apparatus 1 is not moving, the controller 200 may execute the non-display determination processing using a proximity sensor or the non-display determination processing using an illuminance sensor. For example, the controller 200 can determine whether or not the suspendable electronic apparatus 1 is moving, based on a detection result obtained by the accelerometer 330.

The non-display determination processing using an airflow sensor may be executed in the electronic apparatus 1 illustrated in FIGS. 1 to 6 described above in a similar manner.

<Ear-Worn Electronic Apparatus>

As illustrated in FIGS. 13 and 14, the case 10 of the ear-worn electronic apparatus 1 comprises a part to be worn 55. The part to be worn 55 allows the ear-worn electronic apparatus 1 to be worn on the ear. As illustrated in FIG. 13, the display surface 21 and the proximity sensor 350 are located on the first main surface 101 of the case 10. As illustrated in FIG. 14, the display surface 22 and the proximity sensor 450 are located on the second main surface 102 of the case 10.

As illustrated in FIG. 15, the ear-worn electronic apparatus 1 can be worn on a right ear 495 of a user 490. As illustrated in FIG. 16, the ear-worn electronic apparatus 1 can be worn on a left ear 496 of a user 490 as well.

As illustrated in FIG. 15, when the ear-worn electronic apparatus 1 is worn on a right ear 495 of a user 490, the display surface 22 is covered by the head of the user 490. Thus, it is less likely that a person sees the display surface 22 of the ear-worn electronic apparatus 1 worn on the right ear 495. In contrast, as illustrated in FIG. 16, when the ear-worn electronic apparatus 1 is worn on a left ear 496 of a user 490, the display surface 21 is covered by the head of the user 490. Thus, it is less likely that a person sees the display surface 21 of the ear-worn electronic apparatus 1 worn on the left ear 496. When the ear-worn electronic apparatus 1 executes the non-display determination processing using a proximity sensor described above for each of the display surfaces 21 and 22, a display surface that is covered by the head of a user 490 and less likely to be seen by a person can be set to a non-display state.

Note that, when the illuminance sensors 360 and 460 are located on the first main surface 101 and the second main surface 102, respectively, the ear-worn electronic apparatus 1 may execute the non-display determination processing using an illuminance sensor described above.

When the ear-worn electronic apparatus 1 comprises the first and second airflow sensors described above, the non-display determination processing using an airflow sensor may be executed in a similar manner to the above.

The ear-worn electronic apparatus 1 may execute at least two types of non-display determination processing out of the non-display determination processing using a proximity sensor, the non-display determination processing using an illuminance sensor, and the non-display determination processing using an airflow sensor, as provisional determination processing of determining whether or not the target display surface is to be set to a non-display state. Then, based on a result of the provisional determination processing, the ear-worn electronic apparatus 1 may ultimately determine whether or not the target display surface is to be set to a non-display state.

Note that, irrespective of whether the electronic apparatus 1 is a mobile phone or a wearable apparatus, when the controller 200 does not use a detection result obtained by the target touch sensor in determining whether or not the target display surface is to be set to a non-display state, the controller 200 may stop the function of the target touch panel after the controller 200 determines that the target display surface is to be set to a non-display state. This can reduce a probability that the electronic apparatus 1 detects operation performed on a display surface less likely to be seen by a person.

When the target proximity sensor detects an object, the controller 200 may stop the function of the target touch panel, instead of setting the target display surface to a non-display state. When brightness detected by the target illuminance sensor is equal to or less than a threshold value, the controller 200 may stop the function of the target touch panel, instead of setting the target display surface to a non-display state. When airflow detected by the target airflow sensor is equal to or less than a threshold value, the controller 200 may stop the function of the target touch panel, instead of setting the target display surface to a non-display state.

<Display Control According to Rotation of Electronic Apparatus>

The controller 200 can change display of the information display area 20, according to rotation of the electronic apparatus 1. This display control may be hereinafter referred to as display control according to rotation.

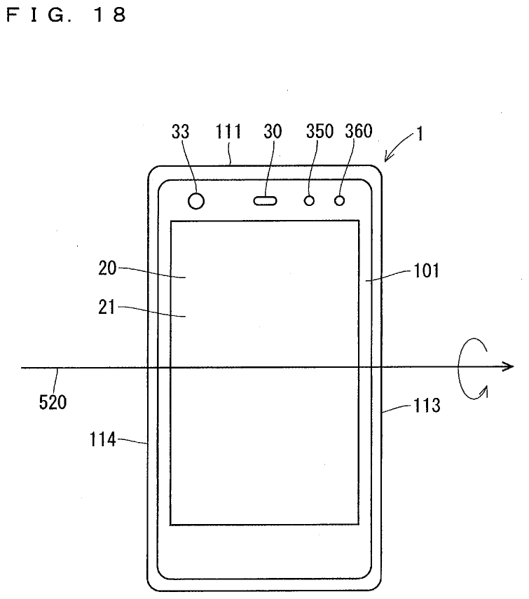

For example, as illustrated in FIG. 17, the controller 200 can change display of the display surfaces 21 and 22, according to rotation about a first rotation axis 510. The first rotation axis 510 is an axis in parallel with the display surfaces 21 and 22, and is in parallel with the long-side direction of the electronic apparatus 1. As illustrated in FIG. 18, the controller 200 can change display of the display surfaces 21 and 22, according to rotation about a second rotation axis 520. The second rotation axis 520 is an axis in parallel with the display surfaces 21 and 22, and is in parallel with the short-side direction of the electronic apparatus 1.

The term “rotation” hereinafter refers to rotation of the electronic apparatus 1, unless otherwise specifically noted. The term “clockwise rotation” in the description of rotation about the first rotation axis 510 of the electronic apparatus 1 refers to clockwise rotation 511 about the first rotation axis 510, when the first rotation axis 510 is seen from the second side surface 112 side as in FIG. 19. The term “counterclockwise rotation” in the description of rotation about the first rotation axis 510 of the electronic apparatus 1 refers to counterclockwise rotation 512 about the first rotation axis 510, when the first rotation axis 510 is seen from the second side surface 112 side as in FIG. 19. In FIG. 19, illustration of the speaker hole 31 and the microphone hole 32 is omitted.

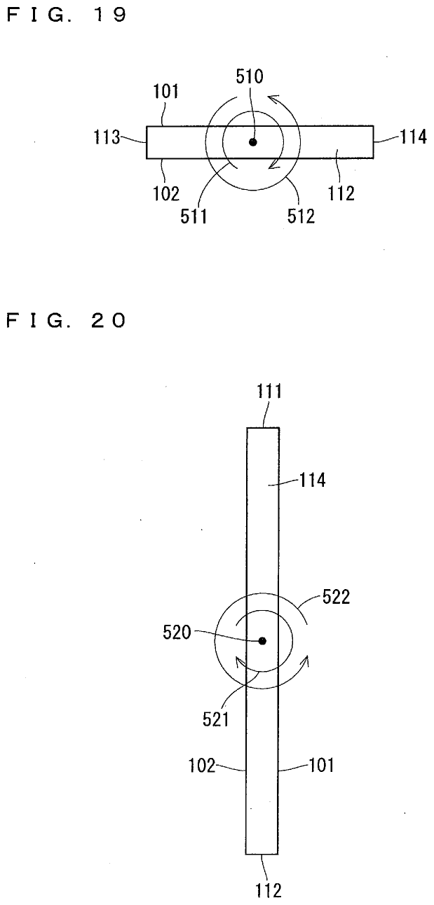

The term “clockwise rotation” in the description of rotation about the second rotation axis 520 of the electronic apparatus 1 refers to clockwise rotation 521 about the second rotation axis 520, when the second rotation axis 520 is seen from the fourth side surface 114 side as in FIG. 20. The term “counterclockwise rotation” in the description of rotation about the second rotation axis 520 of the electronic apparatus 1 refers to counterclockwise rotation 522 about the second rotation axis 520, when the second rotation axis 520 is seen from the fourth side surface 114 side as in FIG. 20. In FIG. 20, illustration of the power button 40 is omitted.

Rotation about the first rotation axis 510 may be referred to as first rotation. Clockwise rotation and counterclockwise rotation about the first rotation axis 510 may be referred to as clockwise first rotation and counterclockwise first rotation, respectively.

Rotation about the second rotation axis 520 may be referred to as second rotation. Clockwise rotation and counterclockwise rotation about the second rotation axis 520 may be referred to as clockwise second rotation and counterclockwise second rotation, respectively.

In one example, the controller 200 can change display of the display surfaces 21 and 22, according to clockwise first rotation. The controller 200 can change display of the display surfaces 21 and 22, according to counterclockwise first rotation. The controller 200 can change display of the display surfaces 21 and 22, according to clockwise second rotation. The controller 200 can change display of the display surfaces 21 and 22, according to counterclockwise second rotation. A plurality of examples of display control according to rotation are described below.

<First Example of Display Control According to Rotation>

In one example, when the controller 200 displays contents consisting of a plurality of pages, the controller 200 controls display of pages in the information display area 20, according to rotation. This display control may be referred to as page display control according to rotation. Examples of the contents consisting of a plurality of pages include a home screen, an electronic book, and a PDF file. It can also be said that a page is one image or one screen.

In page display control according to rotation, for example, according to rotation made while the controller 200 displays a certain page on a display surface, the controller 200 displays another page on another display surface. Specifically, according to rotation about the first rotation axis 510 made while the controller 200 displays a certain page on a display surface, the controller 200 can display another page on another display surface. This display control may be hereinafter referred to as page display control according to first rotation.

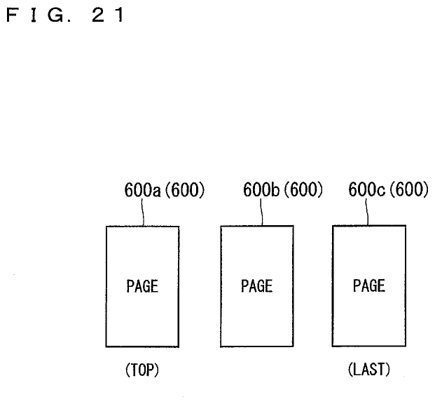

FIG. 21 illustrates a diagram showing one example of a plurality of pages 600 that constitute contents. In one example of FIG. 21, from left to right, the plurality of pages 600 are sequentially illustrated from a top page. The page 600a is a top page 600. The page 600b is a second page 600 from the top page. The page 600c is a last page 600. The pages 600a to 600c may be hereinafter referred to as pages 1 to 3, respectively.

When the electronic apparatus 1 is rotated 180 degrees clockwise about the first rotation axis 510 from a reference orientation while a certain page 600 is displayed on one of the display surfaces 21 and 22, the controller 200 displays a next page 600, which is a page following the certain page 600, on the other of the display surfaces 21 and 22. When the electronic apparatus 1 is rotated 180 degrees clockwise about the first rotation axis 510 from a reference orientation while the last page 600c is displayed on one of the display surfaces 21 and 22, the controller 200 may display the top page 600a or the last page 600c on the other of the display surfaces 21 and 22.

In contrast, when the electronic apparatus 1 is rotated 180 degrees counterclockwise about the first rotation axis 510 from a reference orientation while a certain page 600 is displayed on one of the display surfaces 21 and 22, the controller 200 displays a previous page 600, which is page preceding the certain page 600, on the other of the display surfaces 21 and 22. When the electronic apparatus 1 is rotated 180 degrees counterclockwise about the first rotation axis 510 from a reference orientation while the first page 600a is displayed on one of the display surfaces 21 and 22, the controller 200 may display the last page 600c or the first page 600a on the other of the display surfaces 21 and 22.

According to rotation about the second rotation axis 520 made while the controller 200 displays a certain page on a display surface, the controller 200 can display another page on another display surface. This display control may be hereinafter referred to as page display control according to second rotation.

For example, when the electronic apparatus 1 is rotated 180 degrees clockwise about the second rotation axis 520 from a reference orientation while a certain page 600 is displayed on one of the display surfaces 21 and 22, the controller 200 displays a next page 600, which is a page following the certain page 600, on the other of the display surfaces 21 and 22. When the electronic apparatus 1 is rotated 180 degrees clockwise about the second rotation axis 520 from a reference orientation while the last page 600c is displayed on one of the display surfaces 21 and 22, the controller 200 may display the top page 600a or the last page 600c on the other of the display surfaces 21 and 22.

In contrast, when the electronic apparatus 1 is rotated 180 degrees counterclockwise about the second rotation axis 520 from a reference orientation while a certain page 600 is displayed on one of the display surfaces 21 and 22, the controller 200 displays a previous page 600, which is a page preceding the certain page 600, on the other of the display surfaces 21 and 22. When the electronic apparatus 1 is rotated 180 degrees counterclockwise about the second rotation axis 520 from a reference orientation while the first page 600a is displayed on one of the display surfaces 21 and 22, the controller 200 may display the last page 600c or the first page 600a on the other of the display surfaces 21 and 22.

When the power button 40 is pressed for a short period of time while the operation mode is the sleep mode, the controller 200 sets the operation mode to the normal mode, and stores the present orientation of the electronic apparatus 1 as a reference orientation. For example, the controller 200 can identify an orientation of the electronic apparatus 1, based on detection results obtained by the accelerometer 330 and the gyro sensor 340. When the controller 200 determines that the electronic apparatus 1 has been rotated 180 degrees about the first rotation axis 510 from a reference orientation while the operation mode is the MD mode, the controller 200 stores an orientation of the electronic apparatus 1 after rotation as a new reference orientation. In this case, the rotation may be either clockwise or counterclockwise. When the controller 200 determines that the electronic apparatus 1 has been rotated 180 degrees about the second rotation axis 520 from a reference orientation while the operation mode is the MD mode, the controller 200 stores an orientation of the electronic apparatus 1 after rotation as a new reference orientation. In this case, the rotation may be either clockwise or counterclockwise. For example, the controller 200 can identify a rotation angle of the electronic apparatus 1 about the first rotation axis 510 from a reference orientation, based on detection results obtained by the accelerometer 330 and the gyro sensor 340. Similarly, the controller 200 can identify a rotation angle of the electronic apparatus 1 about the second rotation axis 520 from a reference orientation, based on detection results obtained by the accelerometer 330 and the gyro sensor 340.

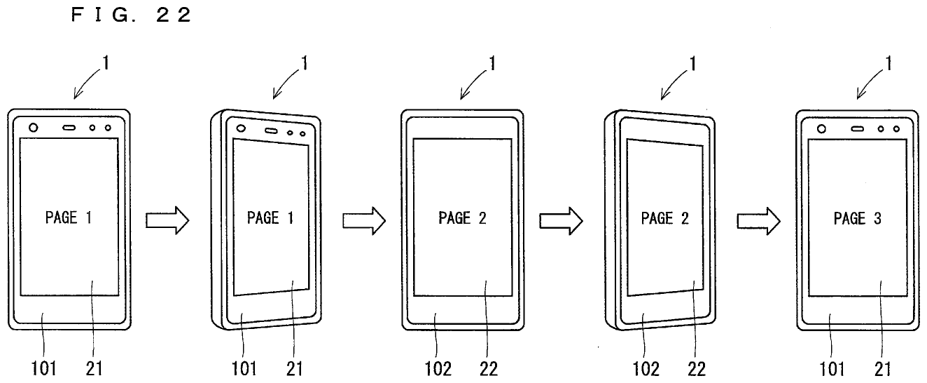

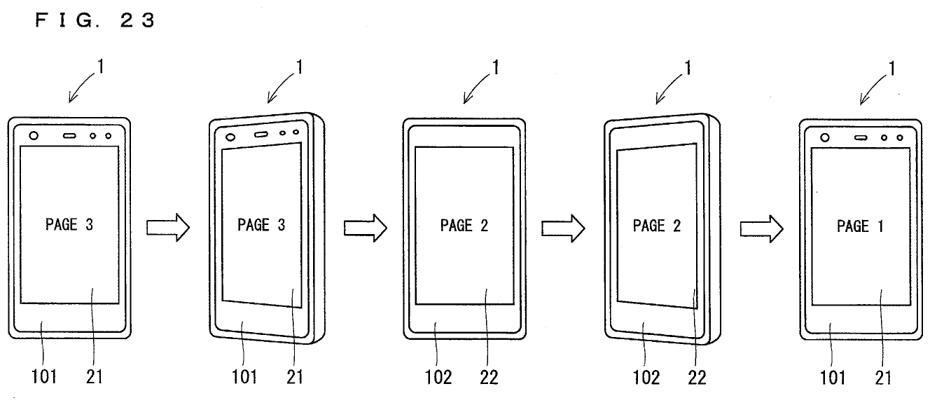

FIG. 22 illustrates a diagram showing one example of how the electronic apparatus 1 makes clockwise first rotation. In FIG. 22, the leftmost electronic apparatus 1 represents an electronic apparatus 1 before rotation, and progress of the rotation is illustrated from left to right. In one example of FIG. 22, a reference orientation of the electronic apparatus 1 before rotation is the orientation of the leftmost electronic apparatus 1. Also in the diagrams to be described later illustrating how the electronic apparatus 1 makes rotation, such as in FIGS. 23 to 27, the leftmost electronic apparatus 1 represents an electronic apparatus 1 before rotation, and progress of the rotation is illustrated from left to right. Additionally, a reference orientation of the electronic apparatus 1 before rotation is the orientation of the leftmost electronic apparatus 1. In one example of FIG. 22, page 1 is displayed on the display surface 21 of the electronic apparatus 1 before rotation.

When the leftmost electronic apparatus 1 displaying page 1 on the display surface 21 is rotated 180 degrees clockwise about the first rotation axis 510 from a reference orientation, page 2, which is a page immediately following page 1, is displayed on the display surface 22 of the electronic apparatus 1, as illustrated in the third electronic apparatus 1 from the left of FIG. 22. At this time, display of page 1 is erased from the display surface 21. Then, the electronic apparatus 1 stores an orientation of the third electronic apparatus 1 from the left of FIG. 22 as a new reference orientation. After that, when the third electronic apparatus 1 from the left of FIG. 22 displaying page 2 on the display surface 22 is rotated 180 degrees clockwise about the first rotation axis 510 from a reference orientation, page 3, which is a page immediately following page 2, is displayed on the display surface 21 of the electronic apparatus 1, as illustrated in the rightmost electronic apparatus 1 of FIG. 22. At this time, display of page 2 is erased from the display surface 22. Then, the electronic apparatus 1 stores an orientation of the rightmost electronic apparatus 1 of FIG. 22 as a new reference orientation.

Here, as one example, as illustrated in FIG. 8 described above, a user holding the electronic apparatus 1 with one hand rotates the electronic apparatus 1 with the hand as illustrated in FIG. 22. When a user holds the leftmost electronic apparatus 1 of FIG. 22 with one hand as in FIG. 8, the hand of the user comes into contact with a wide range of the display surface 22, which is a back display surface for the user. Therefore, the display surface 22 is set to a non-display state, as a result of the non-display determination processing described above. A back display surface for a user refers to a display surface difficult to be seen by a user. A front display surface for a user refers to a display surface easily seen by a user. After that, when the user rotates the electronic apparatus 1 180 degrees clockwise about the first rotation axis 510 with one hand, the hand comes into contact with a wide range of the display surface 21 of the third electronic apparatus 1 from the left of FIG. 22. Therefore, the display surface 21 is set to a non-display state, as a result of the non-display determination processing described above. The hand then comes into contact with a wide range of the display surface 22 of the rightmost electronic apparatus 1 of FIG. 22, causing the display surface 22 to be set to a non-display state. Note that the same holds true for a case in which a user holds the electronic apparatus 1 with both hands.

When a user holding the electronic apparatus 1 with a hand rotates the electronic apparatus 1 about the first rotation axis 510 as described above, the electronic apparatus 1 can display a page on a front display surface for the user, and can set a back display surface for the user to a non-display state at the same time. Then, the electronic apparatus 1 can change a page to be displayed on the front display surface for the user, according to first rotation. Consequently, the user can cause the electronic apparatus 1 to change a page to be displayed on a display surface easily seen by the user, by rotating the electronic apparatus 1 about the first rotation axis 510.

FIG. 23 illustrates a diagram showing one example of how the electronic apparatus 1 makes counterclockwise first rotation. The leftmost electronic apparatus 1 of FIG. 23 is the same as the rightmost electronic apparatus 1 of FIG. 22. In FIG. 23, progress of the rotation is illustrated from left to right.

When the leftmost electronic apparatus 1 is rotated 180 degrees counterclockwise about the first rotation axis 510 from a reference orientation, page 2, which is a page immediately preceding page 3, is displayed on the display surface 22 of the electronic apparatus 1, as illustrated in the third electronic apparatus 1 from the left of FIG. 23. At this time, display of page 3 is erased from the display surface 21. When a hand of a user is in contact with the display surface 21, for example, the display surface 21 is set to a non-display state. Then, the electronic apparatus 1 stores an orientation of the third electronic apparatus 1 from the left of FIG. 23 as a new reference orientation. After that, when the third electronic apparatus 1 from the left of FIG. 23 displaying page 2 on the display surface 22 is rotated 180 degrees counterclockwise about the first rotation axis 510 from a reference orientation, page 1, which is a page immediately preceding page 2, is displayed on the display surface 21 of the electronic apparatus 1, as illustrated in the rightmost electronic apparatus 1 of FIG. 23. At this time, display of page 2 is erased from the display surface 22. When a hand of a user is in contact with the display surface 22, for example, the display surface 22 is set to a non-display state. Then, the electronic apparatus 1 stores an orientation of the rightmost electronic apparatus 1 of FIG. 23 as a new reference orientation.

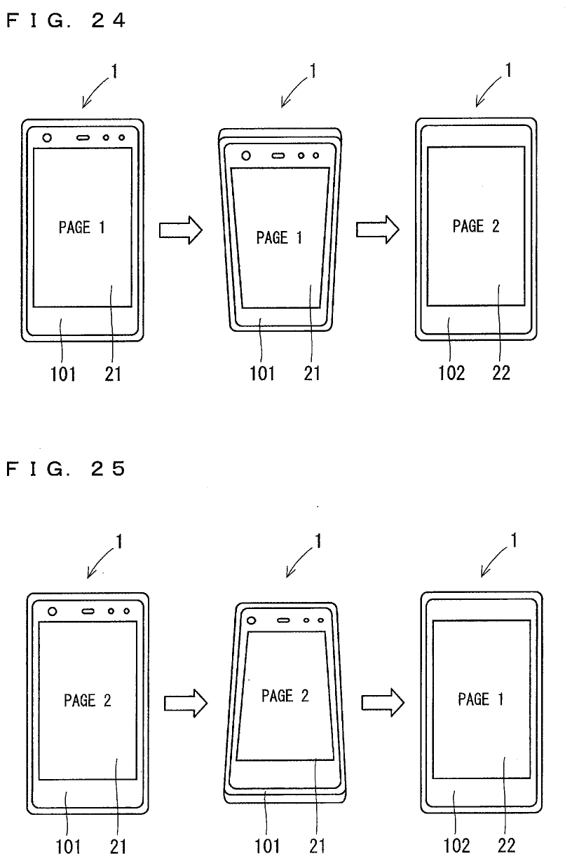

FIG. 24 illustrates a diagram showing one example of how the electronic apparatus 1 makes clockwise second rotation. In FIG. 24, the leftmost electronic apparatus 1 represents an electronic apparatus 1 before rotation, the middle electronic apparatus 1 represents an electronic apparatus 1 in the process of rotation, and the rightmost electronic apparatus 1 represents an electronic apparatus 1 after rotation. In one example of FIG. 24, page 1 is displayed on the display surface 21 of the electronic apparatus 1 before rotation.

When the leftmost electronic apparatus 1 displaying page 1 on the display surface 21 is rotated 180 degrees clockwise about the second rotation axis 520 from a reference orientation, page 2, which is a page following page 1, is displayed on the display surface 22 of the electronic apparatus 1, as illustrated in the rightmost electronic apparatus 1 of FIG. 24. At this time, display of page 1 is erased from the display surface 21. When a hand of a user is in contact with the display surface 21, for example, the display surface 21 is set to a non-display state. Then, the electronic apparatus 1 stores an orientation of the rightmost electronic apparatus 1 of FIG. 24 as a new reference orientation.

FIG. 25 illustrates a diagram showing one example of how the electronic apparatus 1 makes counterclockwise second rotation. The leftmost electronic apparatus 1 of FIG. 25 is the same as the rightmost electronic apparatus 1 of FIG. 24. When the leftmost electronic apparatus 1 is rotated 180 degrees counterclockwise about the second rotation axis 520 from a reference orientation, page 1, which is a page immediately preceding page 2, is displayed on the display surface 22 of the electronic apparatus 1, as illustrated in the rightmost electronic apparatus 1 FIG. 25. At this time, display of page 2 is erased from the display surface 21. When a hand of a user is in contact with the display surface 21, for example, the display surface 21 is set to a non-display state. Then, the electronic apparatus 1 stores an orientation of the rightmost electronic apparatus 1 of FIG. 25 as a new reference orientation.

Note that, when the electronic apparatus 1 is rotated 180 degrees clockwise about the first rotation axis 510 while a certain page is displayed on one display surface, a page that is a plurality of pages after the certain page may be displayed on the other display surface. Similarly, when the electronic apparatus 1 is rotated 180 degrees counterclockwise about the first rotation axis 510 while a certain page is displayed on one display surface, a page that is a plurality of pages before the certain page may be displayed on the other display surface.

When the electronic apparatus 1 is rotated 180 degrees clockwise about the second rotation axis 520 while a certain page is displayed on one display surface, a page that is a plurality of pages after the certain page may be displayed on the other display surface. Similarly, when the electronic apparatus 1 is rotated 180 degrees counterclockwise about the second rotation axis 520 while a certain page is displayed on one display surface, a page that is a plurality of pages before the certain page may be displayed on the other display surface.

When predetermined operation is performed on the target display surface while the controller 200 displays a certain page on the target display surface, the controller 200 may display a page different from the certain page on the target display surface. For example, when rightward slide operation or flick operation is performed on the target display surface while the controller 200 displays a certain page on the target display surface, the controller 200 may display a page following the certain page on the target display surface. When leftward slide operation or flick operation is performed on the target display surface while the controller 200 displays a certain page on the target display surface, the controller 200 may display a page preceding the certain page on the target display surface.

As described above, the electronic apparatus 1 according to one example changes display of the information display area 20, according to first rotation or second rotation of the electronic apparatus 1. Consequently, the user can cause the electronic apparatus 1 to change display by rotating the electronic apparatus 1 about the first rotation axis 510 or the second rotation axis 520. As a result, convenience of the electronic apparatus 1 is enhanced.

In one example, the electronic apparatus 1 changes display of both the display surfaces 21 and 22, according to first rotation or second rotation. Consequently, the user can cause the electronic apparatus 1 to change display of both the display surfaces 21 and 22, by rotating the electronic apparatus 1 about the first rotation axis 510 or the second rotation axis 520.

In one example, according to first rotation or second rotation made while a certain page is displayed on one display surface, the electronic apparatus 1 displays a page different from the certain page on the other display surface. Through such page display control according to rotation, the user can cause the electronic apparatus 1 to change a page to be seen by the user, by rotating the electronic apparatus 1 about the first rotation axis 510 or the second rotation axis 520.

In one example, when one display surface is in a display state, the electronic apparatus 1 can set the other display surface to a non-display state. Therefore, power consumption of the electronic apparatus 1 is reduced.

Note that the controller 200 need not execute the page display control according to first rotation. The controller 200 need not execute the page display control according to second rotation.

When the electronic apparatus 1 operates in the SD mode, the controller 200 may change a page to be displayed on the display surface 21 in a display state, according to rotation. Page display control according to rotation when the electronic apparatus 1 operates in the SD mode is described below.

When the electronic apparatus 1 is rotated 360 degrees clockwise about the first rotation axis 510 from a reference orientation while a certain page 600 is displayed on the display surface 21, the controller 200 displays a next page 600, which is a page following the certain page 600, on the display surface 21. Then, when the electronic apparatus 1 is rotated 360 degrees clockwise about the first rotation axis 510 from a reference orientation, the controller 200 stores an orientation of the electronic apparatus 1 after rotation as a new reference orientation. When the electronic apparatus 1 is rotated 360 degrees clockwise about the first rotation axis 510 from a reference orientation while the last page 600c is displayed on the display surface 21, the controller 200 may display the top page 600a or the last page 600c on the display surface 21.

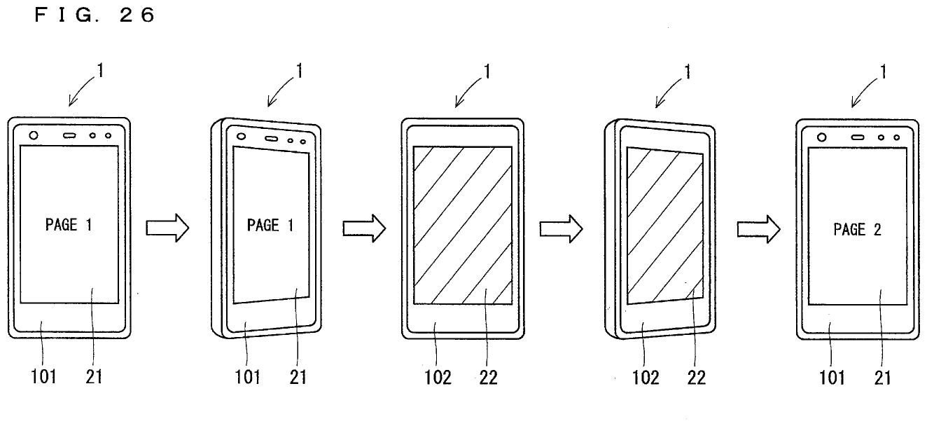

FIG. 26 illustrates a diagram showing one example of how the electronic apparatus 1 is rotated 360 degrees clockwise about the first rotation axis 510. In FIG. 26, a hatched display surface 22 indicates that the display surface 22 is in a non-display state. Also in the diagrams to be described later, a hatched display surface 22 indicates that the display surface 22 is in a non-display state. In one example of FIG. 26, page 1 is displayed on the display surface 21 of the leftmost electronic apparatus 1 before rotation.

When the leftmost electronic apparatus 1 in the SD mode is rotated 360 degrees clockwise about the first rotation axis 510 from a reference orientation, page 2, which is a page immediately following page 1, is displayed on the display surface 21 of the electronic apparatus 1, as illustrated in the rightmost electronic apparatus 1 of FIG. 26. Then, the electronic apparatus 1 stores an orientation of the rightmost electronic apparatus 1 of FIG. 26 as a new reference orientation. After that, when the rightmost electronic apparatus 1 of FIG. 26 is rotated 360 degrees clockwise about the first rotation axis 510, page 3 is displayed on the display surface 21.

When the electronic apparatus 1 is rotated 360 degrees counterclockwise about the first rotation axis 510 from a reference orientation while the operation mode is the SD mode and a certain page 600 is displayed on the display surface 21, the controller 200 displays a previous page 600, which is a page preceding the certain page 600, on the display surface 21. Then, when the electronic apparatus 1 is rotated 360 degrees counterclockwise about the first rotation axis 510 from a reference orientation, the controller 200 stores an orientation of the electronic apparatus 1 after rotation as a new reference orientation. When the electronic apparatus 1 is rotated 360 degrees counterclockwise about the first rotation axis 510 from a reference orientation while the top page 600a is displayed on the display surface 21, the controller 200 may display the top page 600a or the last page 600c on the display surface 21.

When the electronic apparatus 1 is rotated 360 degrees clockwise about the second rotation axis 520 from a reference orientation while the operation mode is the SD mode and a certain page 600 is displayed on the display surface 21, the controller 200 displays a next page 600, which is a page following the certain page 600, on the display surface 21. Then, when the electronic apparatus 1 is rotated 360 degrees clockwise about the second rotation axis 520 from a reference orientation, the controller 200 stores an orientation of the electronic apparatus 1 after rotation as a new reference orientation. When the electronic apparatus 1 is rotated 360 degrees clockwise about the second rotation axis 520 from a reference orientation while the last page 600c is displayed on the display surface 21, the controller 200 may display the top page 600a or the last page 600c on the display surface 21.

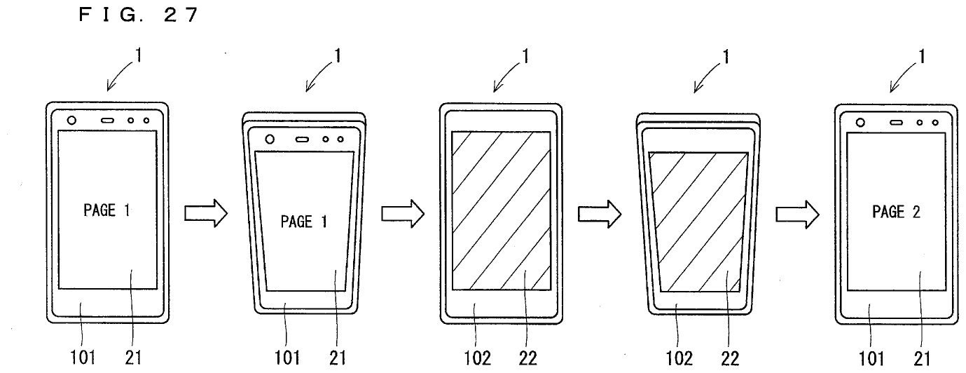

FIG. 27 illustrates a diagram showing one example of how the electronic apparatus 1 is rotated 360 degrees clockwise about the second rotation axis 520. In one example of FIG. 27, page 1 is displayed on the display surface 21 of the leftmost electronic apparatus 1 before rotation.

When the leftmost electronic apparatus 1 in the SD mode is rotated 360 degrees clockwise about the second rotation axis 520 from a reference orientation, page 2, which is a page immediately following page 1, is displayed on the display surface 21 of the electronic apparatus 1, as illustrated in the rightmost electronic apparatus 1 of FIG. 27. Then, the electronic apparatus 1 stores an orientation of the rightmost electronic apparatus 1 of FIG. 27 as a new reference orientation. After that, when the rightmost electronic apparatus 1 of FIG. 27 is rotated 360 degrees clockwise about the second rotation axis 520, page 3 is displayed on the display surface 21.

When the electronic apparatus 1 is rotated 360 degrees counterclockwise about the second rotation axis 520 from a reference orientation while the operation mode is the SD mode and a certain page 600 is displayed on the display surface 21, the controller 200 displays a previous page 600, which is a page preceding the certain page 600, on the display surface 21. Then, when the electronic apparatus 1 is rotated 360 degrees counterclockwise about the second rotation axis 520 from a reference orientation, the controller 200 stores an orientation of the electronic apparatus 1 after rotation as a new reference orientation. When the electronic apparatus 1 is rotated 360 degrees counterclockwise about the second rotation axis 520 from a reference orientation while the top page 600a is displayed on the display surface 21, the controller 200 may display the top page 600a or the last page 600c on the display surface 21.

In this manner, when the electronic apparatus 1 is in the SD mode, the controller 200 changes a page to be displayed on the display surface 21, according to first rotation or second rotation. Consequently, the user can cause the electronic apparatus 1 to change a page to be displayed on the display surface 21, by rotating the electronic apparatus 1 about the first rotation axis 510 or the second rotation axis 520. As a result, convenience of the electronic apparatus 1 is enhanced.

Note that, when the electronic apparatus 1 is rotated 360 degrees clockwise about the first rotation axis 510 while a certain page is displayed on the display surface 21, a page that is a plurality of pages after the certain page may be displayed on the display surface 21. When the electronic apparatus 1 is rotated 360 degrees counterclockwise about the first rotation axis 510 while a certain page is displayed on the display surface 21, a page that is a plurality of pages before the certain page may be displayed on the display surface 21. When the electronic apparatus 1 is rotated 360 degrees clockwise about the second rotation axis 520 while a certain page is displayed on the display surface 21, a page that is a plurality of pages after the certain page may be displayed on the display surface 21. When the electronic apparatus 1 is rotated 360 degrees counterclockwise about the second rotation axis 520 while a certain page is displayed on the display surface 21, a page that is a plurality of pages before the certain page may be displayed on the display surface 21.

The controller 200 need not execute the processing of changing a page to be displayed on the display surface 21, according to first rotation of the electronic apparatus 1. The controller 200 need not execute the processing of changing a page to be displayed on the display surface 21, according to second rotation of the electronic apparatus 1.

Even when the electronic apparatus 1 comprises only the display surface 21 out of the display surfaces 21 and 22, the controller 200 can change a page to be displayed on the display surface 21, according to rotation, similarly to when the electronic apparatus 1 is in the SD mode.

<Second Example of Display Control According to Rotation>

The controller 200 can display a screen associated with an executed application in a display area. For example, when the controller 200 executes a browser, the controller 200 displays a screen showing a webpage on a display surface, as a screen associated with the browser. When the controller 200 executes an email application, the controller 200 displays a screen, such as a screen for creating an email or a screen showing a list of received emails, on a display surface, as a screen associated with the email application. When the controller 200 executes a map application, the controller 200 displays a screen showing a map on a display surface, as a screen associated with the map application. The screen associated with an executed application may be hereinafter referred to as an application screen.

In one example, the controller 200 can control display of an application screen in the information display area 20, according to rotation. This display control may be hereinafter referred to as display control for an application screen according to rotation.

For example, according to rotation of the electronic apparatus 1 made while the controller 200 displays a certain application screen on one display surface, the controller 200 can display another type of application screen that is different from the certain application screen on the other display surface. More specifically, according to first rotation of the electronic apparatus 1 made while the controller 200 displays a certain application screen on one display surface, the controller 200 can display another type of application screen that is different from the certain application screen on the other display surface. This display control may be referred to as display control for an application screen according to first rotation. According to second rotation of the electronic apparatus 1 made while the controller 200 displays a certain application screen on one display surface, the controller 200 can display another type of application screen that is different from the certain application screen on the other display surface. This display control may be referred to as display control for an application screen according to second rotation. The display control for an application screen according to rotation is described in detail below.

When the controller 200 executes a plurality of applications, the controller 200 assigns ordinal numbers to a plurality of types of application screens associated with the plurality of respective applications. The ordinal numbers are assigned for the display control for an application screen according to rotation.

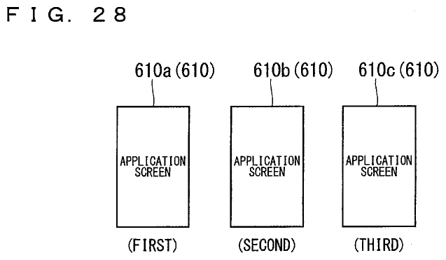

FIG. 28 illustrates a diagram showing one example of how ordinal numbers are assigned to a plurality of types of application screens 610 associated with a plurality of respective executed applications. In one example of FIG. 28, the ordinal numbers first to third are assigned to a plurality of types of application screens 610a to 610c, respectively. For example, the controller 200 assigns ordinal numbers to application screens in ascending order, from an application screen associated with an application having the earliest execution start timing. In one example of FIG. 28, an application associated with the application screen 610a is executed first, out of the plurality of executed applications. How ordinal numbers are assigned to applications is not limited to one example described above.

When the electronic apparatus 1 is rotated 180 degrees clockwise about the first rotation axis 510 from a reference orientation while a certain application screen 610 is displayed on one of the display surfaces 21 and 22, the controller 200 displays a next application screen 610, which is an application screen following the certain application screen 610, on the other of the display surfaces 21 and 22. When the electronic apparatus 1 is rotated 180 degrees clockwise about the first rotation axis 510 from a reference orientation while the last application screen 610c is displayed on one of the display surfaces 21 and 22, the controller 200 may display the first application screen 610a or the last application screen 610c on the other of the display surfaces 21 and 22.

In contrast, when the electronic apparatus 1 is rotated 180 degrees counterclockwise about the first rotation axis 510 from a reference orientation while a certain application screen 610 is displayed on one of the display surfaces 21 and 22, the controller 200 displays a previous application screen 610, which is an application screen preceding the certain application screen 610, on the other of the display surfaces 21 and 22. When the electronic apparatus 1 is rotated 180 degrees counterclockwise about the first rotation axis 510 from a reference orientation while the first application screen 610a is displayed on one of the display surfaces 21 and 22, the controller 200 may display the last application screen 610c or the first application screen 610a on the other of the display surfaces 21 and 22.

When the electronic apparatus 1 is rotated 180 degrees clockwise about the second rotation axis 520 from a reference orientation while a certain application screen 610 is displayed on one of the display surfaces 21 and 22, the controller 200 displays a next application screen 610, which is an application screen following the certain application screen 610, on the other of the display surfaces 21 and 22. When the electronic apparatus 1 is rotated 180 degrees clockwise about the second rotation axis 520 from a reference orientation while the last application screen 610c is displayed on one of the display surfaces 21 and 22, the controller 200 may display the first application screen 610a or the last application screen 610c on the other of the display surfaces 21 and 22.

In contrast, when the electronic apparatus 1 is rotated 180 degrees counterclockwise about the second rotation axis 520 from a reference orientation while a certain application screen 610 is displayed on one of the display surfaces 21 and 22, the controller 200 displays a previous application screen 610, which is an application screen preceding the certain application screen 610, on the other of the display surfaces 21 and 22. When the electronic apparatus 1 is rotated 180 degrees counterclockwise about the second rotation axis 520 from a reference orientation while the first application screen 610a is displayed on one of the display surfaces 21 and 22, the controller 200 may display the last application screen 610c or the first application screen 610a on the other of the display surfaces 21 and 22. A method of determining a reference orientation is the same as that described above.

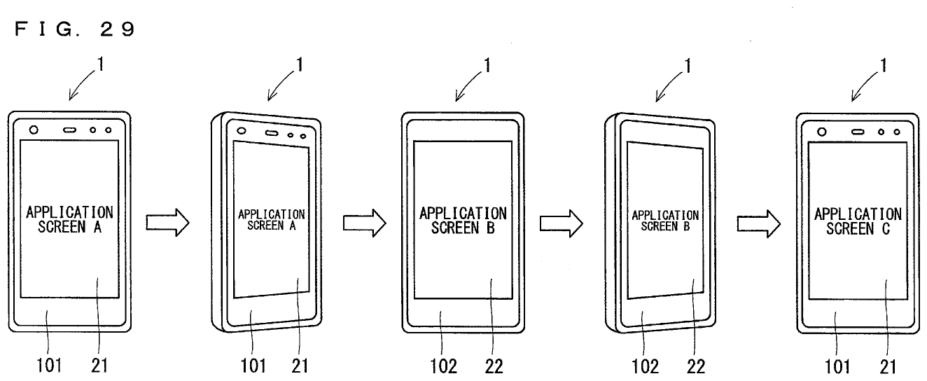

Here, the application screens 610a to 610c are represented by application screens A to C, respectively. As one example, the application screen A is displayed on the display surface 21 of the leftmost electronic apparatus 1 in one example of FIG. 22 described above. In this case, similarly to one example of FIG. 22, display of the electronic apparatus 1 when the electronic apparatus 1 makes clockwise first rotation is as illustrated in FIG. 29. The application screen B is displayed on the display surface 22 of the third electronic apparatus 1 from the left of FIG. 29. The application screen C is displayed on the display surface 21 of the rightmost electronic apparatus 1 of FIG. 29.

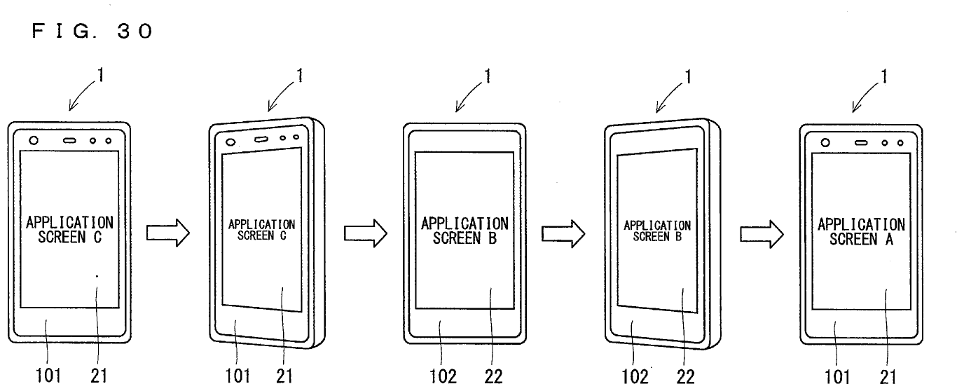

As one example, the application screen C is displayed on the display surface 21 of the leftmost electronic apparatus 1 in one example of FIG. 23 described above. In this case, similarly to one example of FIG. 23, display of the electronic apparatus 1 when the electronic apparatus 1 makes counterclockwise first rotation is as illustrated in FIG. 30. The application screen B is displayed on the display surface 22 of the third electronic apparatus 1 from the left of FIG. 30. The application screen A is displayed on the display surface 21 of the rightmost electronic apparatus 1 of FIG. 30.

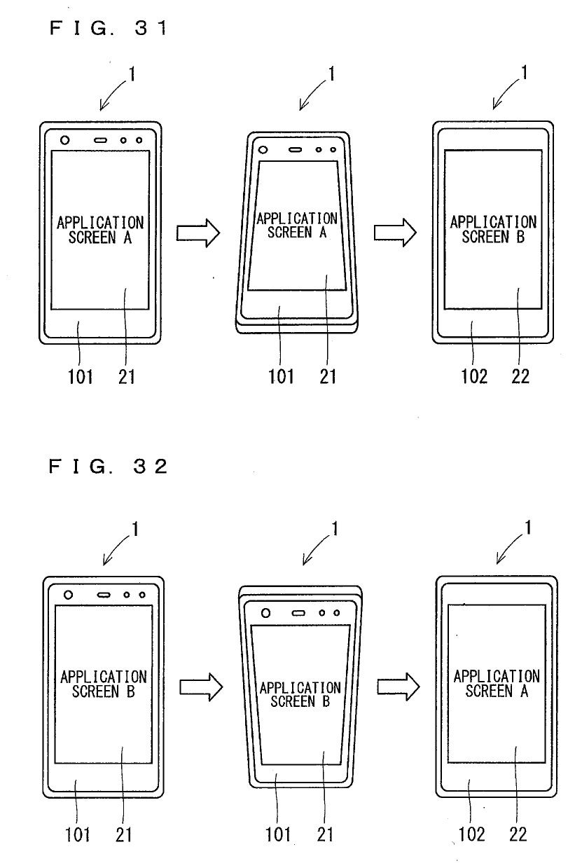

As one example, as illustrated in FIG. 31, the application screen A is displayed on the display surface 21 of the leftmost electronic apparatus 1 in one example of FIG. 24 described above. In this case, similarly to one example of FIG. 24, when the electronic apparatus 1 makes clockwise second rotation, the application screen B is displayed on the display surface 22 as in the rightmost electronic apparatus 1 of FIG. 31.

As one example, as illustrated in FIG. 32, the application screen B is displayed on the display surface 21 of the leftmost electronic apparatus 1 in one example of FIG. 25 described above. In this case, similarly to one example of FIG. 25, when the electronic apparatus 1 makes counterclockwise second rotation, the application screen A is displayed on the display surface 22 as in the rightmost electronic apparatus 1 of FIG. 32.

In this manner, in one example, according to first rotation or second rotation made while a screen associated with a certain executed application is displayed on one display surface, the electronic apparatus 1 displays a screen associated with another executed application that is different from the certain application on the other display surface. Through such display control for an application screen according to rotation, the user can cause the electronic apparatus 1 to change a type of application screen to be seen by the user, by rotating the electronic apparatus 1 about the first rotation axis 510 or the second rotation axis 520.

When first rotation or second rotation of the electronic apparatus 1 is made, the electronic apparatus 1 can display an application screen on a front display surface for a user (i.e., a display area easily seen by a user), and can set a back display surface for a user (i.e., a display area difficult to be seen by a user) to a non-display state at the same time, as a result of execution of the non-display determination processing described above.

Note that, when predetermined operation is performed on the target display surface while the controller 200 displays a certain application screen on the target display surface, the controller 200 may display another type of application screen that is different from the certain application screen on the target display surface.

The controller 200 need not execute the display control for an application screen according to first rotation. The controller 200 need not execute the display control for an application screen according to second rotation.

When the electronic apparatus 1 operates in the SD mode, the controller 200 may change an application screen to be displayed on the display surface 21 in a display state, according to rotation. Display control for an application screen according to rotation when the electronic apparatus 1 operates in the SD mode is described below.

When the electronic apparatus 1 is rotated 360 degrees clockwise about the first rotation axis 510 from a reference orientation while a certain application screen 610 is displayed on the display surface 21, the controller 200 displays a next application screen 610, which is an application screen following the certain application screen 610, on the display surface 21. Then, the controller 200 stores an orientation of the electronic apparatus 1 after rotation as a new reference orientation. When the electronic apparatus 1 is rotated 360 degrees clockwise about the first rotation axis 510 from a reference orientation while the last application screen 610c is displayed on the display surface 21, the controller 200 may display the first application screen 610a or the last application screen 610c on the display surface 21.

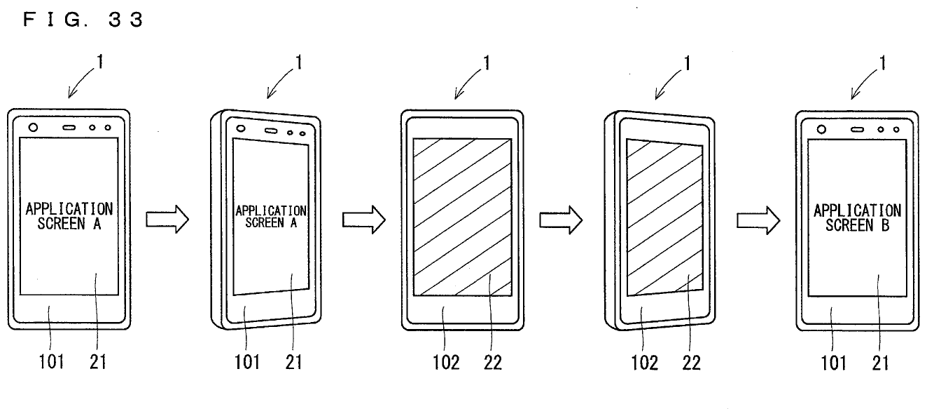

FIG. 33 illustrates a diagram showing one example of how the electronic apparatus 1 is rotated 360 degrees clockwise about the first rotation axis 510. In one example of FIG. 33, the application screen A is displayed on the display surface 21 of the leftmost electronic apparatus 1 before rotation.

When the leftmost electronic apparatus 1 in the SD mode is rotated 360 degrees clockwise about the first rotation axis 510 from a reference orientation, the application screen B, which is an application screen following the application screen A, is displayed on the display surface 21 of the electronic apparatus 1, as illustrated in the rightmost electronic apparatus 1 of FIG. 33. Then, the electronic apparatus 1 stores an orientation of the rightmost electronic apparatus 1 of FIG. 33 as a new reference orientation. After that, when the rightmost electronic apparatus 1 of FIG. 33 is rotated 360 degrees clockwise about the first rotation axis 510, the application screen C is displayed on the display surface 21.

When the electronic apparatus 1 is rotated 360 degrees counterclockwise about the first rotation axis 510 from a reference orientation while the operation mode is the SD mode and a certain application screen 610 is displayed on the display surface 21, the controller 200 displays a previous application screen 610, which is an application screen preceding the certain application screen 610, on the display surface 21. Then, the controller 200 stores an orientation of the electronic apparatus 1 after rotation as a new reference orientation. When the electronic apparatus 1 is rotated 360 degrees counterclockwise about the first rotation axis 510 from a reference orientation while the first application screen 610a is displayed on the display surface 21, the controller 200 may display the first application screen 610a or the last application screen 610c on the display surface 21.

When the electronic apparatus 1 is rotated 360 degrees clockwise about the second rotation axis 520 from a reference orientation while the operation mode is the SD mode and a certain application screen 610 is displayed on the display surface 21, the controller 200 displays a next application screen 610, which is an application screen following the certain application screen 610, on the display surface 21. Then, the controller 200 stores an orientation of the electronic apparatus 1 after rotation as a new reference orientation. When the electronic apparatus 1 is rotated 360 degrees clockwise about the second rotation axis 520 from a reference orientation while the last application screen 610c is displayed on the display surface 21, the controller 200 may display the first application screen 610a or the last application screen 610c on the display surface 21.

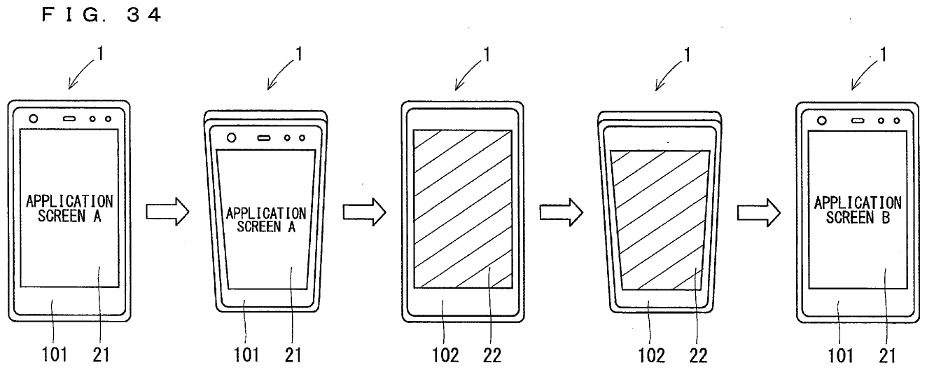

FIG. 34 illustrates a diagram showing one example of how the electronic apparatus 1 is rotated 360 degrees clockwise about the second rotation axis 520. In one example of FIG. 34, the application screen A is displayed on the display surface 21 of the leftmost electronic apparatus 1 before rotation.

When the leftmost electronic apparatus 1 in the SD mode is rotated 360 degrees clockwise about the second rotation axis 520 from a reference orientation, the application screen B, which is an application screen immediately following the application screen A, is displayed on the display surface 21 of the electronic apparatus 1, as illustrated in the rightmost electronic apparatus 1 of FIG. 34. Then, the electronic apparatus 1 stores an orientation of the rightmost electronic apparatus 1 of FIG. 34 as a new reference orientation. After that, when the rightmost electronic apparatus 1 of FIG. 34 is rotated 360 degrees clockwise about the second rotation axis 520, the application screen C is displayed on the display surface 21.

When the electronic apparatus 1 is rotated 360 degrees counterclockwise about the second rotation axis 520 from a reference orientation while the operation mode is the SD mode and a certain application screen 610 is displayed on the display surface 21, the controller 200 displays a previous application screen 610, which is an application screen preceding the certain application screen 610, on the display surface 21. Then, the controller 200 stores an orientation of the electronic apparatus 1 after rotation as a new reference orientation. When the electronic apparatus 1 is rotated 360 degrees counterclockwise about the second rotation axis 520 from a reference orientation while the first application screen 610a is displayed on the display surface 21, the controller 200 may display the first application screen 610a or the last application screen 610c on the display surface 21.

In this manner, when the electronic apparatus 1 is in the SD mode, the controller 200 changes a type of application screen to be displayed on the display surface 21, according to first rotation or second rotation. Consequently, the user can cause the electronic apparatus 1 to change a type of application screen to be displayed on the display surface 21, by rotating the electronic apparatus 1 about the first rotation axis 510 or the second rotation axis 520. As a result, convenience of the electronic apparatus 1 is enhanced.

Note that the controller 200 need not execute the processing of changing a type of application screen to be displayed on the display surface 21, according to first rotation of the electronic apparatus 1. The controller 200 need not execute the processing of changing a type of application screen to be displayed on the display surface 21, according to second rotation of the electronic apparatus 1.

Even when the electronic apparatus 1 comprises only the display surface 21 out of the display surfaces 21 and 22, the controller 200 can change a type of application screen to be displayed on the display surface 21, according to rotation, similarly to when the electronic apparatus 1 is in the SD mode.

<Third Example of Display Control According to Rotation>

The controller 200 can display a part of one image on a display surface. For example, when the controller 200 displays a webpage on a display surface, the controller 200 can display only a part of the webpage on the display surface. When the controller 200 displays a map on a display surface, the controller 200 can display only a part of the map on the display surface. When the controller 200 displays a certain page on a display surface, the controller 200 can display only a part of the certain page on the display surface. A part displayed by the controller 200 within one image may be hereinafter referred to as a display target part.

In one example, the controller 200 can control display of a display target part in the information display area 20, according to rotation. This display control may be hereinafter referred to as display control for a display target part according to rotation.

For example, according to first rotation made while a display target part of one image is displayed on one display surface, the controller 200 can change the display target part and display the changed display target part on the other display surface. This display control may be referred to as display control for a display target part according to first rotation. According to second rotation made while a display target part of one image is displayed on one display surface, the controller 200 can change the display target part and display the changed display target part on the other display surface. This display control may be referred to as display control for a display target part according to second rotation. The display control for a display target part according to rotation is described in detail below.

In one example, when the electronic apparatus 1 is rotated 180 degrees clockwise about the first rotation axis 510 from a reference orientation while the controller 200 displays a display target part on one display surface, the controller 200 shifts the display target part leftward by a first predetermined amount within one image and displays the shifted display target part on the other display surface. For example, the first predetermined amount is set to a value equal to a value of the width of the display target part.

When the electronic apparatus 1 is rotated 180 degrees counterclockwise about the first rotation axis 510 from a reference orientation while the controller 200 displays a display target part on one display surface, the controller 200 shifts the display target part rightward by a second predetermined amount within one image and displays the shifted display target part on the other display surface. For example, the second predetermined amount is set to a value equal to a value of the width of the display target part.

In one example, when the electronic apparatus 1 is rotated 180 degrees clockwise about the second rotation axis 520 from a reference orientation while the controller 200 displays a display target part on one display surface, the controller 200 shifts the display target part upward by a third predetermined amount within one image and displays the shifted display target part on the other display surface. For example, the third predetermined amount is set to a value equal to a value of the length of the display target part.

When the electronic apparatus 1 is rotated 180 degrees counterclockwise about the second rotation axis 520 from a reference orientation while the controller 200 displays a display target part on one display surface, the controller 200 shifts the display target part downward by a fourth predetermined amount within one image and displays the shifted display target part on the other display surface. For example, the fourth predetermined amount is set to a value equal to a value of the length of the display target part. Note that a specific example of each of the first to fourth predetermined amounts is not limited to one example described above. A method of setting a reference orientation is the same as that described above.

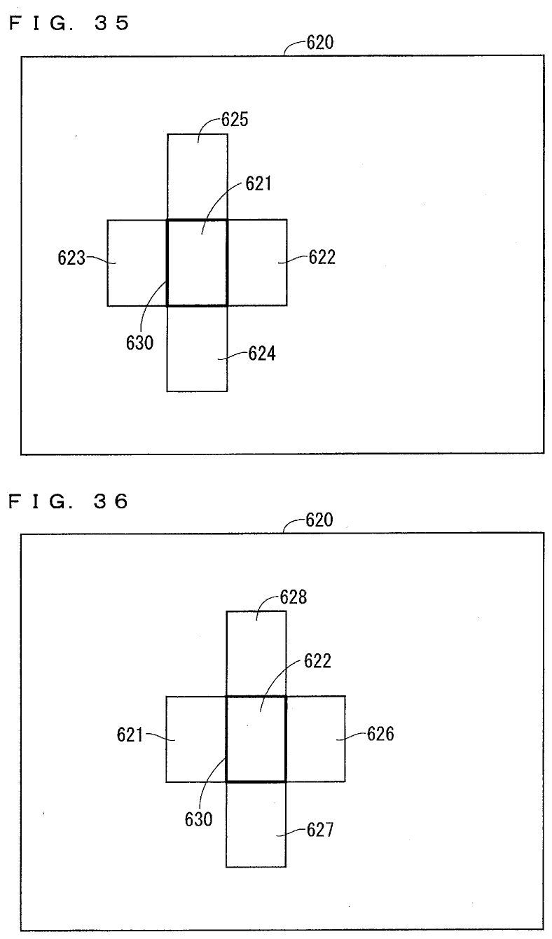

As one example, a display target part 630 currently displayed on one display surface within one image 620 is an area 621 illustrated in FIG. 35. In this case, when the electronic apparatus 1 is rotated 180 degrees clockwise about the first rotation axis 510 from a reference orientation, an area 623, which is an area on the left side of the area 621, is displayed on the other display surface as the display target part 630. When the electronic apparatus 1 is rotated 180 degrees counterclockwise about the first rotation axis 510 from a reference orientation, an area 622, which is an area on the right side of the area 621, is displayed on the other display surface as the display target part 630. When the electronic apparatus 1 is rotated 180 degrees clockwise about the second rotation axis 520 from a reference orientation, an area 625, which is an area on the upper side of the area 621, is displayed on the other display surface as the display target part 630. When the electronic apparatus 1 is rotated 180 degrees counterclockwise about the second rotation axis 520 from a reference orientation, an area 624, which is an area on the lower side of the area 621, is displayed on the other display surface as the display target part 630.

FIG. 36 illustrates a diagram showing a state after the display target part 630 is changed from the area 621 to the area 622. As illustrated in FIG. 36, when the electronic apparatus 1 is rotated 180 degrees clockwise about the first rotation axis 510 from a reference orientation while the area 622 is displayed as a display target part 630 on one display surface, the area 621 on the left side of the area 622 is displayed on the other display surface. When the electronic apparatus 1 is rotated 180 degrees counterclockwise about the first rotation axis 510 from a reference orientation, the area 626 on the right side of the area 622 is displayed on the other display surface. When the electronic apparatus 1 is rotated 180 degrees clockwise about the second rotation axis 520 from a reference orientation, the area 628 on the upper side of the area 622 is displayed on the other display surface. When the electronic apparatus 1 is rotated 180 degrees counterclockwise about the second rotation axis 520 from a reference orientation, the area 627 on the lower side of the area 622 is displayed on the other display surface.

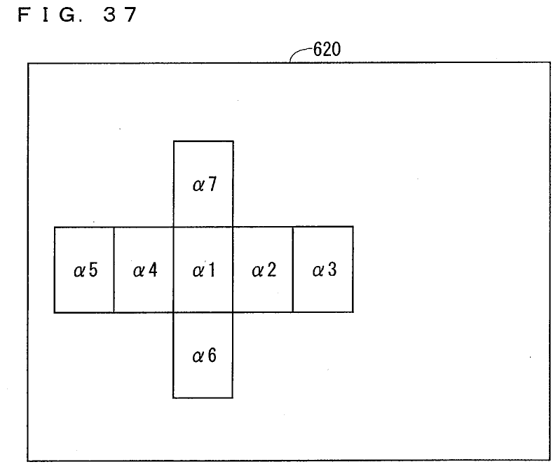

Here, the areas 621, 622, 626, and 623 are represented by areas α1, α2, α3, and α4, respectively. The areas 624 and 625 are represented by areas α6 and α7, respectively. An area located on the left side of the area 621 and having a size the same as the size of the display target part 630 is represented by an area α5. The areas α1 to α7 are as illustrated in FIG. 37.

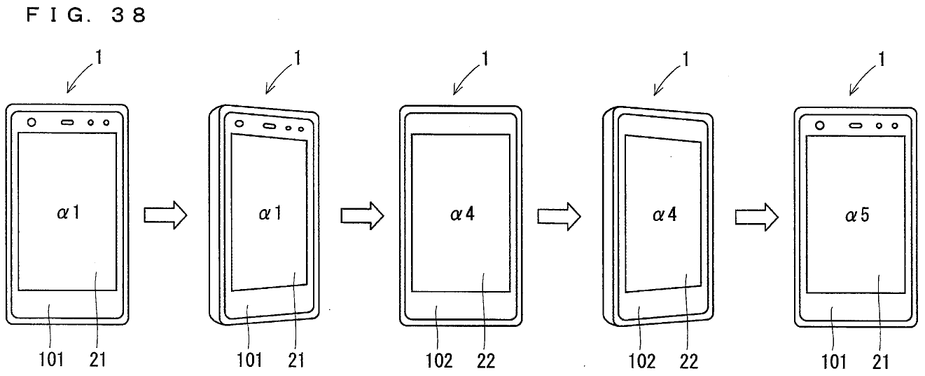

As one example, the area α1 is displayed on the display surface 21 of the leftmost electronic apparatus 1 in one example of FIG. 22 described above. In this case, similarly to one example of FIG. 22, display of the electronic apparatus 1 when the electronic apparatus 1 makes clockwise first rotation is as illustrated in FIG. 38. The area α4 is displayed on the display surface 22 of the third electronic apparatus 1 from the left of FIG. 38. The area α5 is displayed on the display surface 21 of the rightmost electronic apparatus 1 of FIG. 38.

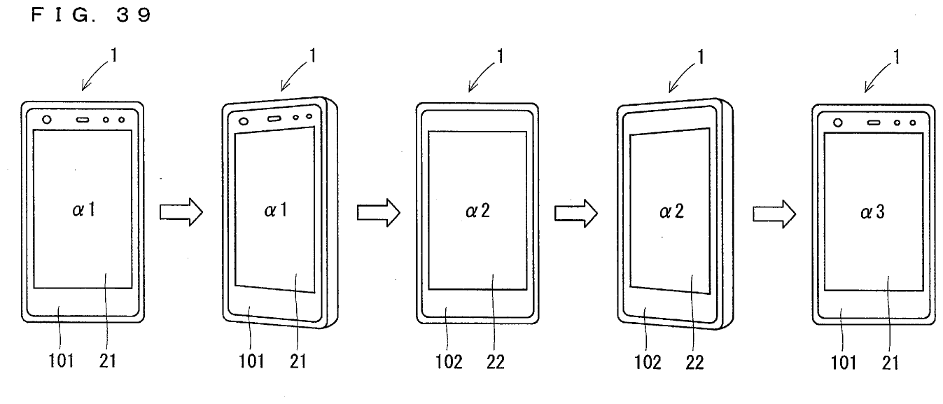

As one example, the area α1 is displayed on the display surface 21 of the leftmost electronic apparatus 1 in one example of FIG. 23 described above. In this case, similarly to one example of FIG. 23, display of the electronic apparatus 1 when the electronic apparatus 1 makes counterclockwise first rotation is as illustrated in FIG. 39. The area α2 is displayed on the display surface 22 of the third electronic apparatus 1 from the left of FIG. 39. The area α3 is displayed on the display surface 21 of the rightmost electronic apparatus 1 of FIG. 39.

In this manner, in one example, the display target part is shifted rightward and leftward within one image 620, according to first rotation. The display target part is shifted leftward, according to clockwise first rotation. The display target part is shifted rightward, according to counterclockwise first rotation.

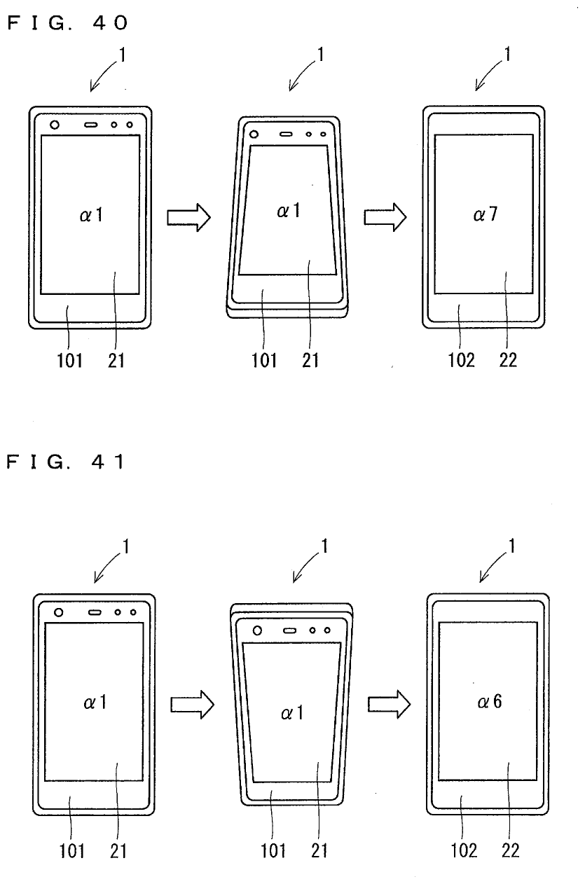

As one example, as illustrated in FIG. 40, the area α1 is displayed on the display surface 21 of the leftmost electronic apparatus 1 in one example of FIG. 24 described above. In this case, similarly to one example of FIG. 24, when the electronic apparatus 1 makes clockwise second rotation, the area α7 is displayed on the display surface 22 as in the rightmost electronic apparatus 1 of FIG. 40.

As one example, as illustrated in FIG. 41, the area α1 is displayed on the display surface 21 of the leftmost electronic apparatus 1 in one example of FIG. 25 described above. In this case, similarly to one example of FIG. 25, when the electronic apparatus 1 makes counterclockwise second rotation, the area α6 is displayed on the display surface 22 as in the rightmost electronic apparatus 1 of FIG. 41.

In this manner, in one example, the display target part is shifted upward and downward within one image 620, according to second rotation. The display target part is shifted upward, according to clockwise second rotation. The display target part is shifted downward, according to counterclockwise second rotation.

Note that, when predetermined operation is performed on the target display surface displaying a webpage, for example, the controller 200 may scroll the display of the target display surface. For example, when rightward slide operation or flick operation is performed on the target display surface, the controller 200 may scroll display of the target display surface leftward. When leftward slide operation or flick operation is performed on the target display surface, the controller 200 may scroll display of the target display surface rightward.

The controller 200 need not execute the display control for a display target part according to first rotation. The controller 200 need not execute the display control for a display target part according to second rotation.

As described above, in one example, according to rotation made while a display target part of one image is displayed on one display surface, the electronic apparatus 1 changes the display target part and displays the changed display target part on the other display surface. Through such display control for a display target part according to rotation, the user can cause the electronic apparatus 1 to change an area that the user desires to check within one image, by rotating the electronic apparatus 1 about the first rotation axis 510 or the second rotation axis 520.

When first rotation or second rotation of the electronic apparatus 1 is made, the electronic apparatus 1 can display a part of an image on a display surface easily seen by a user, and can set a display surface difficult to be seen by a user to a non-display state at the same time, as a result of execution of the non-display determination processing described above.

In one example, the display target part is shifted rightward and leftward within one image 620, according to first rotation. Therefore, the user can cause the electronic apparatus 1 to shift a part to be seen by the user rightward and leftward within one image, by causing first rotation of the electronic apparatus 1, similarly to when the user performs operation on a display surface to scroll display of the screen rightward and leftward.

In one example, the display target part is shifted upward and downward within one image 620, according to second rotation. Therefore, the user can cause the electronic apparatus 1 to shift a part to be seen by the user upward and downward within one image, by causing second rotation of the electronic apparatus 1, similarly to when the user performs operation on a display surface to scroll display of the screen upward and downward.

When the electronic apparatus 1 operates in the SD mode, the controller 200 may scroll display of the display surface 21 in a display state, according to rotation. Specifically, the controller 200 may change a display target part to be displayed on the display surface 21 within one image, according to rotation. Display control for a display target part according to rotation when the electronic apparatus 1 operates in the SD mode is described below.

When the electronic apparatus 1 is rotated 360 degrees clockwise about the first rotation axis 510 from a reference orientation while the controller 200 displays a part of one image on the display surface 21, the controller 200 scrolls display of the display surface 21 leftward. Specifically, when the electronic apparatus 1 is rotated 360 degrees clockwise about the first rotation axis 510 from a reference orientation while a display target part of one image is displayed on the display surface 21, the controller 200 shifts the display target part leftward within the one image and displays the shifted display target part on the display surface 21. Then, the controller 200 stores an orientation of the electronic apparatus 1 after rotation as a new reference orientation.

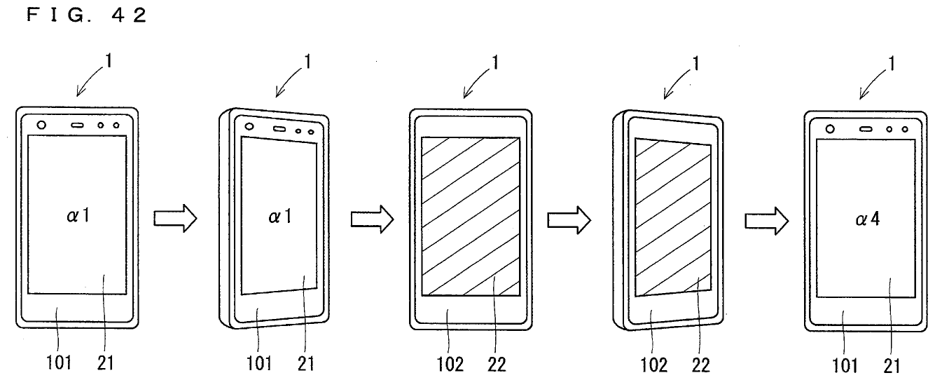

FIG. 42 illustrates a diagram showing one example of how the electronic apparatus 1 is rotated 360 degrees clockwise about the first rotation axis 510. In one example of FIG. 42, the area α1 is displayed on the display surface 21 of the leftmost electronic apparatus 1 before rotation.

When the leftmost electronic apparatus 1 in the SD mode is rotated 360 degrees clockwise about the first rotation axis 510 from a reference orientation, display of the display surface 21 is scrolled leftward, and the area α4 is displayed on the display surface 21 of the electronic apparatus 1, as illustrated in the rightmost electronic apparatus 1 of FIG. 42. Then, the electronic apparatus 1 stores an orientation of the rightmost electronic apparatus 1 of FIG. 42 as a new reference orientation. After that, when the rightmost electronic apparatus 1 of FIG. 42 is rotated 360 degrees clockwise about the first rotation axis 510, display of the display surface 21 is scrolled further leftward, and the area α5 is displayed on the display surface 21.

When the electronic apparatus 1 is rotated 360 degrees counterclockwise about the first rotation axis 510 from a reference orientation while the controller 200 displays a part of one image on the display surface 21, the controller 200 scrolls display of the display surface 21 rightward. Specifically, when the electronic apparatus 1 is rotated 360 degrees counterclockwise about the first rotation axis 510 from a reference orientation while a display target part of one image is displayed on the display surface 21, the controller 200 shifts the display target part rightward within the one image and displays the shifted display target part on the display surface 21. Then, the controller 200 stores an orientation of the electronic apparatus 1 after rotation as a new reference orientation. For example, when the rightmost electronic apparatus 1 of FIG. 42 is rotated 360 degrees counterclockwise about the first rotation axis 510, display of the display surface 21 is scrolled rightward, and the area α1 is displayed on the display surface 21.

When the electronic apparatus 1 is rotated 360 degrees clockwise about the second rotation axis 520 from a reference orientation while the controller 200 displays a part of one image on the display surface 21, the controller 200 scrolls display of the display surface 21 upward. Specifically, when the electronic apparatus 1 is rotated 360 degrees clockwise about the second rotation axis 520 from a reference orientation while a display target part of one image is displayed on the display surface 21, the controller 200 shifts the display target part upward within the one image and displays the shifted display target part on the display surface 21. Then, the controller 200 stores an orientation of the electronic apparatus 1 after rotation as a new reference orientation.

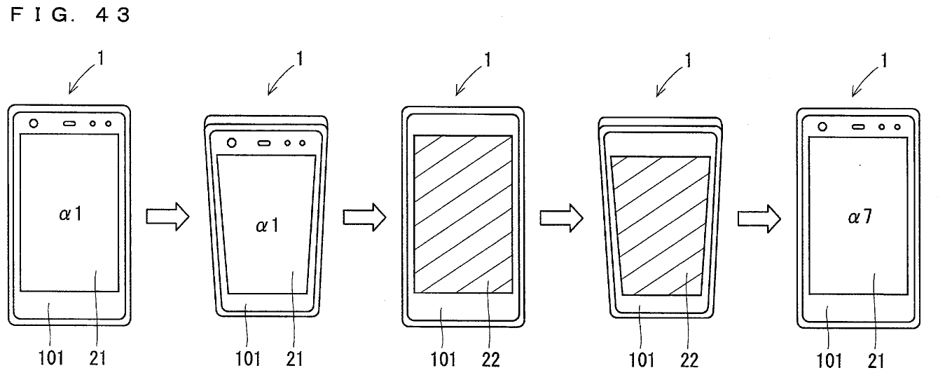

FIG. 43 illustrates a diagram showing one example of how the electronic apparatus 1 is rotated 360 degrees clockwise about the second rotation axis 520. In one example of FIG. 43, the area α1 is displayed on the display surface 21 of the leftmost electronic apparatus 1 before rotation.

When the leftmost electronic apparatus 1 in the SD mode is rotated 360 degrees clockwise about the second rotation axis 520 from a reference orientation, the area α7 on the upper side of the area α1 is displayed on the display surface 21 of the electronic apparatus 1, as illustrated in the rightmost electronic apparatus 1 of FIG. 43. Then, the electronic apparatus 1 stores an orientation of the rightmost electronic apparatus 1 of FIG. 43 as a new reference orientation. After that, when the rightmost electronic apparatus 1 of FIG. 43 is rotated 360 degrees clockwise about the second rotation axis 520, an area further on the upper side of the area α7 is displayed on the display surface 21.

When the electronic apparatus 1 is rotated 360 degrees counterclockwise about the second rotation axis 520 from a reference orientation while the controller 200 displays a part of one image on the display surface 21, the controller 200 scrolls display of the display surface 21 downward. Specifically, when the electronic apparatus 1 is rotated 360 degrees counterclockwise about the second rotation axis 520 from a reference orientation while a display target part of one image is displayed on the display surface 21, the controller 200 shifts the display target part downward within the one image and displays the shifted display target part on the display surface 21. Then, the controller 200 stores an orientation of the electronic apparatus 1 after rotation as a new reference orientation. For example, when the rightmost electronic apparatus 1 of FIG. 43 is rotated 360 degrees counterclockwise about the second rotation axis 520, display of the display surface 21 is scrolled downward, and the area α1 is displayed on the display surface 21.

In this manner, when the electronic apparatus 1 is in the SD mode, the controller 200 scrolls display of the display surface 21, according to first rotation or second rotation. Consequently, the user can cause the electronic apparatus 1 to scroll display of the display surface 21, by rotating the electronic apparatus 1 about the first rotation axis 510 or the second rotation axis 520. As a result, convenience of the electronic apparatus 1 is enhanced.

The controller 200 scrolls display of the display surface 21 rightward and leftward, according to first rotation. The controller 200 scrolls display of the display surface 21 upward and downward, according to second rotation. Consequently, the user can cause the electronic apparatus 1 to scroll display of the display surface 21 upward and downward, and can cause the electronic apparatus 1 to scroll display of the display surface 21 rightward and leftward, by performing simple operation on the electronic apparatus 1.

Note that the controller 200 need not execute the processing of scrolling display of the display surface 21, according to first rotation of the electronic apparatus 1. Note that the controller 200 need not execute the processing of scrolling display of the display surface 21, according to second rotation of the electronic apparatus 1.

Even when the electronic apparatus 1 comprises only the display surface 21 out of the display surfaces 21 and 22, the controller 200 can scroll display of the display surface 21, according to rotation, similarly to when the electronic apparatus 1 is in the SD mode.

The first to third examples of the display control according to rotation described above may be executed in the suspendable electronic apparatus 1 and the ear-worn electronic apparatus 1 described above. Specifically, the page display control according to rotation, the display control for an application screen according to rotation, and the display control for a display target part according to rotation may be executed in the suspendable electronic apparatus 1 and the ear-worn electronic apparatus 1.

As operation modes, the electronic apparatus 1 may include a first operation mode in which the page display control according to rotation is performed, a second operation mode in which the display control for an application screen according to rotation is performed, and a third operation mode in which the display control for a display target part according to rotation is performed. In this case, for example, the electronic apparatus 1 may operate in an operation mode specified by a user, out of the first to third operation modes. For example, a user can specify an operation mode in which the electronic apparatus 1 is to operate, by performing operation on the display surface 21 or the display surface 22.

When the electronic apparatus 1 makes first rotation while the controller 200 displays an application screen on the information display area 20, the controller 200 may perform application display control according to first rotation. When the electronic apparatus 1 makes second rotation while the controller 200 displays an application screen on the information display area 20, the controller 200 may perform display control for a display target part according to second rotation. As one example, the display surface 21 of the electronic apparatus 1 in the MD mode displays a part of the application screen A as a display target part. In this case, when the electronic apparatus 1 is rotated 180 degrees clockwise about the first rotation axis 510, the controller 200 displays the application screen B on the display surface 22. In contrast, when the electronic apparatus 1 is rotated 180 degrees clockwise about the second rotation axis 520, the controller 200 shifts the display target part upward within the application screen A and displays the shifted display target part on the display surface 22.

When the electronic apparatus 1 makes first rotation while the controller 200 displays an application screen on the information display area 20, the controller 200 may perform display control for a display target part according to first rotation. When the electronic apparatus 1 makes second rotation while the controller 200 displays an application screen on the information display area 20, the controller 200 may perform display control for an application screen according to second rotation. As one example, the display surface 22 of the electronic apparatus 1 in the MD mode displays a part of the application screen B as a display target part. In this case, when the electronic apparatus 1 is rotated 180 degrees clockwise about the first rotation axis 510, the controller 200 shifts the display target part leftward within the application screen B and displays the shifted display target part on the display surface 21. In contrast, when the electronic apparatus 1 is rotated 180 degrees clockwise about the second rotation axis 520, the controller 200 displays the application screen C on the display surface 21.

Similarly, when the electronic apparatus 1 makes first rotation while the controller 200 displays a page on the information display area 20, the controller 200 may perform page display control according to first rotation. When the electronic apparatus 1 makes second rotation while the controller 200 displays a page on the information display area 20, the controller 200 may perform display control for a display target part according to second rotation. When the electronic apparatus 1 makes first rotation while the controller 200 displays a page on the information display area 20, the controller 200 may perform display control for a display target part according to first rotation. When the electronic apparatus 1 makes second rotation while the controller 200 displays a page on the information display area 20, the controller 200 may perform page display control according to second rotation.

### OTHER EXAMPLES OF ELECTRONIC APPARATUS

A plurality of other examples of the electronic apparatus 1 are described below.

### Other Example 1

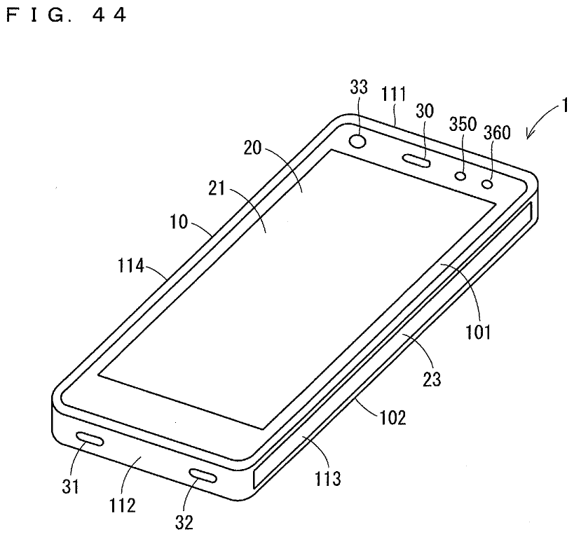

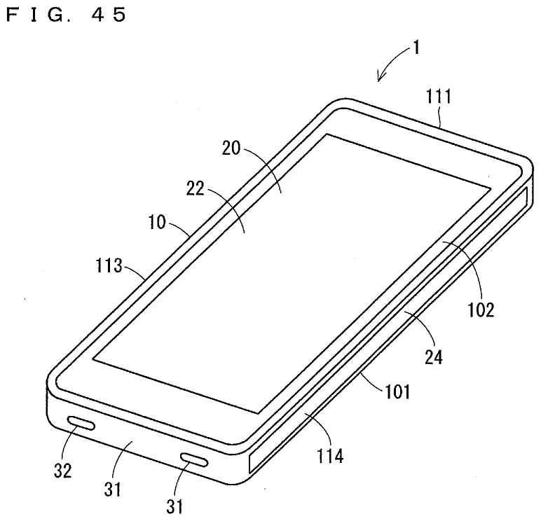

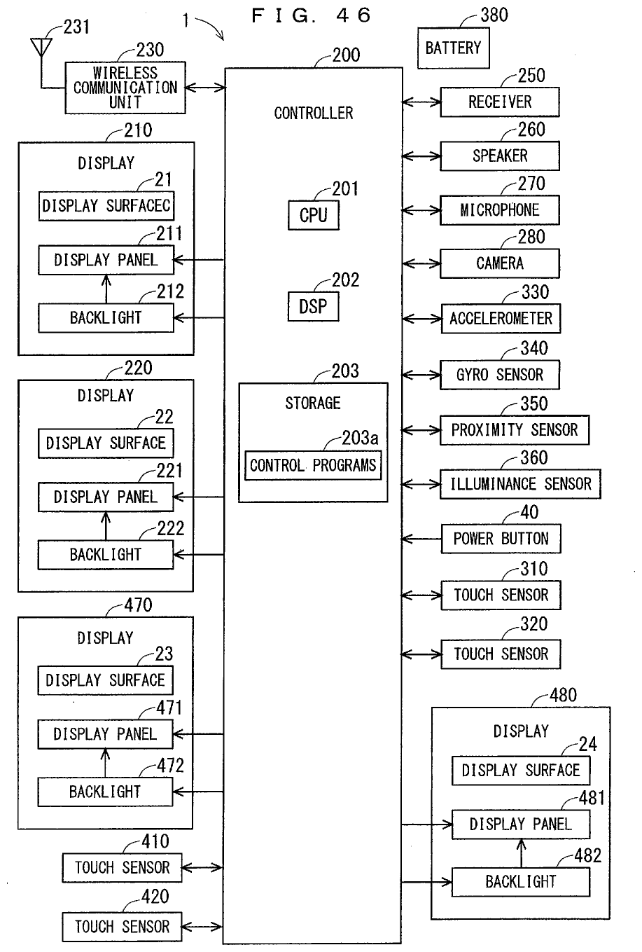

FIGS. 44 and 45 each illustrate a perspective view showing an external appearance of an electronic apparatus 1 according to one example. FIG. 46 illustrates a block diagram mainly showing an electrical configuration of the electronic apparatus 1 according to one example. The electronic apparatus 1 according to one example is described below, mainly focusing on difference from the electronic apparatus 1 illustrated in FIGS. 1, 2, and 6 described above.

As illustrated in FIG. 44, a display surface 23 that can display various pieces of information is located on the third side surface 113 of the electronic apparatus 1 according to one example. As illustrated in FIG. 45, a display surface 24 that can display various pieces of information is located on the fourth side surface 114 of the electronic apparatus 1 according to one example. In one example, for example, the power button 40 is located on the first side surface 111 of the electronic apparatus 1.

As illustrated in FIG. 46, the electronic apparatus 1 according to one example comprises a display 470 comprising the display surface 23, a display 480 comprising the display surface 24, a touch sensor 410, and a touch sensor 420.

The display 470 comprises the display surface 23, a display panel 471, and a backlight 472. The display 480 comprises the display surface 24, a display panel 481, and a backlight 482. A configuration and operation of each of the display panels 471 and 481 are the same as the configuration and operation of the display panel 211 described above. A configuration and operation of each of the backlights 472 and 482 are the same as the configuration and operation of the backlight 212 described above. When the controller 200 controls each pixel of the display panel 471 while the backlight 472 is turned on, the display 470 can display information. Similarly, when the controller 200 controls each pixel of the display panel 481 while the backlight 482 is turned on, the display 480 can display information. For example, the controller 200 can individually turn on and off each of the backlights 472 and 482. The controller 200 can independently control display of each of the display surfaces 21 to 24.

Note that at least one of the display panels 471 and 481 may be a display panel other than a liquid crystal display panel. For example, the display panel 471 may be a light-emitting display panel, such as an organic EL panel. In this case, the backlight 472 is unnecessary. Similarly, the display panel 481 may be a light-emitting display panel, such as an organic EL panel. In this case, the backlight 482 is unnecessary.

In one example, each of the display surfaces 21 to 24 may be hereinafter referred to as a display surface, unless the display surfaces 21 to 24 need to be particularly distinguished from each other. Each of the display surfaces 23 and 24 located on the side surfaces of the case 10 may be referred to as a display surface of a side surface, unless the display surfaces 23 and 24 need to be particularly distinguished from each other. Each of the display surfaces 21 and 22 located on the main surfaces of the case 10 may be referred to as a display surface of a main surface, unless the display surfaces 21 and 22 need to be particularly distinguished from each other.

The touch sensor 410 can detect touch operation performed on the display surface 23 by a pointer, such as a finger. The touch sensor 420 can detect touch operation performed on the display surface 24 by a pointer, such as a finger. A configuration and operation of each of the touch sensors 410 and 420 are the same as the configuration and operation of the touch sensor 310. The controller 200 can identify details of operation performed on the display surface 23, based on an electrical signal from the touch sensor 410. Similarly, the controller 200 can identify details of operation performed on the display surface 24, based on an electrical signal from the touch sensor 420.

In one example, in the MD mode, display is performed on the display surfaces 23 and 24, as well as on the display surfaces 21 and 22. When the controller 200 sets a certain display surface displaying a screen to a non-display state as a result of the non-display determination processing described above while the electronic apparatus 1 according to one example operates in the MD mode, the controller 200 displays information related to the screen on another display surface that is different from the certain display surface, in response to the setting of the certain display surface displaying the screen to a non-display state. For example, in response to setting of the display surface 22 displaying a certain screen to a non-display state, the controller 200 displays information related to the certain screen on the display surfaces 23 and 24. In response to setting of the display surface 21 displaying a certain screen to a non-display state, the controller 200 displays information related to the certain screen on the display surfaces 23 and 24. In one example, the display control according to rotation described above need not be executed in the electronic apparatus 1.

Information related to a screen may be hereinafter referred to as screen-related information. A display surface that has been set to a non-display state may be referred to as a non-display setting display surface. A screen to be erased from a display surface when a display surface displaying a screen is set to a non-display state may be referred to as an erased screen. For example, the screen-related information includes at least one of a graphic symbol and a letter for identifying an erased screen.

For example, when the controller 200 sets one display surface displaying an application screen, out of the display surfaces 21 and 22, to a non-display state as a result of the non-display determination processing, the controller 200 displays screen-related information of the application screen on the display surfaces 23 and 24. In this case, display of the other display surface out of the display surfaces 21 and 22 may be any display. For example, screen-related information of an application screen may include an icon representing an application associated with the application screen. It can be said that the icon is a type of graphic symbol. Screen-related information of an application screen may include a letter indicating details of the application screen.

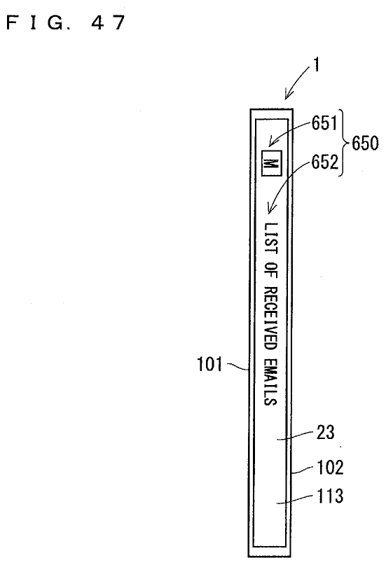

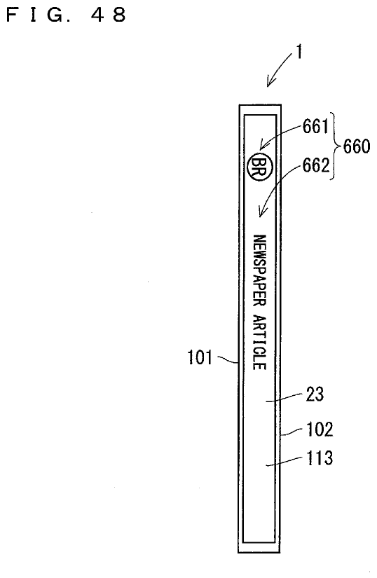

FIGS. 47 and 48 each illustrate a diagram showing one display example of screen-related information of an application screen. FIG. 47 illustrates one example of screen-related information 650, which is displayed on the display surface 23 in response to setting of a display surface of a main surface to a non-display state. In FIG. 47, the display surface of a main surface displays a screen showing a list of received emails of an email application. FIG. 48 illustrates one example of screen-related information 660, which is displayed on the display surface 23 in response to setting of a display surface of a main surface to a non-display state. In FIG. 48, a browser is executed, and the display surface of a main surface displays a webpage of a newspaper article.

The screen-related information 650 illustrated in FIG. 47 includes an icon 651 representing an email application. The screen-related information 650 includes letters 652 indicating that a screen that has been displayed on a non-display setting display surface, i.e., an erased screen, is a screen showing a list of received emails. The screen-related information 650 need not include one of the icon 651 and the letters 652.

The screen-related information 660 illustrated in FIG. 48 includes an icon 661 representing a browser. The screen-related information 660 includes letters 662 indicating that a screen that has been displayed on a non-display setting display surface, i.e., an erased screen, is a webpage of a newspaper article. The screen-related information 660 need not include one of the icon 661 and the letters 662.

Note that the screen-related information 650 may include a part of an erased screen. The screen-related information displayed on the display surface 23 and the screen-related information displayed on the display surface 24 may be the same as each other, or may be different from each other. For example, when the screen-related information 650 illustrated in FIG. 47 is displayed on the display surface 23, both of the icon 651 and the letters 652 may be displayed on the display surface 24, or one of the icon 651 and the letters 652 may be displayed on the display surface 24. The screen-related information may be displayed on only one of the display surfaces 23 and 24. The screen-related information may be displayed on the other display surface of a main surface that is different from a non-display setting display surface.

In this manner, in one example, in response to setting of a display surface displaying a certain screen to a non-display state, the controller 200 displays information related to the certain screen on another display surface. In other words, in response to setting of a display area displaying a certain screen to a non-display state, the controller 200 displays information related to the certain screen on another display area. In this manner, even when a certain display surface is set to a non-display state, the user can identify a screen that has been displayed on the certain display surface, by seeing another display surface. As a result, convenience of the electronic apparatus 1 is enhanced.

When predetermined operation is performed on a display surface of a side surface displaying screen-related information, the controller 200 may display an erased screen on the other display surface of a main surface that is different from a non-display setting display surface. As the predetermined operation, for example, tap operation, double tap operation, or long tap operation is adopted. For example, when predetermined operation is performed on the display surface 23 illustrated in FIG. 47, the controller 200 may display a screen showing a list of receive emails, which is an erased screen, on the other display surface of a main surface (e.g., the display surface 21) that is different from a non-display setting display surface (e.g., the display surface 22). When predetermined operation is performed on the display surface 24 displaying the screen-related information 650 illustrated in FIG. 47, the controller 200 may display a screen showing a list of receive emails on the other display surface of a main surface that is different from a non-display setting display surface. When predetermined operation is performed on the display surface 23 illustrated in FIG. 48, the controller 200 may display a webpage of a newspaper article, which is an erased screen, on the other display surface of a main surface that is different from a non-display setting display surface. When predetermined operation is performed on the display surface 24 displaying the screen-related information 660 illustrated in FIG. 48, the controller 200 may display a webpage of a newspaper article on the other display surface of a main surface that is different from a non-display setting display surface. The controller 200 can identify predetermined operation performed on the display surface 23, based on a detection result obtained by the touch sensor 410. The controller 200 can identify predetermined operation performed on the display surface 24, based on a detection result obtained by the touch sensor 420.

In this manner, when predetermined operation is performed on a display surface of a side surface displaying screen-related information, an erased screen is displayed on the other display surface of a main surface that is different from a non-display setting display surface. In this case, the user can check the erased screen by performing operation on the display surface of a side surface displaying the screen-related information. As a result, convenience of the electronic apparatus 1 is further enhanced.

### Other Example 2

A configuration of the electronic apparatus 1 according to one example is the same as the configuration of the electronic apparatus 1 according to Other Example 1 described above. The controller 200 of the electronic apparatus 1 according to one example sets a certain display surface as a reference display surface. Then, irrespective of whether the operation mode is the SD mode or the MD mode, when predetermined operation is performed on another display surface that is different from a reference display surface while the reference display surface displays a certain screen, the controller 200 can display a screen associated with the another display surface on the reference display surface, in place of the certain screen. This predetermined operation may be referred to as screen switching operation. As the screen switching operation, for example, tap operation, double tap operation, or long tap operation is adopted. In one example, in the MD mode, display of the display surfaces 23 and 24 may be performed, or need not be performed. In one example, the display control according to rotation described above need not be executed in the electronic apparatus 1.

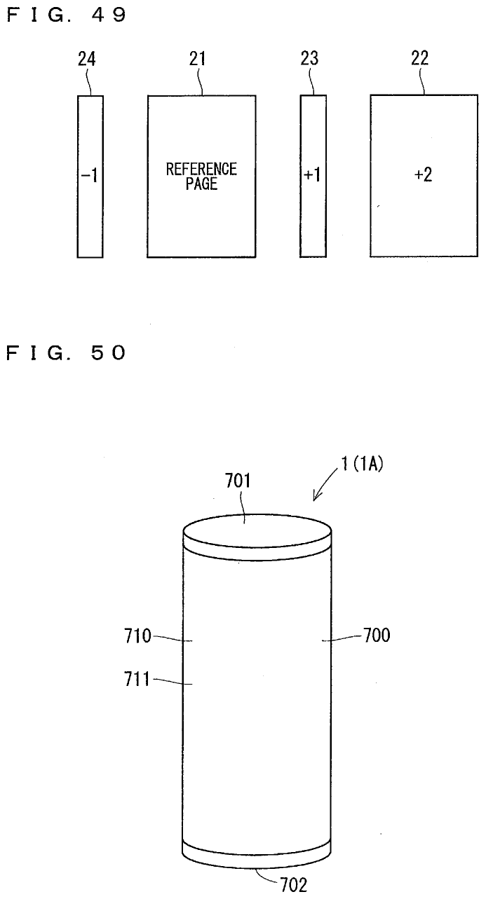

FIG. 49 illustrates a diagram for explaining operation of the electronic apparatus 1 when the electronic apparatus 1 displays contents consisting of a plurality of pages. As illustrated in FIG. 49, in one example, for example, the controller 200 sets the display surface 21 of a main surface as a reference display surface. Then, the controller 200 sets a page displayed on the reference display surface (i.e., the display surface 21) as a reference page. The controller 200 assigns a page immediately following the reference page to the display surface 23 of a side surface on one side. The controller 200 assigns a page immediately preceding the reference page to the display surface 24 of a side surface on the other side. The controller 200 assigns a page that is two pages after the reference page to the display surface 22 of a main surface.

When the controller 200 determines that screen switching operation has been performed on the display surface 23 based on a detection result obtained by the touch sensor 410, the controller 200 displays a page immediately following a reference page displayed on the display surface 21 (i.e., a reference display surface) on the display surface 21, in place of the reference page. For example, when the controller 200 determines that screen switching operation has been performed on the display surface 23 while the page 600a illustrated in FIG. 21 described above is displayed on the display surface 21, the controller 200 displays the page 600b on the display surface 21, in place of the page 600a. Then, when the controller 200 determines that screen switching operation has been performed on the display surface 23 again, the controller 200 displays the page 600c on the display surface 21, in place of the page 600b.

When the controller 200 determines that screen switching operation has been performed on the display surface 24 based on a detection result obtained by the touch sensor 420, the controller 200 displays a page immediately preceding a reference page displayed on the display surface 21 on the display surface 21, in place of the reference page. For example, when the controller 200 determines that screen switching operation has been performed on the display surface 24 while the page 600c is displayed on the display surface 21, the controller 200 displays the page 600b on the display surface 21, in place of the page 600c. Then, when the controller 200 determines that screen switching operation has been performed on the display surface 24 again, the controller 200 displays the page 600a on the display surface 21, in place of the page 600b.

When the controller 200 determines that screen switching operation has been performed on the display surface 22 based on a detection result obtained by the touch sensor 320, the controller 200 displays a page that is two pages after a reference page displayed on the display surface 21 on the display surface 21, in place of the reference page. For example, when the controller 200 determines that screen switching operation has been performed on the display surface 22 while the page 600a is displayed on the display surface 21, the controller 200 displays the page 600c on the display surface 21, in place of the page 600a.

Note that the controller 200 may assign a page that is three or more pages after a reference page to the display surface 22. The controller 200 may assign a page that is a plurality of pages before a reference page to the display surface 22.

Through such operation of the controller 200 as described above, the user can cause the electronic apparatus 1 to change a page to be displayed on the display surface 21 to a page that is after the page, by performing operation on the display surface 23. The user can cause the electronic apparatus 1 to change a page to be displayed on the display surface 21 to a page that is before the page, by performing operation on the display surface 24. The user can cause the electronic apparatus 1 to change a page to be displayed on the display surface 21 to a page that is a plurality of pages before and after the page, by performing operation on the display surface 22.

Note that, when screen switching predetermined operation is performed on another display surface that is different from the display surface 21 while the controller 200 displays a certain application screen on the display surface 21, the controller 200 may display an application screen associated with the another display surface on the display surface 21, in place of the certain application screen. One example of operation of the electronic apparatus 1 in this case is described below.

For example, as in FIG. 28 described above, the controller 200 assigns ordinal numbers to a plurality of types of application screens. Then, the controller 200 sets an application screen displayed on the display surface 21 as a reference application screen. The controller 200 assigns an application screen immediately following the reference application screen to the display surface 23, and assigns an application screen immediately preceding the reference application screen to the display surface 24. Then, the controller 200 assigns an application screen that is two application screens after the reference application screen to the display surface 22.

When the controller 200 determines that screen switching operation has been performed on the display surface 23, the controller 200 displays an application screen immediately following a reference application screen displayed on the display surface 21 on the display surface 21, in place of the reference application screen. For example, when the controller 200 determines that screen switching operation has been performed on the display surface 23 while the application screen 610b illustrated in FIG. 28 described above is displayed on the display surface 21, the controller 200 displays the application screen 610c on the display surface 21, in place of the application screen 610b.

When the controller 200 determines that screen switching operation has been performed on the display surface 24, the controller 200 displays an application screen immediately preceding a reference application screen displayed on the display surface 21 on the display surface 21, in place of the reference application screen. For example, when the controller 200 determines that screen switching operation has been performed on the display surface 24 while the application screen 610b is displayed on the display surface 21, the controller 200 displays the application screen 610a on the display surface 21, in place of the application screen 610b.

When the controller 200 determines that screen switching operation has been performed on the display surface 22, the controller 200 displays an application screen that is two application screens after a reference application screen displayed on the display surface 21 on the display surface 21, in place of the reference application screen. For example, when the controller 200 determines that screen switching operation has been performed on the display surface 22 while the application screen 610a is displayed on the display surface 21, the controller 200 displays the application screen 610c on the display surface 21, in place of the application screen 610a.

Note that the controller 200 may display screen-related information of a screen assigned to the display surface 23 on the display surface 23. The controller 200 may display screen-related information of a screen assigned to the display surface 24 on the display surface 24. When a page is assigned to a display surface, screen-related information of the page may include information indicating details of the page. As the information, for example, a summary of a page is adopted. When an application screen is assigned to a display surface, screen-related information of the application screen may include an icon representing an application associated with the application screen. Screen-related information of an application screen may include a letter indicating details of the application screen.

In one example described above, the display surface 21 is set as a reference display surface. However, another display surface may be set as a reference display surface. For example, the display surface 22 may be set as a reference display surface. When the non-display determination processing described above is performed, a display surface in a display state, out of the display surfaces 21 and 22, may be set as a reference display surface. A method of assigning a screen to a display surface other than a reference display surface is not limited to one example described above.

As described above, in one example, when predetermined operation is performed on another display surface that is different from a reference display surface while the controller 200 displays a certain screen on a reference display surface, the controller 200 displays a screen associated with the another display surface on the reference display surface, in place of the certain screen. Consequently, the user can cause the electronic apparatus 1 to change a screen to be displayed on a reference display surface, by performing operation on another display surface that is different from the reference display surface. As a result, convenience of the electronic apparatus 1 is enhanced.

When screen-related information of a screen assigned to a display surface is displayed on the display surface, the user can easily identify a screen assigned to the display surface, by seeing the screen-related information displayed on the display surface. Specifically, when a user performs operation on a display surface other than a reference display surface, the user can easily identify a screen to be displayed on the reference display surface. As a result, convenience of the electronic apparatus 1 is enhanced.

### Other Example 3

FIG. 50 illustrates a perspective view indicating an external appearance of an electronic apparatus 1 according to one example. The electronic apparatus 1 according to one example is described below, mainly focusing on difference from the electronic apparatus 1 illustrated in FIGS. 1, 2, and 6 described above. The electronic apparatus 1 according to one example may be hereinafter referred to as an electronic apparatus 1A.

As illustrated in FIG. 50, an outer shape of the electronic apparatus 1A is a cylindrical shape. The electronic apparatus 1A comprises a display 710, instead of the displays 210 and 220 described above. For example, the display 710 is a light-emitting display apparatus, such as an EL display. The display 710 comprises an information display area 711 in which various pieces of information can be displayed. The information display area 711 is located on a peripheral surface 700 of the electronic apparatus 1. The information display area 711 has a cylindrical curved surface. The information display area 711 exists in a manner of surrounding a whole periphery of the electronic apparatus 1A. It can also be said that the information display area 711 is a cylindrical display surface. A shape of each of a pair of end surfaces consisting of end surfaces 701 and 702 of the cylindrical electronic apparatus 1A may be a perfect circle or an ellipse.

The electronic apparatus 1A comprises a touch sensor, instead of the touch sensors 310 and 320 described above, that can detect touch operation performed on the information display area 711 by a pointer, such as a finger. A configuration and operation of the touch sensor of the electronic apparatus 1A is the same as the configuration and operation of the touch sensor 310. The controller 200 can identify details of operation performed on the information display area 711, based on an electrical signal from the touch sensor. A user can perform operation on the information display area 711 while the user holds the electronic apparatus 1A with one hand, for example.

For example, the power button 40 of the electronic apparatus 1A is located on the end surface 701. The proximity sensor 350 and the illuminance sensor 360 are located on the peripheral surface 700 of the electronic apparatus 1A.

The term “circumferential direction” by itself hereinafter refers to a circumferential direction of the electronic apparatus 1, i.e., a circumferential direction of the cylindrical curved surface of the information display area 711.

The controller 200 of the electronic apparatus 1A divides the information display area 711 into a plurality of display areas 730 along the circumferential direction. The controller 200 can independently control display of each of the plurality of display areas 730.

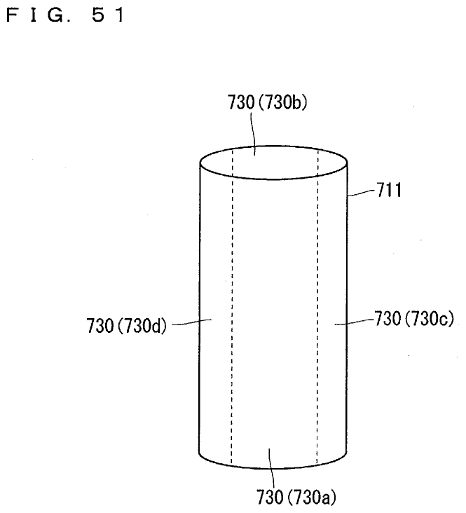

FIG. 51 illustrates a diagram showing one division example of the information display area 711. As illustrated in FIG. 51, the controller 200 evenly divides the information display area 711 along the circumferential direction into four display areas 730a to 730d, for example. The display areas 730a and 730c face each other, and the display areas 730c and 730d face each other. When the electronic apparatus 1A is seen from the end surface 702 side, the display area 730a, the display area 730c, the display area 730b, and the display area 730d are arranged clockwise along the circumferential direction in this order.

The controller 200 can display the same screen on each of the plurality of display areas 730, and can display different screens on the plurality of display areas 730. The controller 200 can regard the plurality of display areas 730 as one large display area and display one screen on this large display area. The controller 200 can set each of the plurality of display areas 730, i.e., the display area 730, to a display state or a non-display state.

<Method of Determining Non-Display State>

In one example, the controller 200 determines whether or not each of the plurality of display areas 730 is to be set to a non-display state, based on a condition of an object in terms of contact or proximity with respect to the information display area 711. Specifically, the controller 200 performs second non-display determination processing of determining whether or not the display area 730 is to be set to a non-display state, based on a condition of an object in terms of contact or proximity with respect to the display area 730. In one example, the display area 730 is in a display state unless it is determined that the display area 730 is to be set to a non-display state. A display area 730 to be described may be hereinafter referred to as a target display area 730.

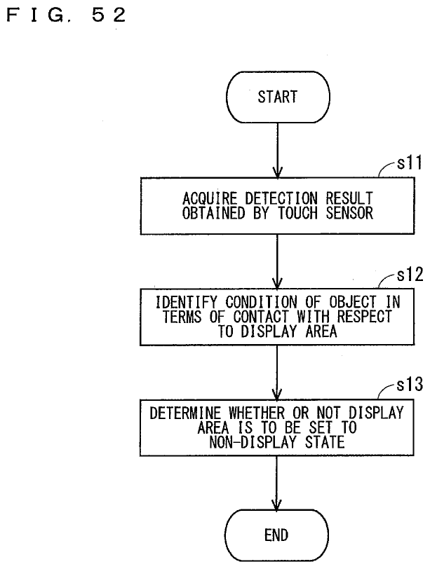

FIG. 52 illustrates a flowchart showing one example of the second non-display determination processing. The controller 200 repeatedly executes the second non-display determination processing illustrated in FIG. 52 for each of the plurality of display areas 730.

As illustrated in FIG. 52, in Step s11, the controller 200 acquires a detection result obtained by a touch sensor. Next, in Step s12, the controller 200 identifies a condition of an object in terms of contact with respect to the target display area 730, based on the acquired detection result. For example, the controller 200 calculates the area of a region in which the object is in contact with the target display area 730, based on the acquired detection result. The area may be hereinafter referred to as a second object contact area.

Next, in Step s13, the controller 200 determines whether or not the target display area 730 is to be set to a non-display state, based on the second object contact area acquired in Step s12. In Step s13, if the second object contact area is equal to or greater than a threshold value, the controller 200 determines that the target display area 730 is to be set to a non-display state. In this manner, the target display area 730 is set to a non-display state. On the other hand, if the second object contact area is less than the threshold value, the controller 200 determines that the target display area 730 is not to be set to a non-display state. In this manner, the target display area 730 remains in a display state.

Through execution of the second non-display determination processing as described above for each of the plurality of display areas 730, the electronic apparatus 1 can set a display area 730 likely to be seen by a person to a display state, and set a display area 730 less likely to be seen by a person to a non-display state, out of the plurality of display areas 730. As a result, convenience of the electronic apparatus 1 can be maintained, and at the same time, power consumption of the electronic apparatus 1 can be reduced.

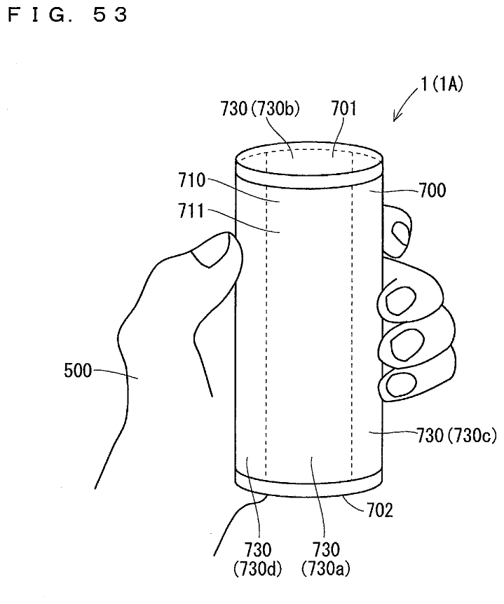

As one example, as illustrated in FIG. 53, a user holds the electronic apparatus 1A with one hand 500. In one example of FIG. 53, it is likely that the hand 500 comes into contact with a wide range of each of the display areas 730b, 730c, and 730d that are less likely to be seen by a user. In contrast, it is likely that the hand 500 comes into contact with a smaller range of the display area 730a that is likely to be seen by a user. Therefore, in one example of FIG. 53, the display areas 730b, 730c, and 730d that are less likely to be seen by a user area set to a non-display state, and the display area 730a that is likely to be seen by a user is set to a display state.

Note that, when the electronic apparatus 1A comprises the proximity sensor 350 that detects an object approaching or coming into contact with the display area 730 for each of the plurality of display areas 730, the controller 200 may use a detection result obtained by the proximity sensor 350 in the second non-display determination processing for the display area 730. The second non-display determination processing using a detection result obtained by the proximity sensor 350 may be referred to as second non-display determination processing using a proximity sensor. The second non-display determination processing using a detection result obtained by a touch sensor illustrated in FIG. 52 may be referred to as second non-display determination processing using a touch sensor.

Here, when the proximity sensor 350 that detects an object approaching or coming into contact with the target display area 730 is referred to as a target proximity sensor 350, details of the second non-display determination processing using a proximity sensor is the same as the details of the non-display determination processing using a proximity sensor described above, except that the target display surface is changed to the target display area 730 and the target proximity sensor is changed to the target proximity sensor 350.

When the electronic apparatus 1A comprises the illuminance sensor 360 that detects illuminance around the display area 730 for each of the plurality of display areas 730, the controller 200 may use a detection result obtained by the illuminance sensor 360 in the second non-display determination processing. The second non-display determination processing using a detection result obtained by the illuminance sensor 360 may be referred to as second non-display determination processing using an illuminance sensor.

Here, when the illuminance sensor 360 that detects illuminance around the target display area 730 is referred to as a target illuminance sensor 360, details of the second non-display determination processing using an illuminance sensor is the same as the details of the non-display determination processing using an illuminance sensor described above, except that the target display surface is changed to the target display area 730 and the target illuminance sensor is changed to the target illuminance sensor 360.

In this manner, a detection result obtained by the proximity sensor or the illuminance sensor is used in the second non-display determination processing. Consequently, even when an object difficult to be detected by a touch sensor approaches or comes into contact with the display area 730, the electronic apparatus 1A can set the display area 730 to a non-display state. For example, when the electronic apparatus 1A is placed on a table with the display area 730b facing down, the electronic apparatus 1 can set the display area 730b less likely to be seen by a person to a non-display state. The controller 200 may execute at least two types of second non-display determination processing out of the second non-display determination processing using a touch sensor, the second non-display determination processing using a proximity sensor, and the second non-display determination processing using an illuminance sensor, as provisional determination processing of determining whether or not the target display area 730 is to be set to a non-display state. Then, based on a result of the provisional determination processing, the controller 200 may ultimately determine whether or not the target display area 730 is to be set to a non-display state. In this case, if the controller 200 determines that the target display area 730 is to be set to a non-display state in at least one type of second non-display determination processing out of a plurality of types of second non-display determination processing executed as the provisional determination processing, the controller 200 ultimately determines that the target display area 730 is to be set to a non-display state. In contrast, if the controller 200 determines that the target display area 730 is not to be set to a non-display state in all of a plurality of types of second non-display determination processing executed as the provisional determination processing, the controller 200 ultimately determines that the target display area 730 is not to be set to a non-display state.

When the controller 200 determines that an object is in contact with or approaching only one display area 730 out of the plurality of display areas 730, the controller 200 may set each of the display areas 730, which are display areas other than a display area 730 facing the one display area 730, to a non-display state, irrespective of a result of the second non-display determination processing. This processing may be hereinafter referred to as third non-display determination processing. The controller 200 can determine that an object is in contact with or approaching the target display area 730, based on a detection result obtained by the target proximity sensor 350 or a detection result obtained by the target illuminance sensor 360 as described above.

As one example, in the third non-display determination processing, the controller 200 determines that an object is in contact with or approaching only the display area 730b out of the plurality of display areas 730a to 730d, for example. In this case, the controller 200 sets each of the display areas 730b, 730c, and 730d, which are display areas other than the display area 730a facing the display area 730b, to a non-display state. As another example, the controller 200 determines that an object is in contact with or approaching only the display area 730c out of the plurality of display areas 730a to 730d, for example. In this case, the controller 200 sets each of the display areas 730a, 730b, and 730c, which are display areas other than the display area 730d facing the display area 730c, to a non-display state.

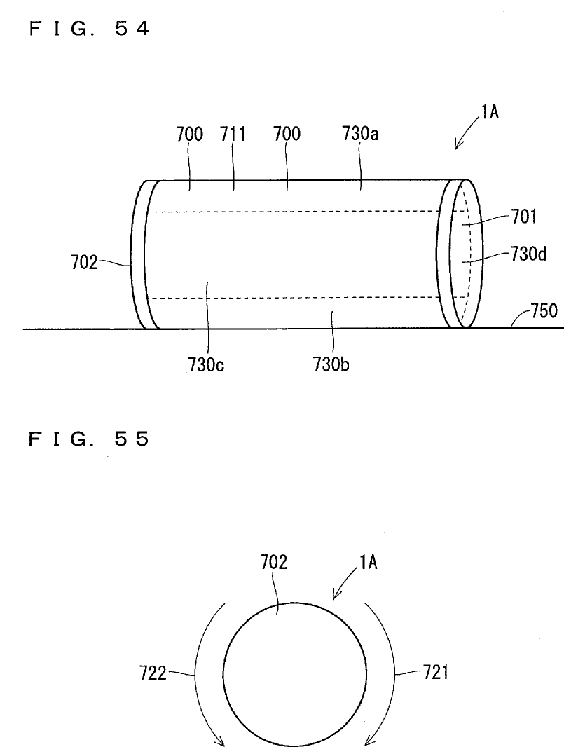

Through execution of the third non-display determination processing as described above, when the electronic apparatus 1A is placed on a table, each of the display areas 730, which are display areas other than a display area 730 facing another display area 730 in contact with the table, is set to a non-display state. As one example, as illustrated in FIG. 54, the electronic apparatus 1A is placed on a table 750 with the display area 730b facing down. In this case, since the display area 730b is in contact with the table 750, the display areas 730b, 730c, and 730d are set to a non-display state, and the display area 730a located on the upper side is set to a display state. Thus, when the electronic apparatus 1A is placed on a table with the display area 730b facing down, only the display area 730a located on the upper side, i.e., only the display area 730a likely to be seen by a user, is set to a display state, out of the plurality of display areas 730a to 730d. Consequently, the user can check display of the electronic apparatus 1A, without lifting the electronic apparatus 1A from the tabletop or changing orientation of the electronic apparatus 1A. Through execution of the third non-display determination processing, even when the electronic apparatus 1A is placed on a table with any of the display areas 730 facing down, a display area 730 on the upper side that is likely to be seen by a user can be set to a display state, and another display area 730 that is less likely to be seen by a user can be set to a non-display state at the same time. For example, when the electronic apparatus 1A placed on a table gives a notification to a user, notification information is displayed in a display area 730 on the upper side that is likely to be seen by the user. Examples of the notification information include information for giving a notification of an incoming phone call or a received electronic mail.

Through execution of the second non-display determination processing or the third non-display determination processing as described above, the electronic apparatus 1A can shift the position of an area in a display state within the information display area 711 along the circumferential direction of the electronic apparatus 1, according to circumferential rotation of the electronic apparatus 1. The term “circumferential rotation” by itself hereinafter refers to circumferential rotation of the electronic apparatus 1A. The term “clockwise circumferential rotation” refers to clockwise rotation 721 in the circumferential direction when the electronic apparatus 1 is seen from the end surface 702 side as in FIG. 55. The term “counterclockwise circumferential rotation” refers to counterclockwise rotation 722 in the circumferential direction when the electronic apparatus 1 is seen from the end surface 702 side as in FIG. 55.

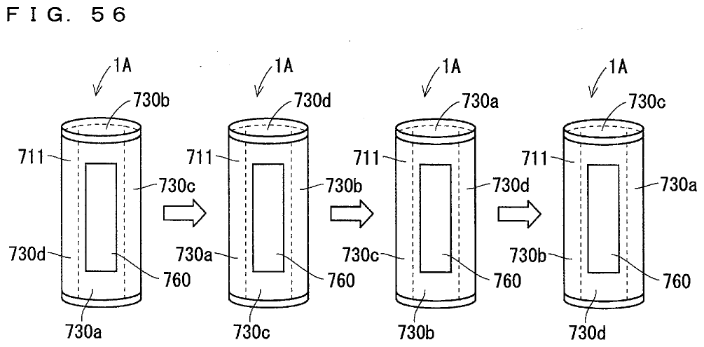

As one example, as in FIG. 53 described above, a user holding the electronic apparatus 1A with one hand 500 rotates the electronic apparatus 1A counterclockwise in the circumferential direction. FIG. 56 illustrates a diagram showing one example of how the electronic apparatus 1A is rotated counterclockwise in the circumferential direction. In one example of FIG. 56, a display area 730 in a display state displays a screen 760.

When the leftmost electronic apparatus 1A of FIG. 56 is held by a hand 500 of a user as in FIG. 53, the display area 730a is set to a display state, and the display areas 730b to 730d are set to a non-display state, as a result of execution of the second non-display determination processing described above. When this electronic apparatus 1A is rotated 90 degrees counterclockwise in the circumferential direction, the second electronic apparatus 1A from the left of FIG. 56 is obtained. When this electronic apparatus 1A is held by the hand 500 of the user, the display area 730c is set to a display state, and the display areas 730a, 730b, and 730d are set to a non-display state. In one example of FIG. 56, an area in a display state is changed from the display area 730a to the display area 730c within the information display area 711. Therefore, it can be said that, within the information display area 711, the position of an area in a display state is shifted along the circumferential direction, according to circumferential rotation of the electronic apparatus 1A.

When the second electronic apparatus 1A from the left of FIG. 56 is rotated 90 degrees counterclockwise in the circumferential direction, the third electronic apparatus 1A from the left of FIG. 56 is obtained. When this electronic apparatus 1A is held by a hand 500 of a user, the display area 730b is set to a display state, and the display areas 730a, 730c, and 730d are set to a non-display state. When this electronic apparatus 1A is rotated 90 degrees counterclockwise in the circumferential direction, the rightmost electronic apparatus 1A of FIG. 56 is obtained. When this electronic apparatus 1A is held by the hand 500 of the user as in FIG. 53, the display area 730d is set to a display state, and the display areas 730a to 730c are set to a non-display state.

In this manner, in one example of FIG. 56, an area in a display state within the information display area 711 is sequentially changed in the order of the display area 730a, the display area 730c, the display area 730b, and the display area 730d, according to counterclockwise circumferential rotation. Specifically, in a view seen from the end surface 702 side, the position of an area in a display state is shifted clockwise within the information display area 711, according to counterclockwise circumferential rotation. In this manner, even when the electronic apparatus 1A makes counterclockwise circumferential rotation, only a display area 730 that is likely to be seen by a user is set to a display state, out of the plurality of display areas 730. When the electronic apparatus 1A held by a hand 500 of a user as in FIG. 53 makes clockwise circumferential rotation, in a view seen from the end surface 702 side, the position of an area in a display state is shifted counterclockwise within the information display area 711.

When the electronic apparatus 1A is rotated in the circumferential direction on a table, the position of an area in a display state is shifted along the circumferential direction within the information display area 711, as a result of execution of the third non-display determination processing described above. Specifically, when the electronic apparatus 1A makes counterclockwise circumferential rotation on a table, similarly to FIG. 56, in a view seen from the end surface 702 side, the position of an area in a display state is shifted clockwise within the information display area 711. When the electronic apparatus 1A makes clockwise circumferential rotation on a table, in a view seen from the end surface 702 side, the position of an area in a display state is shifted counterclockwise within the information display area 711.

As described above, the position of an area in a display state within the information display area 711 is shifted along the circumferential direction of the electronic apparatus 1, according to circumferential rotation of the electronic apparatus 1A. Therefore, in the electronic apparatus 1A, information can be displayed at a place within the information display area 711 easily seen by a user. As a result, convenience of the electronic apparatus 1 is enhanced. The following description is based on the premise that, according to circumferential rotation, the position of an area in a display state within the information display area 711 is shifted along the circumferential direction, unless otherwise specifically noted. The term “display-state area” refers to an area in a display state within the information display area 711.

Note that, when the controller 200 does not use a detection result obtained by the touch sensor in determining whether or not the target display area 730 is set to a non-display state, the controller 200 may stop the function of detecting operation performed on the target display area 730 after the controller 200 determines that the target display area 730 is to be set to a non-display state. This can reduce a probability that the electronic apparatus 1 detects operation performed on a display area 730 less likely to be seen by a person.

When the proximity sensor detects an object in contact with or approaching the target display area 730, the controller 200 may stop the function of detecting operation performed on the target display area 730, instead of setting the target display area 730 to a non-display state. When brightness around the target display area 730 detected by the illuminance sensor is equal to or less than a threshold value, the controller 200 may stop the function of detecting operation performed on the target display area 730, instead of setting the target display area 730 to a non-display state.

<Display Control for Area in Display State According to Circumferential Rotation>

The electronic apparatus 1A can change display of the display-state area, according to circumferential rotation of the electronic apparatus 1A. This display control may be referred to as display control according to circumferential rotation.

The controller 200 of the electronic apparatus 1A can change display of the display-state area, according to clockwise circumferential rotation. The controller 200 can change display of the display-state area, according to counterclockwise circumferential rotation. A plurality of examples of display control according to circumferential rotation are described below.

### First Example of Display Control According to Circumferential Rotation

In one example, when the controller 200 displays contents consisting of a plurality of pages 600 in the information display area 711, the controller 200 changes a page 600 to be displayed in the display-state area, according to circumferential rotation. This display control may be referred to as page display control according to circumferential rotation.

For example, when the electronic apparatus 1A is rotated 90 degrees counterclockwise in the circumferential direction from a reference orientation while a certain page 600 is displayed in the display-state area, the controller 200 displays a next page 600, which is a page following the certain page 600, in the display-state area. When the electronic apparatus 1A is rotated 90 degrees counterclockwise in the circumferential direction from a reference orientation while the last page 600c is displayed in the display-state area, the controller 200 may display the top page 600a or the last page 600c in the display-state area. A method of determining a reference orientation is the same as that described above.

In contrast, when the electronic apparatus 1A is rotated 90 degrees clockwise in the circumferential direction from a reference orientation while a certain page 600 is displayed in the display-state area, the controller 200 displays a previous page 600, which is page preceding the certain page 600, in the display-state area. When the electronic apparatus 1A is rotated 90 degrees clockwise in the circumferential direction from a reference orientation while the first page 600a is displayed in the display-state area, the controller 200 may display the last page 600c or the first page 600a in the display-state area.

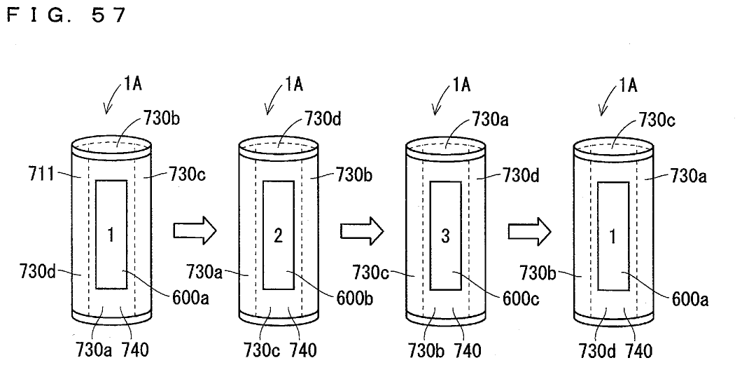

FIG. 57 illustrates a diagram showing one example of how the electronic apparatus 1A makes counterclockwise circumferential rotation. In one example of FIG. 57, the electronic apparatus 1A makes counterclockwise circumferential rotation while the electronic apparatus 1A is held by a hand 500 of a user as in FIG. 53 described above. In the leftmost electronic apparatus 1 before rotation, the display area 730a is a display-state area 740, and the page 600a (i.e., page 1) is displayed in the display area 730a.

When the leftmost electronic apparatus 1A is rotated 90 degrees counterclockwise in the circumferential direction from a reference orientation, the second electronic apparatus 1A from the left of FIG. 57 is obtained. In this electronic apparatus 1A, the display-state area 740 is the display area 730c, and the page 600b (i.e., page 2), which is a page immediately following the page 600a, is displayed in the display-state area 740. Then, the controller 200 stores an orientation of the second electronic apparatus 1A from the left of FIG. 57 as a new reference orientation. After that, when the second electronic apparatus 1A from the left of FIG. 57 is rotated 90 degrees counterclockwise in the circumferential direction from a reference orientation, the third electronic apparatus 1A from the left of FIG. 57 is obtained. In this electronic apparatus 1A, the display-state area 740 is the display area 730b, and the page 600c (i.e., page 3), which is a page immediately following the page 600b, is displayed in the display-state area 740. Then, the controller 200 stores an orientation of the third electronic apparatus 1A from the left of FIG. 57 as a new reference orientation. After that, when the third electronic apparatus 1A from the left of FIG. 57 is rotated 90 degrees counterclockwise in the circumferential direction from a reference orientation, the rightmost electronic apparatus 1A of FIG. 57 is obtained. In this electronic apparatus 1A, the display-state area 740 is the display area 730d, and the first page 600a is displayed in the display-state area 740, for example. Then, the controller 200 stores an orientation of the rightmost electronic apparatus 1A of FIG. 57 as a new reference orientation.

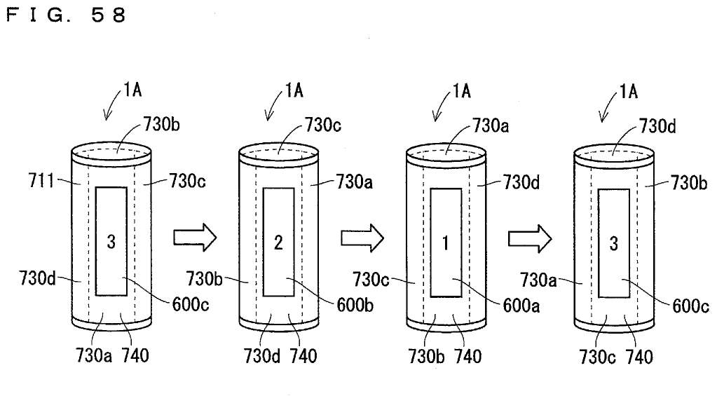

FIG. 58 illustrates a diagram showing one example of how the electronic apparatus 1A makes clockwise circumferential rotation. In one example of FIG. 58, the electronic apparatus 1A makes clockwise circumferential rotation while the electronic apparatus 1A is held by a hand 500 of a user as in FIG. 53 described above. In the leftmost electronic apparatus 1 before rotation, the display area 730a is the display-state area 740, and the page 600c (i.e., page 3) is displayed in the display area 730a.

When the leftmost electronic apparatus 1A is rotated 90 degrees clockwise in the circumferential direction from a reference orientation, the second electronic apparatus 1A from the left of FIG. 58 is obtained. In this electronic apparatus 1A, the display-state area 740 is the display area 730d, and the page 600b (i.e., page 2), which is a page immediately preceding the page 600c, is displayed in the display-state area 740. Then, the controller 200 stores an orientation of the second electronic apparatus 1A from the left of FIG. 58 as a new reference orientation. After that, when the second electronic apparatus 1A from the left of FIG. 58 is rotated 90 degrees clockwise in the circumferential direction from a reference orientation, the third electronic apparatus 1A from the left of FIG. 58 is obtained. In this electronic apparatus 1A, the display-state area 740 is the display area 730b, and the page 600a (i.e., page 1), which is a page immediately preceding the page 600b, is displayed in the display-state area 740. Then, the controller 200 stores an orientation of the third electronic apparatus 1A from the left of FIG. 58 as a new reference orientation. After that, when the third electronic apparatus 1A from the left of FIG. 58 is rotated 90 degrees clockwise in the circumferential direction from a reference orientation, the rightmost electronic apparatus 1A of FIG. 58 is obtained. In this electronic apparatus 1A, the display-state area 740 is the display area 730c, and the last page 600c is displayed in the display-state area 740, for example. Then, the controller 200 stores an orientation of the rightmost electronic apparatus 1A of FIG. 58 as a new reference orientation.

Note that, when the electronic apparatus 1A is rotated 90 degrees counterclockwise in the circumferential direction while a certain page is displayed in the display-state area, a page that is a plurality of pages after the certain page may be displayed in the display-state area. Similarly, when the electronic apparatus 1A is rotated 90 degrees clockwise in the circumferential direction while a certain page is displayed in the display-state area, a page that is a plurality of pages before the certain page may be displayed in the display-state area.

When the electronic apparatus 1A is rotated 90 degrees counterclockwise in the circumferential direction from a reference orientation while a certain page is displayed in the display-state area, display of the display-state area need not be changed. When the electronic apparatus 1A is rotated 180 degrees counterclockwise in the circumferential direction from a reference orientation while a certain page is displayed in the display-state area, by contrast, a page that is at least one page after the certain page may be displayed in the display-state area. Similarly, when the electronic apparatus 1A is rotated 90 degrees counterclockwise in the circumferential direction from a reference orientation while a certain page is displayed in the display-state area, display of the display-state area need not be changed. When the electronic apparatus 1A is rotated 180 degrees clockwise in the circumferential direction from a reference orientation while a certain page is displayed in the display-state area, by contrast, a page that is at least one page before the certain page may be displayed in the display-state area.

When predetermined operation is performed on the target display area 730 while the controller 200 displays a certain page in the target display area 730, the controller 200 may display a page different from the certain page in the target display area 730.

As described above, the electronic apparatus 1A according to one example changes display of the display-state area, according to circumferential rotation. Consequently, the user can cause the electronic apparatus 1A to change display of the display-state area by rotating the electronic apparatus 1 A in the circumferential direction. As a result, convenience of the electronic apparatus 1 is enhanced.

In one example, a page to be displayed in the display-state area of the electronic apparatus 1A is changed, according to circumferential rotation. Consequently, the user can cause the electronic apparatus 1A to change a page to be displayed in the display-state area, by rotating the electronic apparatus 1A in the circumferential direction.

### Second Example of Display Control According to Circumferential Rotation

In one example, the controller 200 can change a type of application screen to be displayed in the display-state area, according to circumferential rotation. This display control may be hereinafter referred to as display control for an application screen according to circumferential rotation.

When the controller 200 executes a plurality of applications similarly to when the controller 200 performs the display control for an application screen according to rotation described above, the controller 200 assigns ordinal numbers to a plurality of types of application screens associated with the plurality of respective applications. The ordinal numbers are assigned for the display control for an application screen according to circumferential rotation.

When the electronic apparatus 1A is rotated 90 degrees counterclockwise in the circumferential direction from a reference orientation while a certain application screen 610 illustrated in FIG. 28 described above is displayed in the display-state area, the controller 200 displays a next application screen 610, which is an application screen following the certain application screen 610, in the display-state area. When the electronic apparatus 1A is rotated 90 degrees clockwise in the circumferential direction from a reference orientation while the last application screen 610c is displayed in the display-state area, the controller 200 may display the first application screen 610a or the last application screen 610c in the display-state area.

In contrast, when the electronic apparatus 1A is rotated 90 degrees clockwise in the circumferential direction from a reference orientation while a certain application screen 610 is displayed in the display-state area, the controller 200 displays a previous application screen 610, which is an application screen preceding the certain application screen 610, in the display-state area. When the electronic apparatus 1A is rotated 90 degrees clockwise in the circumferential direction from a reference orientation while the first application screen 610a is displayed in the display-state area, the controller 200 may display the last application screen 610c or the first application screen 610a in the display-state area.

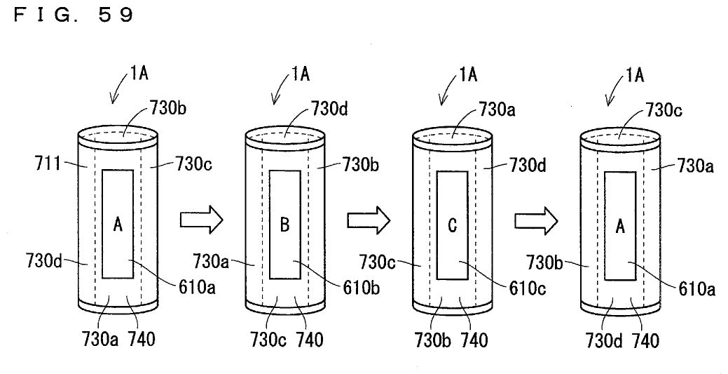

Here, as one example, the application screen 610a (i.e., the application screen A) is displayed in the display-state area 740 (i.e., the display area 730a) of the leftmost electronic apparatus 1A in one example of FIG. 57 described above. In this case, similarly to one example of FIG. 57, display of the display-state area 740 of the electronic apparatus 1A when the electronic apparatus 1A makes counterclockwise circumferential rotation is as illustrated in FIG. 59. The application screen 610b (i.e., the application screen B) is displayed in the display-state area 740 of the second electronic apparatus 1A from the left of FIG. 59. The application screen 610c (i.e., the application screen C) is displayed in the display-state area 740 of the third electronic apparatus 1A from the left of FIG. 59. For example, the application screen 610a is displayed in the display-state area 740 of the rightmost electronic apparatus 1A of FIG. 59.

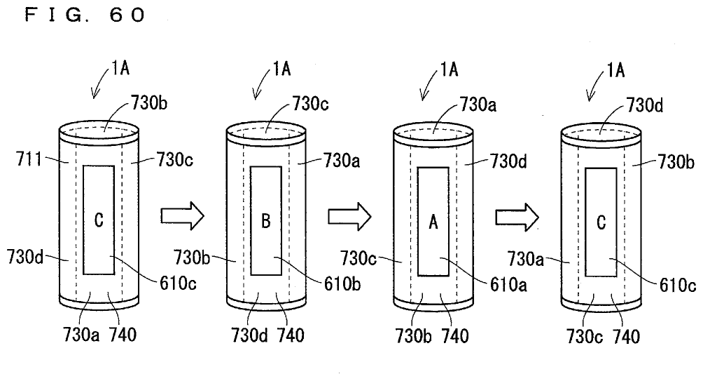

As one example, the application screen 610c (i.e., the application screen C) is displayed in the display-state area 740 of the leftmost electronic apparatus 1A in one example of FIG. 58 described above. In this case, similarly to one example of FIG. 58, display of the display-state area 740 of the electronic apparatus 1A when the electronic apparatus 1 makes clockwise circumferential rotation is as illustrated in FIG. 60. The application screen 610b is displayed in the display-state area 740 of the second electronic apparatus 1A from the left of FIG. 60. The application screen 610a is displayed in the display-state area 740 of the third electronic apparatus 1A from the left of FIG. 60. For example, the application screen 610c is displayed in the display-state area 740 of the rightmost electronic apparatus 1A of FIG. 60.

In this manner, in one example, the electronic apparatus 1A changes a type of application screen to be displayed in the display-state area 740, according to circumferential rotation. Consequently, the user can cause the electronic apparatus 1A to change a type of application screen to be displayed in the display-state area, by rotating the electronic apparatus 1A in the circumferential direction.

Note that, when the electronic apparatus 1A is rotated 90 degrees counterclockwise in the circumferential direction from a reference orientation while a certain application screen is displayed in the display-state area, display of the display-state area need not be changed. When the electronic apparatus 1A is rotated 180 degrees counterclockwise in the circumferential direction from a reference orientation while a certain application screen is displayed in the display-state area, by contrast, an application screen after the certain application screen may be displayed in the display-state area. Similarly, when the electronic apparatus 1A is rotated 90 degrees clockwise in the circumferential direction from a reference orientation while a certain application screen is displayed in the display-state area, display of the display-state area need not be changed. When the electronic apparatus 1A is rotated 180 degrees clockwise in the circumferential direction from a reference orientation while a certain application screen is displayed in the display-state area, by contrast, an application screen before the certain application screen may be displayed in the display-state area.

When predetermined operation is performed on the target display area 730 while the controller 200 displays a certain application screen on the target display area 730, the controller 200 may display another type of application screen that is different from the certain application screen on the target display area 730.

### Third Example of Display Control According to Circumferential Rotation

In one example, when the controller 200 displays a display target part being a part of one image in the display-state area, the controller 200 can change the display target part and display the changed display target part in the display-state area, according to circumferential rotation. This display control may be hereinafter referred to as display control for a display target part according to circumferential rotation.

For example, the controller 200 shifts a display target part to be displayed in the display-state area rightward within one image, according to counterclockwise circumferential rotation of the electronic apparatus 1. In contrast, the controller 200 shifts a display target part to be displayed in the display-state area leftward within one image, according to clockwise circumferential rotation of the electronic apparatus 1.

Specifically, when the electronic apparatus 1A is rotated 90 degrees counterclockwise in the circumferential direction from a reference orientation, the controller 200 shifts the display target part rightward by a fifth predetermined amount and displays the shifted display target part in the display-state area. For example, the fifth predetermined amount is set to a value equal to a value of the width of the display target part. In contrast, when the electronic apparatus 1A is rotated 90 degrees clockwise in the circumferential direction from a reference orientation, the controller 200 shifts the display target part leftward by a sixth predetermined amount and displays the shifted display target part in the display-state area. For example, the sixth predetermined amount is set to a value equal to a value of the width of the display target part. Note that a specific example of each of the fifth and sixth predetermined amounts is not limited to one example described above. A method of setting a reference orientation is the same as that described above.

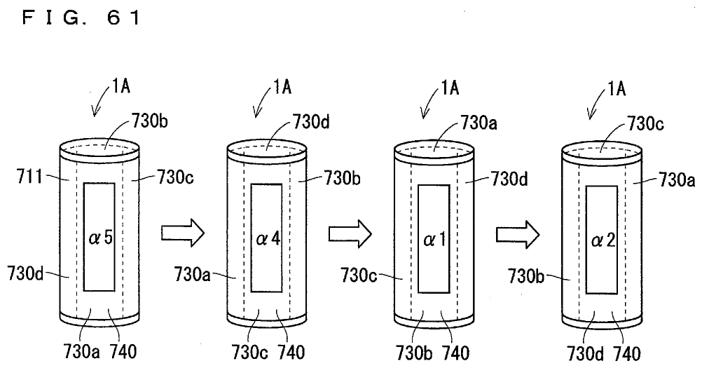

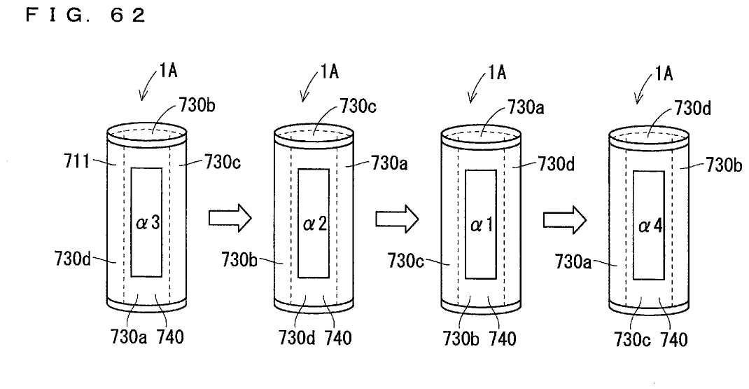

FIGS. 61 and 62 each illustrate a diagram for explaining one specific example of display control for a display target part according to circumferential rotation. As one example, the area α5 illustrated in FIG. 37 described above is displayed in the display-state area 740 (i.e., the display area 730a) of the leftmost electronic apparatus 1A in one example of FIG. 57 described above. Specifically, as one example, a display target part to be displayed in the display-state area 740 of the leftmost electronic apparatus 1A is the area α5. In this case, similarly to one example of FIG. 57, display of the display-state area 740 of the electronic apparatus 1A when the electronic apparatus 1A makes counterclockwise circumferential rotation is as illustrated in FIG. 61. The area α4, which is located on the right side of the area α5 and is shifted from the area α5 by an amount corresponding to the width of the display target part, is displayed in the display-state area 740 of the second electronic apparatus 1A from the left of FIG. 61. The area α1, which is located on the right side of the area α4, is displayed in the display-state area 740 of the third electronic apparatus 1A from the left of FIG. 61. The area α3, which is located on the right side of the area α1, is displayed in the display-state area 740 of the rightmost electronic apparatus 1A of FIG. 61.

As one example, the area α3 illustrated in FIG. 37 is displayed in the display-state area 740 of the leftmost electronic apparatus 1A in one example of FIG. 58 described above. In this case, similarly to one example of FIG. 58, display of the display-state area 740 of the electronic apparatus 1A when the electronic apparatus 1 makes clockwise circumferential rotation is as illustrated in FIG. 62. The area α2, which is located on the left side of the area α3 and is shifted from the area α3 by an amount corresponding to the width of the display target part, is displayed in the display-state area 740 of the second electronic apparatus 1A from the left of FIG. 62. The area α1, which is located on the left side of the area α2, is displayed in the display-state area 740 of the third electronic apparatus 1A from the left of FIG. 62. The area α4, which is located on the left side of the area α1, is displayed in the display-state area 740 of the rightmost electronic apparatus 1A of FIG. 62.

In this manner, in one example, the electronic apparatus 1A changes a display target part and displays the changed display target part in the display-state area 740, according to circumferential rotation. Consequently, the user can cause the electronic apparatus 1A to change a display target part to be displayed in the display-state area 740, by rotating the electronic apparatus 1A in the circumferential direction.

Note that, when the electronic apparatus 1A is rotated 90 degrees counterclockwise in the circumferential direction from a reference orientation, the controller 200 need not change a display target part. When the electronic apparatus 1A is rotated 180 degrees counterclockwise in the circumferential direction from a reference orientation, by contrast, the controller 200 may shift a display target part rightward and display the shifted display target part in the display-state area. Similarly, when the electronic apparatus 1A is rotated 90 degrees clockwise in the circumferential direction from a reference orientation, the controller 200 need not change a display target part. When the electronic apparatus 1A is rotated 180 degrees clockwise in the circumferential direction, by contrast, the controller 200 may shift a display target part leftward and display the shifted display target part in the display-state area.

When predetermined operation is performed on the target display area 730 while the controller 200 displays a display target part of one image in the target display area 730, the controller 200 may shift the display target part and display the shifted display target part in the target display area 730. Specifically, the controller 200 may scroll display of the target display area 730, according to predetermined operation performed on the target display area 730.

As operation modes, the electronic apparatus 1A may include a fourth operation mode in which the page display control according to circumferential rotation described above is performed, a fifth operation mode in which the display control for an application screen according to circumferential rotation described above is performed, and a sixth operation mode in which the display control for a display target part according to circumferential rotation is performed. In this case, for example, the electronic apparatus 1A may operate in an operation mode specified by a user, out of the fourth to sixth operation modes. For example, a user can specify an operation mode in which the electronic apparatus 1A is to operate, by performing operation on the information display area 711.

### Other Examples of Display Control of Cylindrical Electronic Apparatus

Other examples of display control performed in the electronic apparatus 1A are described below.

### Other Example 1 of Display Control

In one example, when the controller 200 of the electronic apparatus 1A sets only one display area 730 out of a plurality of display areas 730 to a non-display state, the controller 200 displays information related to a screen displayed in the one display area 730 in another display area 730. In one example, the third non-display determination processing described above is not executed. In one example, only one display area 730 out of a plurality of display areas 730 is set to a non-display state, unless otherwise specifically noted. In one example, the display control according to circumferential rotation described above need not be executed in the electronic apparatus 1A.

When the controller 200 sets a certain display area 730 displaying a screen to a non-display state as a result of the second non-display determination processing described above, the controller 200 displays screen-related information of the screen in another display area 730 that is different from the certain display area 730, in response to the setting of the certain display area 730 displaying the screen to a non-display state. For example, in response to setting of a certain display area 730 displaying a screen to a non-display state, the controller 200 displays screen-related information of the screen in two display areas 730, which are display areas other than the certain display area 730 and a display area 730 facing the certain display area 730. In other words, in response to setting of a certain display area 730 displaying a screen to a non-display state, the controller 200 displays screen-related information of the screen in two display areas 730, which are display areas interposing the certain display area 730 in the circumferential direction.

A display area 730 that has been set to a non-display state may be hereinafter referred to as a non-display setting display area 730. In one example, the term “erased screen” refers to a screen to be erased from a display area 730 when a display area 730 displaying a screen is set to a non-display state. Each of the two display areas 730 interposing a non-display setting area 730 in the circumferential direction may be referred to as a display area 730 adjacent to the non-display setting area 730.

For example, when the controller 200 sets the display area 730a displaying an application screen to a non-display state as a result of the second non-display determination processing, the controller 200 displays screen-related information of the application screen in the display areas 730c and 730d. In this case, display of the display area 730b facing the display area 730a may be any display. As the screen-related information, for example, screen-related information described in <Other Example 1> above is adopted.

When the controller 200 sets the display area 730c displaying an application screen to a non-display state as a result of the second non-display determination processing, the controller 200 displays screen-related information of the application screen in the display areas 730a and 730b. In this case, display of the display area 730d facing the display area 730c may be any display.

Pieces of the screen-related information displayed in two display areas 730 adjacent to the non-display setting area 730 may be the same as each other, or may be different from each other. The screen-related information may be displayed in only one of two display areas 730 adjacent to the non-display setting area 730. The screen-related information may be displayed in a display area 730 facing the non-display setting area 730.

In this manner, in one example, in response to setting of a display area 730 displaying a certain screen to a non-display state, the controller 200 displays information related to the certain screen in another display area 730. In this manner, even when a certain display area 730 is set to a non-display state, the user can identify a screen that has been displayed in the certain display area 730 by seeing another display area 730. As a result, convenience of the electronic apparatus 1 is enhanced.

When predetermined operation is performed on a display area 730 adjacent to the non-display setting area 730 and displaying screen-related information, the controller 200 may display an erased screen in a display area 730 facing the non-display setting area 730. As the predetermined operation, for example, tap operation, double tap operation, or long tap operation is adopted.

As one example, the non-display setting area 730 is the display area 730b. In this case, when predetermined operation is performed on one of the display areas 730c and 730d displaying image-related information, the controller 200 displays an erased screen in the display area 730a. As one example, the non-display setting area 730 is the display area 730c. In this case, when predetermined operation is performed on one of the display areas 730a and 730b displaying image-related information, the controller 200 displays an erased screen in the display area 730d.

In this manner, when predetermined operation is performed on a display area 730 displaying screen-related information, an erased screen is displayed in another display area 730 that is different from the non-display setting display area 730 and the display area 730 displaying the screen-related information. Consequently, the user can check the erased screen by performing operation on the display area 730 displaying the screen-related information. As a result, convenience of the electronic apparatus 1 is further enhanced.

### Other Example 2 of Display Control

In one example, the controller 200 of the electronic apparatus 1A sets a certain display area 730 as a reference display area 730. Then, when predetermined operation is performed on another display area 730 that is different from a reference display area 730 while the reference display area 730 displays a certain screen, the controller 200 can display a screen associated with the another display area 730 in the reference display area 730, in place of the certain screen. In one example, the term “screen switching operation” refers to this predetermined operation. As the screen switching operation, for example, tap operation, double tap operation, or long tap operation is adopted. In one example, the second non-display determination processing and the third non-display determination processing described above need not be executed in the electronic apparatus 1A. In one example, the display control according to circumferential rotation described above need not be executed in the electronic apparatus 1A.

Basically, the controller 200 sets the display area 730a as the reference display area 730. However, when only one display area 730 out of a plurality of display areas 730 is in a display state as a result of execution of the second non-display determination processing or the third non-display determination processing described above, the controller 200 sets the one display area 730 as the reference display area 730, irrespective of whether or not the one display area 730 is the display area 730a.

The reference display area 730 may be hereinafter referred to as a reference display area 730Z1. Among two display areas 730 interposing the reference display area 730Z1 in the circumferential direction, in a view seen from the end surface 702 side of the electronic apparatus 1A, a display area 730 located next to the reference display area 730 in the clockwise direction may be referred to as a right display area 730Z2, and a display area 730 located next to the reference display area 730Z1 in the counterclockwise direction may be referred to as a left display area 730Z3. A display area 730 facing the reference display area 730Z1 may be referred to as an opposite display area 730Z4. Provided that the reference display area 730Z1 is the display area 730a, for example, the right display area 730Z2, the left display area 730Z3, and the opposite display area 730Z4 are the display area 730c, the display area 730d, and the display area 730b, respectively.

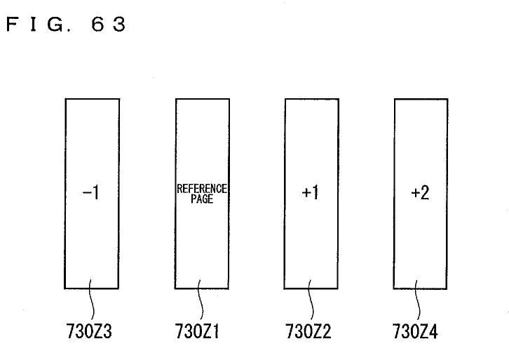

FIG. 63 illustrates a diagram for explaining operation of the electronic apparatus 1A when the electronic apparatus 1A displays contents consisting of a plurality of pages. As illustrated in FIG. 63, in one example, the controller 200 sets a page displayed in the reference display area 730Z1 as a reference page. The controller 200 assigns a page immediately following the reference page to the right display area 730Z2. The controller 200 assigns a page immediately preceding the reference page to the left display area 730Z3. The controller 200 assigns a page that is two pages after the reference page to the opposite display area 730Z4.

When the controller 200 determines that screen switching operation has been performed on the right display area 730Z2, the controller 200 displays a page immediately following a reference page displayed in the reference display area 730Z1 in the reference display area 730Z1, in place of the reference page. For example, when the controller 200 determines that screen switching operation has been performed on the right display area 730Z2 while the page 600a illustrated in FIG. 21 described above is displayed in the reference display area 730Z1, the controller 200 displays the page 600b in the reference display area 730Z1, in place of the page 600a. Then, when the controller 200 determines that screen switching operation has been performed on the right display area 730Z2 again, the controller 200 displays the page 600c in the reference display area 730Z1, in place of the page 600b.

When the controller 200 determines that screen switching operation has been performed on the left display area 730Z3, the controller 200 displays a page immediately preceding a reference page displayed in the reference display area 730Z1 in the reference display area 730Z1, in place of the reference page.

When the controller 200 determines that screen switching operation has been performed on the opposite display area 730Z4, the controller 200 displays a page that is two pages after a reference page displayed in the reference display area 730Z1 in the reference display area 730Z1, in place of the reference page.

Note that the controller 200 may assign a page that is three or more pages after a reference page to the opposite display area 730Z4. The controller 200 may assign a page that is a plurality of pages before a reference page to the opposite display area 730Z4.

Through such operation of the controller 200 as described above, the user can cause the electronic apparatus 1A to change a page to be displayed in the reference display area 730Z1 to a page that is after the page, by performing operation on the right display area 730Z2. The user can cause the electronic apparatus 1A to change a page to be displayed in the reference display area 730Z1 to a page that is before the page, by performing operation on the left display area 730Z3. The user can cause the electronic apparatus 1A to change a page to be displayed in the reference display area 730Z1 to a page that is a plurality of pages before and after the page, by performing operation on the opposite display area 730Z4.

Note that, when screen switching predetermined operation is performed on another display area 730 that is different from the reference display area 730Z1 while the controller 200 displays a certain application screen in the reference display area 730Z1, the controller 200 may display an application screen associated with the another display area 730 in the reference display area 730Z1, in place of the certain application screen. One example of operation of the electronic apparatus 1A in this case is described below.

For example, as in FIG. 28 described above, the controller 200 assigns ordinal numbers to a plurality of types of application screens. Then, the controller 200 sets an application screen displayed in the reference display area 730Z1 as a reference application screen. The controller 200 assigns an application screen immediately following the reference application screen to the right display area 730Z2, and assigns an application screen immediately preceding the reference application screen to the left display area 730Z3. Then, the controller 200 assigns an application screen that is two application screens after the reference application screen to the opposite display area 730Z4.

When the controller 200 determines that screen switching operation has been performed on the right display area 730Z2, the controller 200 displays an application screen immediately following a reference application screen displayed in the reference display area 730Z1 in the reference display area 730Z1, in place of the reference application screen. For example, when the controller 200 determines that screen switching operation has been performed on the right display area 730Z2 while the application screen 610b illustrated in FIG. 28 described above is displayed in the reference display area 730Z1, the controller 200 displays the application screen 610c in the reference display area 730Z1, in place of the application screen 610b.

When the controller 200 determines that screen switching operation has been performed on the left display area 730Z3, the controller 200 displays an application screen immediately preceding a reference application screen displayed in the reference display area 730Z1 in the reference display area 730Z1, in place of the reference application screen. For example, when the controller 200 determines that screen switching operation has been performed on the left display area 730Z3 while the application screen 610b is displayed in the reference display area 730Z1, the controller 200 displays the application screen 610a in the reference display area 730Z1, in place of the application screen 610b.

When the controller 200 determines that screen switching operation has been performed on the opposite display area 730Z4, the controller 200 displays an application screen that is two application screens after a reference application screen displayed in the reference display area 730Z1 in the reference display area 730Z1, in place of the reference application screen. For example, when the controller 200 determines that screen switching operation has been performed on the opposite display area 730Z4 while the application screen 610a is displayed in the reference display area 730Z1, the controller 200 displays the application screen 610c in the reference display area 730Z1, in place of the application screen 610a.

Note that the controller 200 may display screen-related information of a screen assigned to the right display area 730Z2 in the right display area 730Z2. The controller 200 may display screen-related information of a screen assigned to the left display area 730Z3 in the left display area 730Z3. When a page is assigned to a display area 730, screen-related information of the page may include information indicating details of the page. For example, the information may include a summary of a page. When an application screen is assigned to a display area 730, screen-related information of the application screen may include an icon representing an application associated with the application screen. Screen-related information of an application screen may include a letter indicating details of the application screen.

As described above, in one example, when predetermined operation is performed on another display area 730 that is different from the reference display area 730Z1 while the controller 200 displays a certain screen in the reference display area 730Z1, the controller 200 displays a screen associated with the another display area 730 in the reference display area 730Z1, in place of the certain screen. Consequently, the user can cause the electronic apparatus 1 to change a screen to be displayed in the reference display area 730Z1, by performing operation on another display area 730 that is different from the reference display area 730Z1. As a result, convenience of the electronic apparatus 1 is enhanced.

When screen-related information of a screen assigned to a display area 730 is displayed in the display area 730, the user can easily identify a screen assigned to the display area 730 by seeing the screen-related information displayed in the display area 730. Specifically, when a user performs operation on a display area 730 other than the reference display area 730Z1, the user can easily identify a screen to be displayed in the reference display area 730Z1. As a result, convenience of the electronic apparatus 1 is enhanced.

In one example described above, the information display area 711 is divided into four display areas 730 in the circumferential direction. However, the information display area 711 may be divided into two or three display areas 730 in the circumferential direction, or may be divided into five or more display areas 730 in the circumferential direction.

While the electronic apparatus 1 has been described in detail as in the above, the above description is in all aspects illustrative, and the present disclosure is not limited to the above description. Various examples described above may be applied in combination, on the condition that the combination is consistent. It is therefore understood that numerous examples not illustrated herein are assumable without departing from the scope of the present disclosure.

1. An electronic apparatus comprising:
an information display area located on a surface of the electronic apparatus; and
at least one processor configured to change display of the information display area, according to first rotation of the electronic apparatus about a first axis, the first axis being in parallel with a first display area comprised in the information display area.

2. The electronic apparatus according to claim 1, wherein
according to the first rotation, the at least one processor changes a page to be displayed in the first display area.

3. The electronic apparatus according to claim 1, wherein
during execution of a first application and a second application, according to the first rotation made while the at least one processor displays a first screen associated with the first application in the first display area, the at least one processor displays a second screen associated with the second application in the first display area, in place of the first screen.

4. The electronic apparatus according to claim 1, wherein
according to the first rotation, the at least one processor scrolls display of the first display area.

5. The electronic apparatus according to claim 4, wherein
according to second rotation about a second axis, the at least one processor scrolls display of the first display area in a direction different from a direction of a scrolling according to the first rotation, the second axis being in parallel with the first display area of the electronic apparatus.

6. The electronic apparatus according to claim 1, wherein
the information display area comprises a second display area in parallel with the first rotation axis.

7. The electronic apparatus according to claim 6, wherein
according to the first rotation made while a first page is displayed in the first display area, the at least one processor displays a second page in the second display area, the second page being different from the first page.

8. The electronic apparatus according to claim 6, wherein
during execution of a first application and a second application, according to the first rotation made while the at least one processor displays a first screen associated with the first application in the first display area, the at least one processor displays a second screen associated with the second application in the second display area.

9. The electronic apparatus according to claim 6, wherein
according to the first rotation made while the at least one processor displays a display target part of one image in the first display area, the at least one processor changes the display target part and displays the changed display target part in the second display area.

10. The electronic apparatus according to claim 9, wherein
according to second rotation about a second axis, the at least one processor changes display of the information display area, the second axis being in parallel with the first display area and the second display area of the electronic apparatus,
according to the first rotation made while the display target part is displayed in the first display area, the at least one processor shifts the display target part in a first direction within the one image and displays the shifted display target part in the second display area, and
according to the second rotation made while the display target part is displayed in the first display area, the at least one processor shifts the display target part in a second direction within the one image and displays the shifted display target part in the second display area.

11. The electronic apparatus according to claim 6, wherein
when the first display area is in a display state, the at least one processor sets the second display area to a non-display state, and
when the second display area is in a display state, the at least one processor sets the first display area to a non-display state.

12. The electronic apparatus according to claim 11, wherein
the at least one processor determines whether or not each of the first display area and the second display area is to be set to a non-display state, based on a condition of an object in terms of contact or proximity with respect to the information display area.

13. The electronic apparatus according to claim 1, further comprising
a plurality of display areas located on the surface of the electronic apparatus, the plurality of display areas comprising the first display area, wherein
when predetermined operation is performed on another display area that is different from a certain display area while the at least one processor displays a third screen in the certain display area, the at least one processor displays a fourth screen associated with the another display area in the certain display area, in place of the third screen, the another display area being comprised in the plurality of display areas, the certain display area being comprised in the plurality of display areas.

14. An electronic apparatus comprising:
an information display area located on a surface of the electronic apparatus, the information display area comprising a cylindrical curved surface; and
at least one processor configured to change display of the information display area, according to circumferential rotation of the electronic apparatus, the circumferential rotation being rotation in a circumferential direction of the cylindrical curved surface.

15. The electronic apparatus according to claim 14, wherein
according to the circumferential rotation, the at least one processor shifts a position of an area in a display state within the information display area along the circumferential direction.

16. The electronic apparatus according to claim 15, wherein
according to the circumferential rotation, the at least one processor changes display of the area in a display state.

17. The electronic apparatus according to claim 16, wherein
according to the circumferential rotation, the at least one processor changes a page to be displayed in the area in a display state.

18. The electronic apparatus according to claim 16, wherein
during execution of a first application and a second application, according to the circumferential rotation made while the at least one processor displays a first screen associated with the first application in the area in a display state, the at least one processor displays a second screen associated with the second application in the area in a display state, in place of the first screen.

19. The electronic apparatus according to claim 15, wherein
the at least one processor determines where the position of the area in a display state within the information display is to be, based on a condition of an object in terms of contact or proximity with respect to the information display area.

20. The electronic apparatus according to claim 14, wherein
when predetermined operation is performed on another display area that is different from a certain display area while the at least one processor displays a third screen in the certain display area, the at least one processor displays a fourth screen associated with the another display area in the certain display area, in place of the third screen, the another display area being comprised in a plurality of display areas comprised in the information display area, the certain display area being comprised in the plurality of display areas.
